(19) United States
(12) Patent Application Publication
(10) Pub. No.: US 2026/0354946 A1
(43) Pub. Date: Nov. 12, 2026

(54) INTRAORAL SCANNER WITH IMPROVED STRUCTURED LIGHT PROJECTION

(71) Applicant: Align Technology, Inc., San Jose, CA (US)

(72) Inventors: Ofer Saphier, Rechovot (IL); Noam Shekel, Kiryat Gat (IL); Tal Verker, Ofra (IL); Asaf Pellman, Bet-Yehoshua (IL)

(21) Appl. No.: 19/670,921

(22) Filed: May 7, 2026

Related U.S. Application Data
(60) Provisional application No. 63/802,481, filed on May 8, 2025.
(60) Provisional application No. 63/920,324, filed on Nov. 18, 2025.

(51) Int. Cl. A61C 9/00

(52) U.S. Cl. CPC A61C 9/006

(57) ABSTRACT

An intraoral scanner comprises a structured light projector configured to project structured light onto an intraoral object. The structured light projector comprises at least one light source configured to generate coherent light and a feature pattern generating optical element configured to output the structured light when the coherent light is transmitted through the feature pattern generating optical element. The intraoral scanner further comprises one or more speckle pattern generating elements configured to cause the projected structured light to have a plurality of speckle patterns. The intraoral scanner further comprises a plurality of cameras configured to capture one or more sets of images of the structured light projected onto the intraoral object and a communication module to transmit the one or more sets of images to a computing device.

### RELATED APPLICATIONS

This patent application claims the benefit under 35 U.S.C. § 119(e) of U.S. Provisional Application No. 63/802,481, filed May 8, 2025, and of U.S. Provisional Application No. 63/920,324, filed Nov. 18, 2025, both of which are incorporated by reference herein.

### TECHNICAL FIELD

Embodiments of the present disclosure relate to the field of intraoral scanning and, in particular, to an intraoral scanner with improved structured light projection.

### BACKGROUND

In prosthodontic procedures designed to insert a dental prosthesis in the oral cavity, the dental site at which the prosthesis is to be implanted in many cases should be measured accurately and studied carefully, so that a prosthesis such as a crown, denture or bridge, for example, can be properly designed and dimensioned to fit in place. A good fit enables mechanical stresses to be properly transmitted between the prosthesis and the jaw, and to prevent infection of the gums via the interface between the prosthesis and the dental site, for example. Accurate scans are also important for orthodontics.

One technique that can be used to capture three-dimensional (3D) information of a dental site is structured light projection. It can be difficult to achieve uniformity for pattern features of a projected structured light pattern. Additionally, if a coherent light source is used, then speckles are generated, which further reduces a uniformity of the structured light pattern. A lowered uniformity of the structured light pattern results in scanning inaccuracies.

### SUMMARY

In a first aspect of the disclosure, an intraoral scanning system comprises an intraoral scanner and a computing device. The intraoral scanner comprises a structured light projector configured to project structured light onto an intraoral object. The structured light projector comprises at least one light source configured to generate coherent light and a feature pattern generating optical element configured to output the structured light when the coherent light is transmitted through the feature pattern generating optical element. The intraoral scanner further comprises a plurality of cameras configured to capture one or more sets of images of the structured light projected onto the intraoral object. The intraoral scanner further comprises one or more speckle pattern generating elements configured to cause the projected structured light to have a plurality of speckle patterns. The computing device is configured to solve a correspondence problem within each set of images such that points in three-dimensional (3D) space are determined based on correspondence between projected features of the structured light and captured features of the structured light captured in the set of images, and to generate a 3D representation of the intraoral object based at least in part on a solution to the correspondence problem.

In a second aspect of the disclosure, an intraoral scanning system comprises an intraoral scanner and a computing device. The intraoral scanner comprises a structured light projector configured to project structured light onto an intraoral object. The structured light projector comprises at least one light source configured to generate light, a feature pattern generating optical element configured to output the structured light when the light is transmitted through the feature pattern generating optical element, and a stack of dielectric layers on the feature pattern generating optical element, wherein the stack of dielectric layers is configured to increase a transmittance of the coherent light at first angles below an angle threshold and to increase a reflectance of the coherent light at second angles above the angle threshold. The intraoral scanner further comprises a plurality of cameras configured to capture one or more sets of images of the structured light projected onto the intraoral object. The computing device is configured to solve a correspondence problem within each set of images such that points in three-dimensional (3D) space are determined based on correspondence between projected features of the structured light and captured features of the structured light captured in the set of images, and to generate a 3D representation of the intraoral object based at least in part on a solution to the correspondence problem.

In a third aspect of the disclosure, an intraoral scanner comprises a structured light projector configured to project structured light onto an intraoral object. The structured light projector comprises at least one light source configured to generate coherent light, a feature pattern generating optical element configured to output the structured light when the coherent light is transmitted through the feature pattern generating optical element, and one or more speckle pattern generating elements configured to cause the projected structured light to have a plurality of speckle patterns. The intraoral scanner further comprises a plurality of cameras configured to capture one or more sets of images of the structured light projected onto the intraoral object, and a communication module to transmit the one or more sets of images to a computing device.

In a fourth aspect of the disclosure, an intraoral scanner comprises a structured light projector configured to project structured light onto an intraoral object, which comprises at least one light source configured to generate light, a feature pattern generating optical element configured to output the structured light when the light is transmitted through the feature pattern generating optical element, and a stack of dielectric layers on the feature pattern generating optical element, wherein the stack of dielectric layers is configured to increase a transmittance of the coherent light at first angles below an angle threshold and to increase a reflectance of the coherent light at second angles above the angle threshold. The intraoral scanner further comprises a plurality of cameras configured to capture one or more sets of images of the structured light projected onto the intraoral object, and a communication module configured to transmit the one or more sets of images to a computing device.

In a fifth aspect of the disclosure, an intraoral scanning system comprises an intraoral scanner and a computing device. The intraoral scanner comprises a structured light projector configured to project structured light onto an intraoral object. The structured light projector comprises at least one light source configured to generate coherent light, a feature pattern generating optical element configured to output the structured light when the coherent light is transmitted through the feature pattern generating optical element, and a polarizer configured to cause at least one of the coherent light or the structured light to have a combination of x-polarization and y-polarization. The intraoral scanner further comprises a plurality of cameras configured to capture one or more sets of images of the structured light projected onto the intraoral object. The computing device is configure to solve a correspondence problem within each set of images such that points in three-dimensional (3D) space are determined based on correspondence between projected features of the structured light and captured features of the structured light captured in the set of images, and generate a 3D representation of the intraoral object based at least in part on a solution to the correspondence problem.

In a sixth aspect of the disclosure, an intraoral scanner comprises a structured light projector configured to project structured light onto an intraoral object, the structured light projector comprising at least one light source configured to generate coherent light, a feature pattern generating optical element configured to output the structured light when the coherent light is transmitted through the feature pattern generating optical element, and a polarizer configured to cause at least one of the coherent light or the structured light to have a combination of x-polarization and y-polarization. The intraoral scanner further comprises a plurality of cameras configured to capture one or more sets of images of the structured light projected onto the intraoral object.

In a seventh aspect of the disclosure, an intraoral scanner comprises a structured light projector comprising: a laser diode configured to generate coherent light, an aperture configured to shape the coherent light, a lens configured to focus the coherent light, a polarization element configured to polarize the coherent light, and a pattern generating optical element configured to output structured light when the coherent light is transmitted through the pattern generating optical element. The intraoral scanner further comprises one or more cameras configured to captured a plurality of images of the structured light projected onto an intraoral object and a processor configured to process the plurality of images.

In an eighth aspect of the disclosure, an intraoral scanner comprises a laser-based pattern projector for projecting a structured light pattern, wherein the structured light pattern has both X and Y polarization simultaneously, one or more cameras configured to capture a plurality of images of the structured light projected onto an intraoral object, and a processor configured to process the plurality of images.

In a ninth aspect of the disclosure, an intraoral scanner comprises a laser-based pattern projector for projecting a structured light pattern, a camera comprising an exposure time, wherein the camera is configured to capture a plurality of images of the structured light projected onto an intraoral object, and a controller configured to adjust a wavelength of the structured light pattern over the exposure time of the camera.

In a tenth aspect of the disclosure, an intraoral scanner comprises a structured light projector configured to project structured light onto an intraoral object, the structured light projector comprising: a means for generating coherent light; a means for producing a structured light pattern from the coherent light, and a means for causing at least one of the coherent light or the structured light pattern to have a plurality of speckle patterns. The intraoral scanner further comprises a plurality of cameras configured to capture one or more sets of images of the structured light pattern projected onto an intraoral object, and a processor configured to process the one or more sets of images.

In an eleventh aspect of the disclosure, an intraoral scanner comprises: a structured light projector configured to project a structured light pattern onto an intraoral object, the structured light projector comprising: at least one light source configured to generate coherent light that modulates between at least a first wavelength and a second wavelength; a first diffractive optical element configured to adjust an angle of the coherent light to an optical axis based on wavelength, wherein the first diffractive optical element causes the coherent light at the first wavelength to have a first angle to the optical axis and causes the coherent light at the second wavelength to have a second angle to the optical axis; and a feature pattern generating optical element configured to output the structured light when the coherent light is transmitted through the feature pattern generating optical element, wherein positions of pattern features of the structured light pattern are to alternate between first positions associated with the first angle and second positions associated with the second angle; and a plurality of cameras configured to capture one or more sets of images of the structured light pattern projected onto the intraoral object, wherein alteration of the pattern features of the structured light pattern between the first positions and the second positions reduces speckle contrast in the pattern features.

### BRIEF DESCRIPTION OF THE DRAWINGS

The present disclosure is illustrated by way of example, and not by way of limitation, in the figures of the accompanying drawings.

FIGS. 1A-D illustrate a structured light pattern comprising pattern features having speckles.

FIG. 1E illustrates contrasts between dark and light points in pattern features having different numbers of speckle patterns.

FIG. 2 illustrates a structured light projector that generates a structured light pattern having an increased number of speckle patterns, in accordance with embodiments of the present disclosure.

FIG. 3A illustrates a structured light projector that generates a structured light pattern having an increased number of speckle patterns, in accordance with embodiments of the present disclosure.

FIG. 3B illustrates a structured light projector that generates a structured light pattern having an increased number of speckle patterns, in accordance with embodiments of the present disclosure.

FIG. 4A illustrates a portion of a structured light projector, including a diffractive optical element configured to change an angle of coherent light based on order and wavelength, in accordance with embodiments of the present disclosure.

FIG. 4B is a chart showing light intensity for different orders of light passing through the diffractive optical element of the structured light projector of FIG. 4A, in accordance with embodiments of the present disclosure.

FIG. 4C illustrates a structured light projector, including a diffractive optical element configured to change an angle of coherent light based on order and wavelength and a pattern generating optical element, in accordance with embodiments of the present disclosure.

FIG. 4D illustrates the structured light projector of FIG. 4C and a structured light pattern projected by the structured light projector onto an intraoral object, in accordance with embodiments of the present disclosure.

FIG. 5A is a chart showing wavelengths of light output by a laser at different power levels of the laser, in accordance with embodiments of the present disclosure.

FIG. 5B illustrates alight projection cycle for a structured light projector that outputs light using multiple current levels, in accordance with embodiments of the present disclosure.

FIG. 5C illustrates a light projection cycle for a structured light projector (e.g., laser diode) that outputs light using multiple current levels, in accordance with embodiments of the present disclosure.

FIG. 6 is a chart showing lateral spot shift and deflected beam angle verses diffraction order, in accordance with embodiments of the present disclosure.

FIG. 7 illustrates a structured light projector that generates a structured light pattern having improved structured light projection, in accordance with embodiments of the present disclosure.

FIG. 8 is a chart showing transmittance through an antireflective coating on a transparent surface of a structured light projector with different angles of incidence, in accordance with embodiments of the present disclosure.

FIG. 9 illustrates one embodiment of a system for performing intraoral scanning and generating a virtual three dimensional model of a dental site.

FIG. 10 is a schematic illustration of a wand (e.g., intraoral scanner) with a plurality of light projectors and cameras disposed within a probe at a distal end of the wand, in accordance with embodiments of the present disclosure.

FIG. 11 is a chart depicting a plurality of different configurations for the position of the light projectors and the cameras in the probe of FIG. 10, in accordance with embodiments of the present disclosure.

FIG. 12 is a flow chart for a method of generating a 3D representations of an intraoral object using an intraoral scanner configured to improve image quality using one or more speckle pattern generating elements and/or an antireflective coating, in accordance with embodiments of the present disclosure.

FIG. 13A is a flow chart for a method 1300 of modulating a wavelength of light produced by a structured light projector, in accordance with embodiments of the present disclosure.

FIG. 13B illustrates three example modulation schemes for modulating alight beam during intraoral scanning, in accordance with embodiments of the present disclosure.

FIG. 14 illustrates a block diagram of an example computing device, in accordance with embodiments of the present disclosure.

### DETAILED DESCRIPTION

Described herein methods and apparatuses for improving the quality of intraoral scans taken of dental sites using an intraoral scanner that uses structured light projection of coherent light for three-dimensional (3D) imaging.

Some embodiments described herein increase the number of distinct speckle patterns that are present within a structured light pattern, and that are captured in an image frame. Increasing the number of distinct speckle patterns reduces a speckle contrast (contrast between bright spots and dark spots of speckle patterns), improving a consistency of pattern features in a structured light pattern. Speckles are a granular pattern generated when light from a coherent light source such as a laser diode is reflected or transmitted through a diffusive target (e.g., such as teeth). In embodiments, an intraoral scanner includes one or more structured light projectors that project a structured light pattern of pattern features (e.g., distinct spots) onto intraoral objects (e.g., teeth, gingiva, etc.) using coherent light. The intraoral objects illuminated by the structured light are imaged by one or more cameras of the intraoral scanner. The imaged structured light pattern projected onto the intraoral object are overlayed by parasitic speckles resulting in speckle noise, making pattern localization difficult and reducing the overall quality of the structured light pattern.

One or more techniques for reducing speckle contrast and reduced speckle noise (e.g., by increasing the number of distinct speckle patterns that occur within an image frame) are provided herein, improving the quality of a projected structured light pattern. In one embodiment, coherent light used for structured light projection is provided with both x-polarization and y-polarization (e.g., is circularly polarized) to increase a number of speckle patterns that are generated and reduce speckle contrast. In one embodiment, a temperature of a coherent structured light projector is fluctuated at a high rate to cause changes in the wavelength of the structured light, increasing a number of distinct speckle patterns. In one embodiment, multiple different light sources (e.g., laser diodes) generate the structured light pattern at slightly different wavelengths to increase a number of speckle patterns. In one embodiment, a vibrator rapidly vibrates the structured light projector (or one or more components of the structured light projector), smearing the speckle pattern and effectively increasing a number of different speckle patterns. In some embodiments, the coherent structured light projector includes a wavelength-dependent turning element (e.g., such as a diffractive optical element) that causes light projected onto or through the wavelength-dependent turning element to deflect at an angle based on the wavelength of light. This may introduce a smearing of a speckle pattern (and of the light in general), further reducing speckle contrast. Any one or more of these and other techniques may be used to increase the number of distinct speckle patterns and reduce speckle contrast in embodiments.

Some embodiments described herein increase the uniformity of pattern features in a projected structured light pattern. The uniformity of intensity in a structured light pattern has importance for scanning quality. Achieving high uniformity is difficult, and there are tradeoffs between a cost and quality of a pattern generating optical element (e.g., a diffractive optical element (DOE)). In some embodiments, the pattern generating optical element includes a dielectric layer stack that is tuned to reflect light that has an angle of incidence that is above a threshold and to transmit light that has an angle of incidence that is below the threshold. The dielectric layer stack is referred to as an anti-reflective coating herein for convenience. In embodiments, the anti-reflective coating is an alternating stack of dielectric layers whose thicknesses and materials are chosen to tune the anti-reflective coating to reflect light of the wavelength projected by the structured light projector that impacts the pattern generating optical element at an angle above the threshold, and to transmit light of the wavelength that impacts the pattern generating optical element at a angle below the threshold. The tuned anti-reflective coating on a backside of the pattern generating optical element may remove parasitic pattern features from a defined field of illumination of the structured light projector in embodiments.

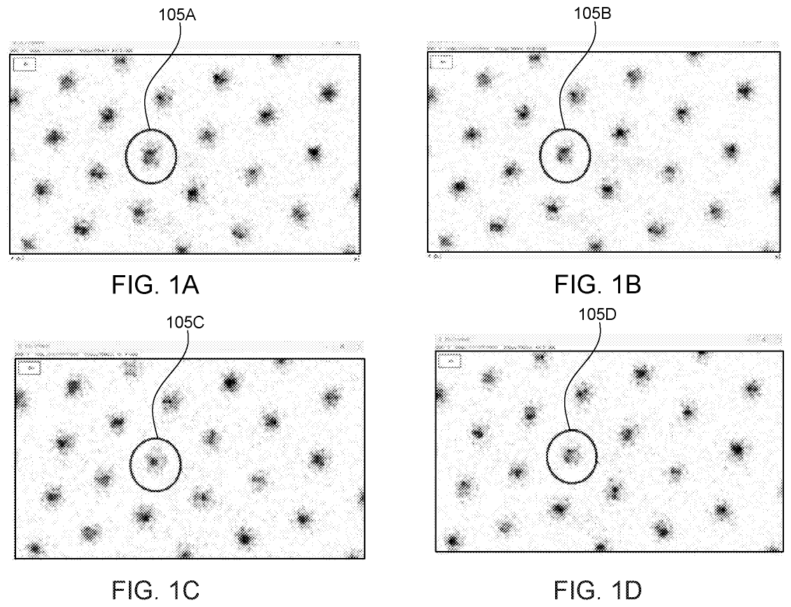

FIGS. 1A-D illustrate a structured light pattern comprising pattern features having speckles. In the illustrated examples, the structured light pattern is a pattern of spots arranged in a hexagonal grid. A structured light projector used to generate the structured light pattern may be a coherent light source, which may generate pattern features of coherent light (e.g., pattern features having a specific wavelength). When the coherent light pattern features interact with teeth, unpredictable speckle patterns may occur at the intersection of each of the pattern features and the teeth. However, the interaction between the coherent light of the pattern features and the teeth is not easily predictable. Due to speckles, the pattern features (e.g., spots) in the structured light pattern (e.g., spot array) have “hot spots” where constructive interferences increases the light intensity and “cold spots” where destructive interference reduces light intensity. The random occurrence of the hot spots and cold spots within each of the pattern features makes exact localization of the center of each pattern feature difficult. FIGS. 1A-D show the same structured light pattern projected onto different surfaces. As shown, a same pattern feature 105 may be captured by a same set of pixels in each of four frames (e.g., a different frame for each of FIGS. 1A-D). The pattern feature 105 has a first intensity distribution with a bright spot in a lower left corner of the pattern feature in FIG. 1A, has a second intensity distribution in FIG. 1B, has a third intensity distribution in FIG. 1C, and has a fourth intensity distribution with dark pixels in FIG. 1D. The changes in the intensity distribution make it more difficult to identify a center of the pattern feature 105 between frames.

FIG. 1E illustrates contrasts between dark and light points in pattern features having different numbers of speckle patterns. “Speckle contrast” is defined as

$$\frac{σ}{μ} ,$$

where σ is the special standard deviation of the light intensity and μ is the mean intensity. The lower the speckle contrast, the easier it is to perform localization of the pattern features in the structured light pattern. By increasing a number of independent speckle patterns that are generated simultaneously (or at least within an exposure time of a camera so that they are captured within an image frame), the speckle contrast will decrease, by a factor of

$$\frac{1}{√ N} ,$$

when N is the number of the independent speckle patterns.

FIG. 1E shows simulated speckles and speckle contrast as function of number of independent speckle patterns. Image 110A shows a highest speckle contrast that occurs with N=1 (i.e., a single speckle pattern). Image 110B shows a lower speckle contrast that occurs with N=10 (i.e., 10 independent speckle patterns). Image 110C shows a still lower speckle contrast that occurs with N=30 (i.e., 30 independent speckle patterns). Image 110D shows a still lower speckle contrast that occurs with N=50 (i.e., 50 independent speckle patterns). As shown, there is a diminishing return with each additional speckle pattern. For example, going from one to two speckle patterns results in a highest improvement per additional speckle pattern added, with a gradual decrease in reduction of the speckle contrast that occurs from adding another speckle pattern.

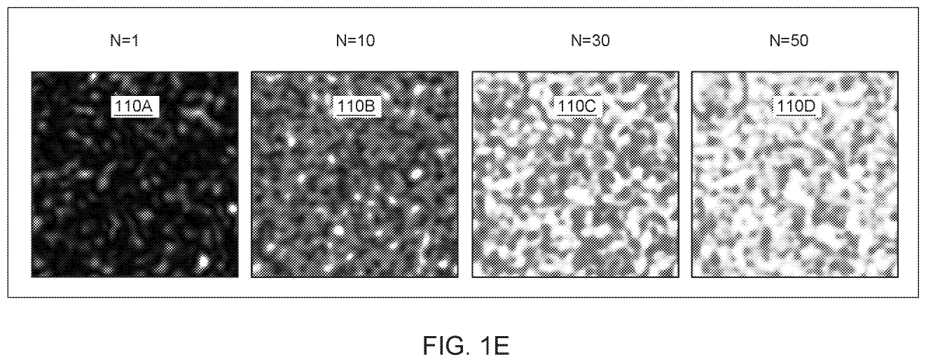

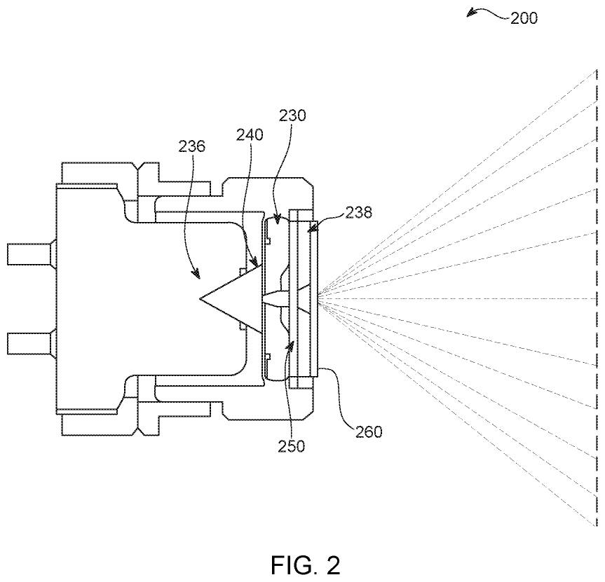

FIG. 2 illustrates a structured light projector 200 that generates a structured light pattern having an increased number of speckle patterns, in accordance with embodiments of the present disclosure. The structured light projector 200 includes a light source 236 that is configured to generate coherent light that is unstructured. The light source 236 may be, for example, a laser diode. The light source 236 may be configured to generate coherent light at a specific wavelength or set of wavelengths (e.g., a wavelength range) in embodiments. For example, the light source 236 may generate light at wavelengths around 451-452 nm, where the specific wavelength output may be dependent on temperature of the light source 236. Additional components of the structured light projector 200 may be tuned to operate on light of the specific wavelength or set of wavelengths. In examples, the structured light projector may be configured to generate green light, blue light, or infrared (also including near-infrared) light.

The structured light projector 200 may include an aperture 240 through which the coherent light is passed. The aperture 240 may shape the light beam output by the light source 236 to ensure that the light beam has a target spatial profile. The aperture 240 may additionally collimate the light beam, making light rays more parallel, which helps the light beam to maintain a consistent beam size over a distance. The aperture 240 may reduce divergent or off-axis light and improve directionality and/or focus of the light beam, and/or may limit a beam width of the light beam.

The structured light projector 200 may include a lens 230 along a path of the light beam after the aperture 240. The lens may focus the coherent light beam (e.g., laser beam) and/or shape the coherent light beam. The lens 230 may cause the light beam to converge to a tight focal point, and can collimate the light beam to cause the rays of the light beam to be parallel or approximately parallel. In embodiments, the lens 230 may cause beam expansion (e.g., to increase a beam diameter) and/or beam reduction (to decrease the beam diameter) to shape the beam. In some embodiments, the lens 230 corrects aberrations and/or aligns beams. Examples of lenses 230 that may be used include a plano-convex lens, a biconvex lens, a concave lens, and a cylindrical lens.

The structured light projector 200 may include a feature pattern generating optical element 238 along a path of the light beam after the lens 230. In one embodiment, the feature pattern generating optical element 238 is a transmission mask. In one embodiment, the feature pattern generating optical element 238 is a diffractive optical element (DOE) or refractive optical element. In one embodiment, the feature pattern generating optical element 238 is a multi-lens array. The feature pattern generating optical element 238 may be configured to receive the nonstructured light (e.g., light beam) focused by the lens 230, and to output structured light comprising a plurality of pattern features having a configured arrangement (e.g., an array). For example, the feature pattern generating optical element 238 may output a feature pattern comprising an array of spots, a grid pattern, a line pattern, and so on. In embodiments, the structured light (e.g., feature pattern) output by the feature pattern generating optical element 238 is a non-coded feature pattern. A non-coded feature pattern is a feature pattern that does not carry explicit or unique identifiers for individual features. Examples of non-coded features are stripes and dots. Unlike coded patterns, which use unique markings to distinguish different parts of the light pattern, non-coded light patterns are generally repetitive and ambiguous.

A structured light pattern output by the structured light projector 200 may be used to project a light pattern (structured light) onto intraoral surfaces and/or objects. Cameras may capture images of the structured light projected onto the intraoral surfaces and/or objects, and may generate a 3D representation of the intraoral surfaces and/or objects based on the structured light pattern captured in the images.

For some materials such as teeth, a speckle pattern is generated when coherent light illuminates the materials. A speckle pattern is a random-looking intensity pattern that occurs when coherent light is scattered by a surface or medium that the light is incident upon. When coherent light (like a laser beam) hits a rough surface or passes through a scattering medium (e.g., such as teeth), the scattered wavefronts of the light interfere with each other-constructively and destructively-resulting in a seemingly random pattern of bright and dark spots. This interference happens because the scattered light paths have slightly different lengths (and thus phases), which create both constructive interference (bright spots) in some locations and destructive interference (dark spots) in other locations. A distinct speckle pattern may be generated for each pattern feature that is incident upon a tooth, and the speckle pattern for a specific pattern feature may change depending on the shape of the tooth, internal properties of the tooth, the angle of incidence of the light rays of the pattern feature on the tooth, and so on. Accordingly, the speckle pattern that is produced for each individual pattern feature is not predictable, and may change. The non-predictable speckle patterns that are produced for each of the pattern features of the structured light pattern may render it difficult to determine centers of those pattern features. An accurate determination of the centers of the pattern features may be useful in accurately determining pattern feature locations in images, which in turn may be used to accurately determine locations in 3D space at which light rays of the pattern features intersected the 3D surface of a tooth (and thus points on the surface of the tooth in the 3D space).

As discussed with reference to FIGS. 1A-E, the impact of a speckle pattern may be reduced by decreasing a speckle contrast. The speckle contrast can be decreased by increasing the number of different speckle patterns that are generated in an image frame (e.g., either the number of speckle patterns that are generated simultaneously, or at different times but within the exposure time of an image frame).

In embodiments, the light output by light source 236 is linearly polarized. The speckle pattern that is generated when a coherent light beam interacts with a diffuse object such as a tooth may be at least in part based on a linear polarization of the light beam. Accordingly, a light beam having a linear polarization in an x axis may produce a different speckle pattern than a light beam having a linear polarization in a y axis. The number of speckle patterns may therefore be increased by causing generated light to have both x polarization and y polarization.

In embodiments, a speckle pattern generating optical element 250 is disposed along the optical axis of the light beam. In one embodiment, the speckle pattern generating optical element 250 is an elliptical or circular polarizer, which may cause linearly polarized light to have both X and Y polarization simultaneously (e.g., to become elliptically polarized or circularly polarized). When the speckle pattern generating optical element 250 causes the coherent light to have both X and Y polarization, the resulting structured light pattern output by the feature pattern generating optical element 238 also has both x-polarization and y-polarization simultaneously. In one embodiment, the circular polarizer is a quarter waveplate. The speckle pattern generating optical element 250 may improve speckle contrast. In one embodiment, speckle contrast is improved by a factor

$$\frac{1}{√ 2} .$$

In the illustrated example, the speckle pattern generating optical element is disposed between the lens 230 and the feature pattern generating optical element 238. Alternatively, the feature pattern generating optical element 238 may be disposed between the speckle pattern generating optical element 250 and the lens 238. In one embodiment, the feature pattern generating optical element 238 and the speckle pattern generating optical element 250 are integrated into a same optical element. The optical element may perform both the function of causing the light to generate multiple different speckle patterns when it is incident on a tooth and the function of dividing the light into a plurality of pattern features. In some embodiments, one side of the optical element performs the function of the speckle pattern generating optical element and an opposite side of the optical element performs the function of the feature pattern generating optical element. In some embodiments, the optical element causes both circular/elliptical polarization and feature pattern generation at a same region of the optical element (e.g., rather than doing one and then the other).

In some embodiments, multiple speckle pattern generating elements and techniques may be combined to achieve enhanced speckle reduction. For example, an intraoral scanner may include both a speckle pattern generating optical element (such as an elliptical or circular polarizer) and a controller configured to dynamically fluctuate the power of the light source. The controller may be provided as a separate element in addition to other speckle pattern generating elements, allowing the system to leverage multiple independent mechanisms for generating different speckle patterns. In some embodiments, the combination of polarization-based speckle pattern generation and wavelength-based speckle pattern generation (through power/current fluctuation) may provide greater speckle contrast reduction than either technique alone. Additionally, multiple light sources with different wavelengths may be combined with polarization elements and/or power fluctuation control to further increase the number of independent speckle patterns generated within a single camera exposure.

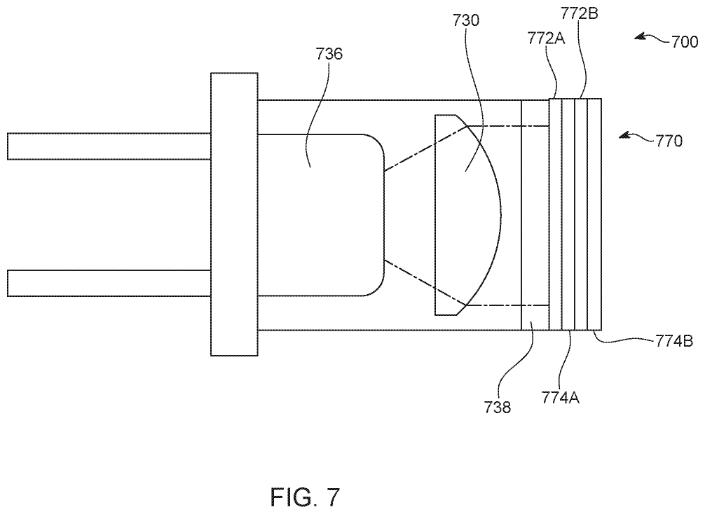

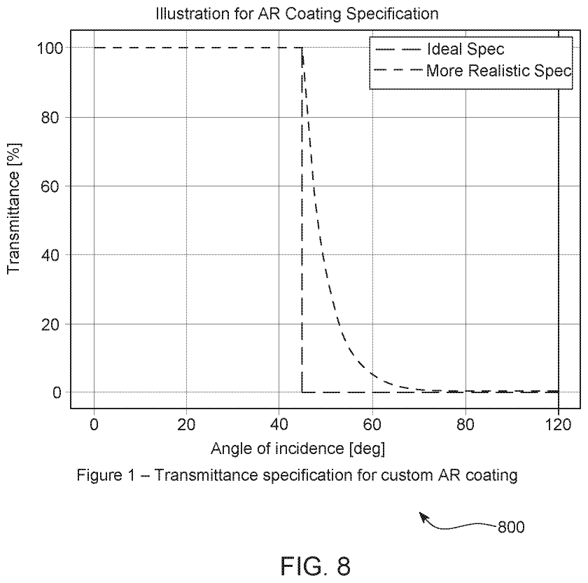

In some embodiments, an anti-reflective coating 260 is disposed on the feature pattern generating optical element 238 and/or on the speckle pattern generating optical element 250. The anti-reflective coating 260 may include a stack of dielectric layers in embodiments. The stack of dielectric layers may be configured to increase a transmittance of the coherent light having the wavelength(s) output by the light source 236 at first angles of incidence below an angle threshold and to increase a reflectance of the coherent light having the wavelength(s) output by the light source 236 at second angles of incidence above the angle threshold. This may further improve a quality of the projected structured light in embodiments. The anti-reflective coating is discussed in greater detail with reference to FIGS. 7-8.

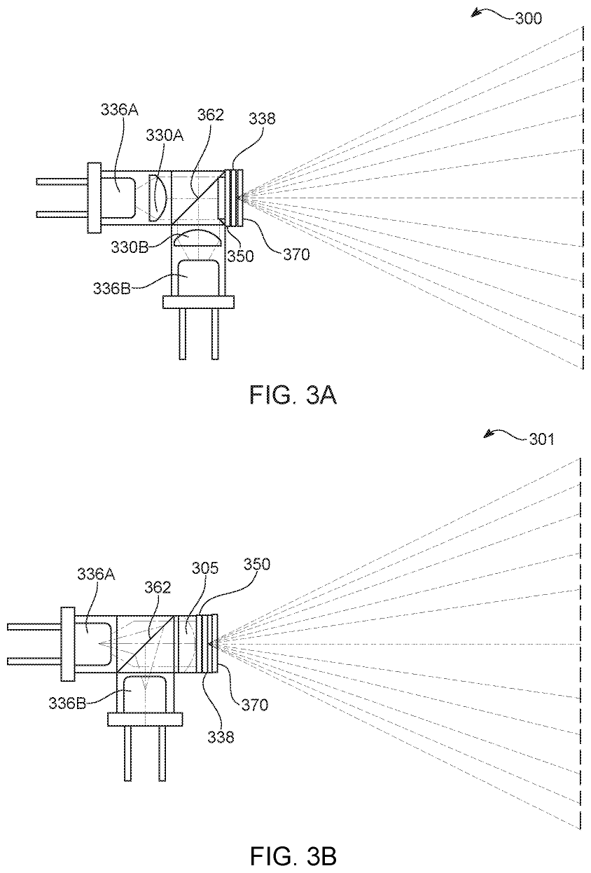

The speckle pattern generating optical element of FIG. 2 is one type of speckle pattern generating element that may be used to improve a speckle contrast in embodiments. Other types of speckle pattern generating elements may also be used instead of, or in addition to, the speckle pattern generating optical element. Examples of such other types of speckle pattern generating elements are discussed with reference to FIGS. 3-6.

Reference is now made to FIGS. 3A-B, which are schematic illustrations of a structured light projector with more than one light source (e.g., laser diodes), in accordance with some applications of the present disclosure. FIG. 3A illustrates a first structured light projector that generates a structured light pattern having an increased number of speckle patterns by using multiple light sources, in accordance with embodiments of the present disclosure. FIG. 3B illustrates a second structured light projector that generates a structured light pattern having an increased number of speckle patterns by using multiple light sources, in accordance with embodiments of the present disclosure.

As discussed above, using a laser diode, speckles may give rise to spatial noise. The speckle effect may be a result of interference of many waves of the same frequency but different phases and amplitudes. When all added together, the resultant wave is a wave whose amplitude varies randomly across the beam profile. For some applications, the speckle effect may be reduced by combining a plurality of light sources (e.g., laser diodes) of the same wavelength or of slightly different wavelengths (e.g., both producing green light or both producing blue light, but with one having an offset in wavelength as compared to the other). Different lasers having the same wavelength are not coherent to one another, so combining them into the same spatial space, or the same diffractive beam splitter, will lower the speckles by at least a factor of the square root of the number of different light sources. Additionally, different wavelengths produce different speckle patterns. Accordingly, by using two or more light sources with slightly different wavelengths, the number of speckle patterns may be increased (and thus the speckle contrast may be decreased).

Structured light projector 300 of FIG. 3A and structured light projector 301 of FIG. 3B each include at least a first coherent light source 336A and a second coherent light source 336B, each of which generates a respective coherent light having a respective wavelength (e.g., first coherent light source generates a first coherent light at a first wavelength and second coherent light source generates a second coherent light at a second wavelength that may be the same as or offset from the first coherent wavelength). In some embodiments, the first coherent light and the second coherent light are generated at a same time (e.g., simultaneously). In some embodiments, the first coherent light and the second coherent light are generated in an alternating manner at a rate that enables cameras to capture multiple speckle patterns in a single exposure. For example, the rate of alternating between activation of the first light source and the second light source may be one or more gigahertz in some embodiments. Note that more than two coherent light sources may be used, which further increases a number of speckle patterns and reduces a speckle contrast. In embodiments, light from the first and second light sources 336A-B may be combined using a beam splitter 362. Beam splitter 362 may be a standard 50/50 splitter, lowering the efficiency of both beams to under 50%, or a polarizing beam splitter (PBS), keeping the efficiency at greater than 90%.

For some applications, each light source 336A-B may have its own collimating lens 330A-B, such as is shown in FIG. 3A. Alternatively, the plurality of light sources 336A-B may share a collimating lens 305, the collimating lens being disposed between beam splitter 362 and a feature pattern generating optical element 338, such as is shown in FIG. 3B. Feature pattern generating optical element 338 may be a DOE, segmented DOE, micro-lens array, compound diffractive periodic structure, or other type of pattern generating optical element in embodiments. In some embodiments, a speckle pattern generating optical element 350 is disposed between the beam splitter 362 and the feature pattern generating optical element 338. In some embodiments, feature pattern generating optical element 338 is disposed between beam splitter 362 and speckle pattern generating optical element 350. In some embodiments, the feature pattern generating optical element 338 and speckle pattern generating optical element 350 are combined into a single optical element. In some embodiments, an antireflective coating 370 is disposed on the feature pattern generating optical element 338 and/or speckle pattern generating optical element 350. The antireflective coating may correspond to the anti-reflective coating described with reference to FIGS. 7-8 in embodiments.

Depending on the diffusivity of a material being illuminated by coherent light, different wavelengths of light will produce different speckle patterns. For some light sources that produce coherent light (e.g., such as laser diodes), the temperature of the light source affects the wavelength of the light that is produced. Accordingly, modulating the temperature of the light source causes the wavelength of the light output by that light source to also modulate. In embodiments, the temperature of a light source may be modulated by modulating the current and/or power that is supplied to the light source.

In embodiments, the temperature rise in a laser diode is very fast relative to pulse length. However, the temperature itself depends on a starting temperature. For a pulse of constant current (e.g., a rectangular waveform), a junction temperature of the laser diode will rise fast initially, then rise slowly thereafter. The exact temperature transient behavior is dependent on the heat capacity and heat resistance of the laser diode and a package for the laser diode. The diode itself, made of semiconductor material, is hundreds of microns in size, and will heat up quickly. The package size may be 5-10 mm in size, formed mostly of metal, and heats up more slowly.

The coordination of multiple light sources in structured light projectors may benefit from precise timing control to ensure that different speckle patterns are captured within a single camera exposure while maintaining optimal optical power distribution. When using multiple laser diodes with slightly different wavelengths, the system may employ various synchronization strategies to maximize speckle reduction effectiveness. In simultaneous operation mode, all light sources operate concurrently, with each contributing its unique wavelength and associated speckle pattern to the overall illumination. This approach provides the maximum number of independent speckle patterns but requires careful power balancing to ensure that each wavelength contributes equally to the total optical energy captured by the camera.

In alternating operation mode, the light sources may be activated sequentially at rates significantly higher than the camera frame rate, typically in the gigahertz range. For example, with a camera exposure time of 1 millisecond and alternating frequencies of 1-10 GHz, each light source may be activated thousands to millions of times during a single exposure, ensuring thorough averaging of the different speckle patterns. The alternating sequence may follow various patterns, such as simple round-robin switching between sources, weighted switching that favors certain wavelengths based on their speckle reduction effectiveness, or adaptive switching that responds to real-time feedback about speckle contrast levels.

The control system may also implement sophisticated power management algorithms that account for the thermal characteristics and response times of different laser diodes. Since different laser diodes may have varying temperature coefficients and thermal time constants, the controller may apply individualized current profiles to each source to achieve optimal wavelength separation and temporal stability. Additionally, the system may monitor the optical output from each source using photodetectors or other feedback mechanisms to ensure consistent power levels and wavelength characteristics throughout the scanning process, automatically adjusting drive currents to compensate for aging effects, temperature drift, or other factors that could affect the speckle reduction performance.

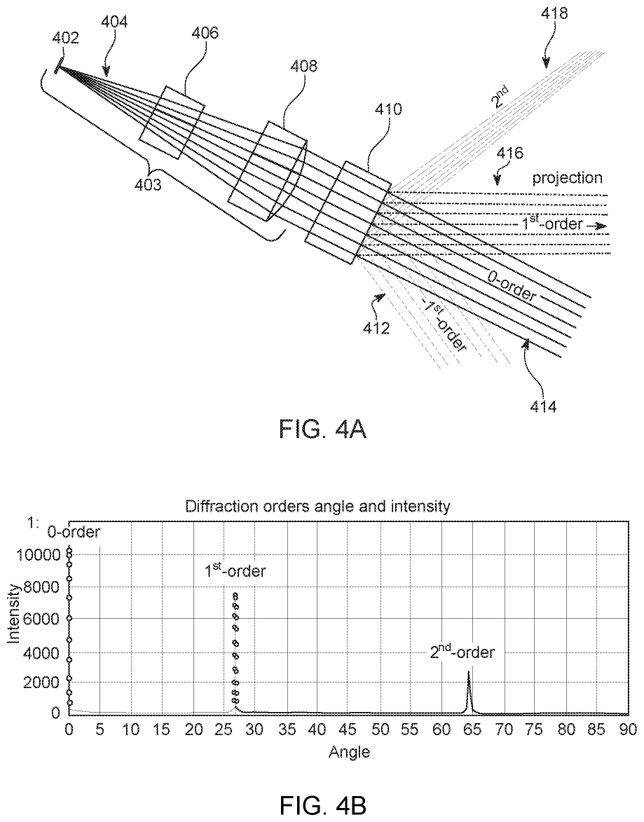

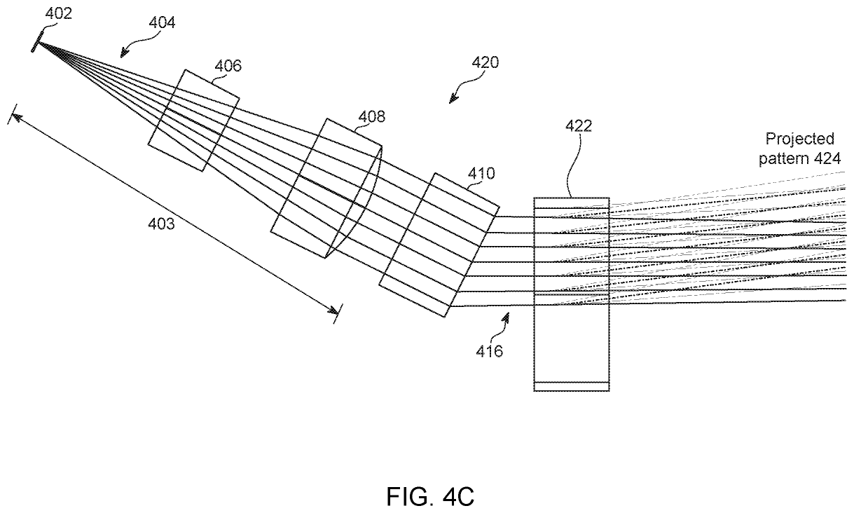

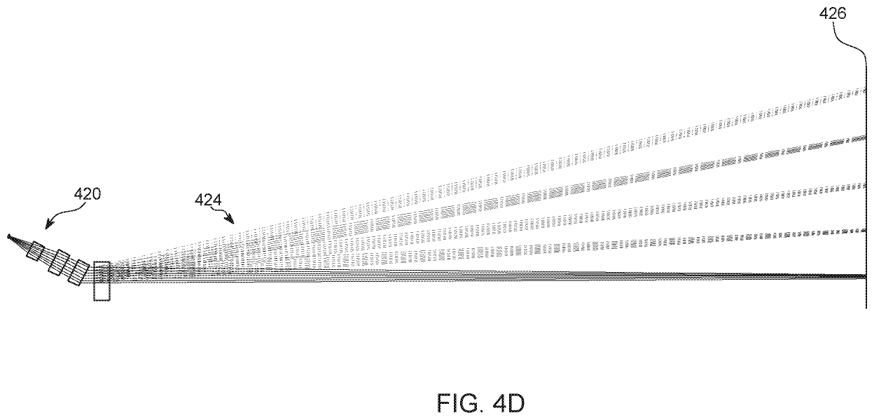

FIG. 4A illustrates a schematic view of a portion of a structured light projector in accordance with an embodiment of the present disclosure. The structured light projector may be configured to output a light pattern with pattern features that oscillate back and forth, but without use of moving parts. In embodiments, the oscillating positions of the structured light features may be caused partially or entirely by varying a temperature of a light source. The structured light projector includes a coherent light source 402 that generates coherent light 404. In embodiments, the coherent light source 402 is a single mode edge emitter source. In some embodiments, the coherent light source 402 comprises a laser diode. In embodiments, the coherent light source 402 is operated in a pulse mode, where each pulse is modulated by a higher frequency to generate a wavelength drift that follows junction temperature variations for the coherent light source 402. The modulation frequency may be much higher than the main pulse frequency and much higher than an exposure time of an observing camera in embodiments.

The coherent light 404 passes through focusing optics 403, which may include a cover plate 406 and one or more focusing lens 408, before reaching a diffractive optical element 410 or other wavelength-dependent turning element. The diffractive optical element 410 (or other wavelength-dependent turning element) is configured to change an angle of the coherent light 404 based on diffraction order and wavelength. The diffractive optical element 410 (or other wavelength-dependent turning element) is positioned to receive the coherent light 404 and redirect it at different angles depending on the wavelength characteristics of the incident light, thereby enabling wavelength-dependent beam steering for improved structured light projection.

In embodiments, the diffractive optical element 410 shown in FIG. 4A corresponds to a first diffractive optical element that functions as a speckle pattern generating element by converting wavelength variations into angular variations of the coherent light 404 beam. In embodiments, the diffractive optical element acts as a wavelength to angle converter. In other embodiments, other types of optical components may be used instead of or in addition to a DOE to provide wavelength to angle conversion. The diffractive optical element 410 may comprise a linear grating having a grating period (also referred to as grating cycle) that determines the angular sensitivity to wavelength changes. In one embodiment, the grating period is approximately 1 micrometer, which provides sufficient angular deflection sensitivity while maintaining optical efficiency. The focusing optics 403, including the cover plate 406 and focusing lens 408, condition the coherent light 404 from the coherent light source 402 to provide optimal beam characteristics for interaction with the diffractive optical element 410.

The cover plate 406 may serve multiple functions in the structured light projector system. In some embodiments, the cover plate 406 may be a protective element that shields the internal optical components from environmental contaminants such as dust, moisture, or debris that may be present in the oral cavity during scanning. The cover plate 406 may be made from optically transparent materials such as glass, sapphire, or optical-grade polymers that maintain high transmittance for the wavelength of the coherent light 404. In some applications, the cover plate 406 may include anti-reflective coatings to minimize unwanted reflections that could degrade the quality of the structured light pattern. The cover plate 406 may also function as a beam conditioning element, helping to maintain the spatial profile and coherence properties of the coherent light 404 as it propagates through the optical system.

In some embodiments, the cover plate 406 may incorporate additional optical functionality beyond simple protection. For example, the cover plate 406 may include a slight wedge angle to eliminate back-reflections, or may be designed with specific thickness and material properties to introduce controlled phase delays. The cover plate 406 may also serve as a mounting surface for additional optical elements or may include integrated features such as apertures or filters.

The focusing lens(es) 408 may be configured to control the spatial characteristics of the coherent light 404 beam before it reaches the diffractive optical element 410. In some embodiments, the focusing lens(es) 408 may include a converging lens that reduces the beam diameter and increases the beam intensity at the diffractive optical element 410 (or other wavelength-dependent turning element), which may improve the efficiency of the diffraction process. The focusing lens 408 may include a collimating lens that makes the light rays more parallel, ensuring that the coherent light 404 has consistent angular characteristics when interacting with the diffractive optical element 410.

Various types of lenses may be used for the focusing lens lens(es) 408 depending on the specific optical requirements of the system. In some applications, the focusing lens lens(es) 408 may include a plano-convex lens, which has one flat surface and one curved surface, providing focusing capability while minimizing optical aberrations. In other embodiments, the focusing lens(es) 408 may include a biconvex lens with two curved surfaces, which may provide stronger focusing power or better aberration correction. The focusing lens(es) 408 may also include an aspheric lens designed to minimize spherical aberration and provide improved beam quality. In some embodiments, the focusing lens includes multiple lenses.

In some embodiments, the focusing lens(es) 408 may include a compound lens system comprising multiple lens elements to achieve specific optical performance characteristics. For example, the focusing lens(es) 408 may include an achromatic doublet to minimize chromatic aberration, or may incorporate multiple elements to achieve a specific numerical aperture or working distance. The focusing lens(es) 408 may also include a gradient index (GRIN) lens that uses a radially varying refractive index to achieve focusing without curved surfaces.

The focal length of the focusing lens(es) 408 may be selected based on the desired beam characteristics at the diffractive optical element 410 (or other wavelength-dependent turning element). In some applications, a shorter focal length may be used to achieve a smaller beam diameter and higher intensity, while a longer focal length may be used to maintain a larger beam diameter with more uniform intensity distribution. The focusing lens(es) 408 may also be positioned at a specific distance from the coherent light source 402 to achieve optimal beam conditioning for the particular wavelength and beam characteristics of the coherent light 404.

In some embodiments, the focusing optics 403 includes a DOE and/or a metalens configured to focus the light to a certain distance from a few millimeters to infinity.

In one embodiment, the diffractive optical element 410 (or other wavelength-dependent turning element) operates according to the grating equation: nλ=d(sin θₘ−sin θᵢ), where n is the diffraction order, λ is the wavelength of the incident coherent light 404, d is the grating period, θₘ is the diffraction angle, and θᵢ is the incident angle. As the wavelength of the coherent light 404 changes due to temperature variations in the coherent light source 402 (e.g., caused by current modulation of a laser diode), the diffraction angle θₘ changes accordingly, causing the light beam to sweep through a small angular range. The diffractive optical element 410 produces multiple diffraction orders, including −1st-order light 412, 0-order light 414, 1st-order light 416, and 2nd-order light 418, each propagating at different angles.

In embodiments, the diffractive optical element 410 is designed to suppress unwanted diffraction orders while maximizing the efficiency of a desired diffraction order. In an example, the DOE 410 may be configured to output a zero-order, −1^{st}-order, 1^{st}-order, and 2^{nd}-order, and to suppress all other orders. For example, the diffractive optical element 410 may be optimized to maximize the 1st-order light 416 while suppressing other orders such as the −1st-order light 412, 0-order light 414, and 2nd-order light 418. The diffractive optical element 410 may be tilted relative to the optical axis to eliminate negative diffraction orders such as the −1st-order light 412, a −2^{nd}-order light, etc., ensuring that substantially all useful light energy is directed into the positive 1st-order light 416. In embodiments, outcoming light beam output by the DOE 410 will have a high frequency angle flickering proportional to wavelength variations. In one example, for blue light at wavelengths around 400-450 nm (e.g., an approximately 450 nm wavelength) from the coherent light source 402, the diffractive optical element 410 may be tilted at approximately 32 degrees to achieve optimal suppression of unwanted orders including the 0-order light 414 and 2nd-order light 418.

The angular deflection produced by the diffractive optical element 410 translates into lateral displacement of the structured light pattern at the target surface, with the magnitude of displacement being proportional to the working distance between the structured light projector and the intraoral object. This controlled lateral displacement causes the pattern features to smear slightly in one direction during the camera exposure time, effectively averaging multiple speckle patterns and reducing speckle contrast without significantly degrading the overall pattern quality. The focusing optics 403, including the cover plate 406 and focusing lens(es) 408, work in conjunction with the diffractive optical element 410 to ensure that the desired 1st-order light 416 maintains proper beam characteristics for subsequent pattern generation.

The diffractive optical element 410 may be implemented as various types of diffractive structures depending on the specific application requirements. In some embodiments, the diffractive optical element 410 may be a ruled transmission grating, which consists of a series of parallel grooves or lines etched into a transparent substrate. The groove spacing, also referred to as the grating period, determines the angular dispersion characteristics of the element. For applications requiring high efficiency and low stray light, the diffractive optical element 410 may be a blazed grating, where the groove profile is asymmetric and optimized to direct most of the diffracted light into a specific order.

In other embodiments, the diffractive optical element 410 may be a volume phase holographic grating, which uses variations in the refractive index within a thick optical medium rather than surface relief structures. Volume phase holographic gratings may offer advantages such as higher efficiency, lower polarization sensitivity, and reduced sensitivity to wavelength variations compared to surface relief gratings.

The diffractive optical element 410 may also be implemented as a binary phase grating, where the surface relief pattern consists of rectangular grooves with only two depth levels. Binary phase gratings may be easier to manufacture using photolithographic techniques and may provide good efficiency for specific wavelengths and diffraction orders.

In some applications, the diffractive optical element 410 may be a sinusoidal grating, where the surface relief or refractive index variation follows a sinusoidal profile. Sinusoidal gratings may produce primarily first-order diffraction with minimal higher-order contributions, which may be beneficial for applications requiring clean beam steering.

The grating period of the diffractive optical element 410 may be selected based on the desired angular sensitivity to wavelength changes. In one embodiment, the grating period is approximately 1 micrometer, which provides sufficient angular deflection sensitivity while maintaining optical efficiency. For applications requiring larger angular deflections, smaller grating periods may be used, while larger grating periods may be employed when smaller angular changes are desired.

The angular deflection produced by the diffractive optical element 410 translates into lateral displacement of the structured light pattern at the target surface, with the magnitude of displacement being proportional to the working distance between the structured light projector and the intraoral object. This controlled lateral displacement causes the pattern features to smear slightly in one direction during the camera exposure time, effectively averaging multiple speckle patterns and reducing speckle contrast without significantly degrading the overall pattern quality.

The grating period of the diffractive optical element, typically expressed as lines per millimeter or cycles per millimeter, represents one design parameter for the DOE 410. For applications requiring high angular sensitivity to wavelength changes, smaller grating periods (e.g., 1000-2000 cycles per millimeter) may be preferred, as they produce larger angular deflections for a given wavelength change according to the grating equation. However, smaller grating periods also result in higher diffraction angles for the target orders, which may call for more complex optical system layouts and can reduce the overall optical efficiency due to increased sensitivity to manufacturing tolerances and surface quality.

The groove profile of the diffractive optical element impacts the efficiency distribution among different diffraction orders. Blazed gratings, which feature asymmetric groove profiles optimized for a specific wavelength and diffraction order, can achieve efficiencies exceeding 90% for the target order while suppressing unwanted orders to less than 5% of the incident power. The blaze angle, which determines the optimal wavelength and diffraction order, may be calculated based on the target operating wavelength and the intended application. For multi-wavelength applications, the blaze angle may be optimized for the center wavelength of the operating range, accepting some efficiency reduction at the wavelength extremes in exchange for broader spectral performance.

The substrate material and coating design also play roles in DOE performance. Fused silica substrates offer excellent optical quality and thermal stability but may be more expensive than alternative materials such as optical glass or polymer substrates. Anti-reflective coatings applied to the DOE surfaces can significantly improve transmission efficiency and reduce unwanted reflections that could create ghost images or reduce contrast. For wavelength-sensitive applications, the coating design may maintain low reflectance across the entire operating wavelength range while preserving phase relationships for proper diffraction. Advanced coating designs may incorporate multiple dielectric layers with carefully controlled thicknesses to achieve broadband anti-reflection performance while providing additional functionality such as angle-dependent transmission characteristics.

The suppression of unwanted diffraction orders in diffractive optical elements may be based on a combination of careful optical design and strategic implementation of filtering techniques to ensure that only the desired diffraction order reaches the pattern generating optical element. Mechanical blocking represents one of the most straightforward approaches, involving the placement of physical apertures or beam stops at strategic locations along the optical path to intercept unwanted diffraction orders while allowing the target order to pass unobstructed. The positioning of these mechanical elements relies on precise knowledge of the angular separation between different diffraction orders, which can be calculated using the grating equation and verified through optical modeling or experimental measurement. Adjustable apertures may be employed to provide flexibility in optimizing the blocking effectiveness for different operating conditions or wavelength ranges.

Aperture placement strategies may account for the spatial separation of diffraction orders at various distances from the diffractive optical element. Immediately after the DOE, different orders may be angularly separated but not yet spatially separated. Accordingly, the aperture may be positioned at sufficient distance to achieve adequate spatial separation for selective blocking. However, increasing the distance between the DOE and the aperture also increases the overall size of the optical system, creating trade-offs between order suppression effectiveness and system compactness. Variable aperture systems may be implemented using iris diaphragms, sliding masks, or electronically controlled spatial light modulators that can dynamically adjust the blocking characteristics based on real-time optimization of the projected pattern quality.

Advanced order suppression techniques may incorporate angle-selective optical filters that provide wavelength and angle-dependent transmission characteristics. These filters, typically implemented as multilayer dielectric coatings, can be designed to have high transmission for light incident at the angle corresponding to the target diffraction order while providing high reflection for light at angles corresponding to unwanted orders. The design of such filters involves sophisticated thin-film modeling to optimize the layer thicknesses and refractive indices for the specific wavelength and angular requirements of the application. Polarization-selective suppression techniques may also be employed, taking advantage of the fact that different diffraction orders may have different polarization characteristics, allowing unwanted orders to be suppressed using polarizing filters while preserving the desired order. In some embodiments, dielectric band-pass filters may be employed to provide angle-selective transmission characteristics that complement the order suppression capabilities of the diffractive optical element. These dielectric filters may comprise alternating stacks of dielectric layers with thicknesses and refractive indices selected to create constructive interference for light at angles corresponding to the desired diffraction order while creating destructive interference for light at angles corresponding to unwanted orders. When working with coherent light sources having a narrow wavelength range (e.g., a few nanometers), the design of such angle-selective dielectric filters may be simplified compared to broadband applications. The dielectric filter may be positioned between the first diffractive optical element and the pattern generating optical element, or may be integrated as a coating on one of these elements. In some embodiments, the dielectric filter may be optimized for the specific angle at which the desired diffraction order exits the first diffractive optical element, providing high transmission at that angle while reflecting or absorbing light at other angles. The combination of multiple suppression techniques, such as mechanical apertures, angle-selective filters, and polarization control, may provide superior order suppression performance compared to any single technique alone.

FIG. 4B is a chart showing light intensity for different orders of light passing through the diffractive optical element of FIG. 4A at different angles, in accordance with embodiments of the present disclosure. The chart illustrates the relative intensity distribution among the various diffraction orders produced by the diffractive optical element 410, including the −1st-order light 412, 0-order light 414, 1st-order light 416, and 2nd-order light 418. In embodiments, the diffractive optical element 410 is designed and optimized to maximize the intensity of a target diffraction order, such as the 1st-order light 416, while suppressing unwanted orders including the 0-order light 414 and higher-order diffractions. The chart demonstrates how the grating parameters, including the grating period and groove profile, can be tailored to achieve optimal energy distribution, with the majority of the incident coherent light 404 being directed into the 1st-order light 416 that is subsequently used for structured light projection. The suppression of unwanted orders, as shown in the intensity distribution, helps to minimize parasitic light that could degrade the quality of the projected structured light pattern and reduces energy loss that would otherwise occur if significant portions of the coherent light were distributed among multiple diffraction orders. As shown, there is a peak for the 0-order light at a zero degree angle, indicating the 0-order light passes through the DOE without an angle change. Additionally, there is another peak for the 1st-order light at around 27 degrees, and there is a third peak for the 2nd-order light at around 65 degrees according to one DOE configuration. As shown, the x-axis represents angle relative to an optical axis of the focusing optics 403, and the y-axis represents light intensity.

FIG. 4C illustrates a structured light projector 420 that incorporates the diffractive optical element 410 of FIG. 4A along with additional optical components to generate a structured light pattern, in accordance with embodiments of the present disclosure. The structured light projector 420 includes the coherent light source 402, focusing optics 403 comprising the cover plate 406 and focusing lens 408, and the diffractive optical element 410 as previously described. Beyond these components, the system further incorporates a pattern generating optical element 422, which may comprise a second diffractive optical element (DOE) configured to convert the angularly deflected coherent light from the first diffractive optical element 410 into a structured light pattern.

The pattern generating optical element 422 may be implemented using various optical technologies depending on the specific application requirements. In some embodiments, the pattern generating optical element 422 may comprise a second diffractive optical element with a rectangular or hexagonal pattern arrangement designed to create discrete spots or other pattern features. Alternatively, the pattern generating optical element 422 may be implemented as a microelectromechanical systems (MEMS) device that can dynamically control the pattern generation through electronically controlled micro-mirrors or other movable elements. In other embodiments, the pattern generating optical element 422 may comprise a mirror goniometer system that uses precisely controlled mirror angles to direct light into specific pattern configurations. The pattern generating optical element 422 may also be implemented as a transmission mask with predetermined apertures, a holographic optical element, or a micro-lens array that focuses the incident light into discrete pattern features.

The pattern generating optical element 422 may be implemented using various advanced optical technologies beyond traditional diffractive optical elements. Microelectromechanical systems (MEMS) devices represent one alternative implementation that offers dynamic control over pattern generation through electronically controlled micro-mirrors or other movable elements. MEMS-based pattern generators may include arrays of individually controllable micro-mirrors, each capable of being tilted or moved to direct light in specific directions. This approach allows for real-time modification of the projected pattern, enabling the system to adapt the pattern characteristics based on scanning conditions, target surface properties, or measurement requirements.

Mirror goniometer systems provide another alternative implementation that uses precisely controlled mirror angles to direct light into specific pattern configurations. These systems may employ galvanometer-driven mirrors or piezoelectric actuators to achieve rapid and accurate angular positioning of mirrors that deflect portions of the incident light beam. The mirror goniometer approach may offer advantages in terms of pattern flexibility and the ability to generate complex, non-repetitive patterns that can be optimized for specific scanning scenarios. Additionally, mirror goniometers may provide higher optical efficiency compared to some diffractive approaches, as they rely on reflection rather than diffraction to redirect light.

Other alternative implementations may include spatial light modulators (SLMs) that use liquid crystal technology to create programmable phase or amplitude patterns, digital micromirror devices (DMDs) that use arrays of individually controllable mirrors, or holographic optical elements that can generate complex three-dimensional light distributions. Each of these technologies offers unique advantages in terms of pattern flexibility, optical efficiency, response time, and integration complexity. The selection of a particular pattern generating technology may depend on factors such as the required pattern complexity, update rate, optical power handling capability, size constraints, and cost considerations for the specific intraoral scanning application.

In embodiments, the pattern generating optical element 422 is positioned at an angle relative to the optical axis of the focusing optics 403 and the first diffractive optical element 410, where this angle corresponds to the deflection angle at which a target diffraction order of light is output by the diffractive optical element 410. For example, if the first diffractive optical element 410 is optimized to direct the majority of the coherent light 404 into the 1st-order light 416 at approximately 27 degrees relative to the optical axis, then the pattern generating optical element 422 may be positioned at approximately 27 degrees to the optical axis to efficiently receive and process this 1st-order light. This angular alignment ensures that the target diffraction order from the diffractive optical element 410 is optimally coupled into the pattern generating optical element 422, maximizing the efficiency of pattern generation while minimizing losses from unwanted diffraction orders.

The pattern generating optical element 422 receives the wavelength-dependent angularly deflected light from the diffractive optical element 410 and generates a projected pattern 424 comprising multiple discrete pattern features arranged in a predetermined configuration. In embodiments, the projected pattern 424 may comprise an array of spots, a grid pattern, a checkerboard pattern, or other structured light arrangements suitable for three-dimensional scanning applications. The array of spots may be arranged in various configurations, such as a rectangular grid, hexagonal array, or other regular or pseudo-random distributions that provide optimal coverage and feature density for accurate depth measurement. Grid patterns may include line grids with intersecting horizontal and vertical lines, creating a mesh-like pattern that facilitates precise triangulation calculations. Checkerboard patterns may comprise alternating light and dark squares arranged in a regular pattern, where the corners of the squares serve as distinctive features for correspondence matching between projected and captured images. Other structured light arrangements may include stripe patterns with parallel lines of varying thickness or spacing, concentric circles or rings that provide radial reference points, or more complex encoded patterns that incorporate unique identifiers for individual features. The selection of a particular structured light pattern may depend on factors such as the required measurement accuracy, the surface characteristics of the intraoral objects being scanned, the working distance of the scanner, and the computational requirements for pattern recognition and correspondence solving.

In some embodiments, the pattern generating optical element includes an anti-reflective coating, such as described elsewhere herein (e.g., such as with reference to FIG. 7 below).

The combination of the first diffractive optical element 410 and the pattern generating optical element 422 enables the structured light projector 420 to produce the projected pattern 424 with reduced speckle contrast through a controlled wavelength modulation mechanism. When the power or current supplied to the coherent light source 402 is varied, the operating temperature of the light source changes accordingly. For laser diodes and similar coherent light sources, this temperature variation directly affects the wavelength of the emitted coherent light 404, with higher temperatures typically producing longer wavelengths and lower temperatures producing shorter wavelengths. The diffractive optical element 410, operating according to the grating equation, deflects light at different angles depending on the wavelength of the incident light. As the wavelength of the coherent light 404 shifts due to temperature fluctuations in the coherent light source 402, the diffraction angle produced by the diffractive optical element 410 changes proportionally, causing the deflected light beam to sweep through a small angular range. By alternating the coherent light source 402 between two different power or current levels, the wavelength alternates between two distinct values, which in turn causes the diffractive optical element 410 to deflect the light between two corresponding angles. This angular alternation results in the pattern features of the projected pattern 424 moving linearly back and forth between two positions during the camera exposure time. The linear movement of the pattern features effectively smears each individual speckle pattern across a small spatial range, creating multiple overlapping speckle patterns that average together to reduce the overall speckle contrast and associated speckle noise without significantly degrading the quality or detectability of the structured light pattern features.

FIG. 4D illustrates the structured light projector of FIG. 4C and a structured light pattern projected by the structured light projector onto an intraoral object, in accordance with embodiments of the present disclosure. FIG. 4D illustrates a zoomed out view of the structured light projector 420 of FIG. 4C and shows the structured light pattern 424 projected by the structured light projector 420 onto an intraoral object 426, in accordance with embodiments of the present disclosure. The amount of lateral movement and resulting smearing of the pattern features in the projected pattern 424 depends on the distance of the intraoral object 426 from the structured light projector 420, with greater distances resulting in proportionally greater smearing effects. This distance-dependent smearing occurs because the angular deflection produced by the diffractive optical element 410 translates into larger lateral displacements at the target surface as the working distance increases.

During intraoral scanning operations, the scanner may itself be moving relative to the intraoral object 426, which introduces additional motion blur and smearing effects that can complement or interact with the wavelength-modulation-induced smearing. The combination of scanner motion and controlled wavelength modulation may provide enhanced speckle reduction under certain scanning conditions.

The system may control whether to modulate the wavelength of the coherent light source 402 and the frequency of such modulation using either open loop or closed loop control strategies based on various factors. In open loop control, predetermined modulation parameters may be selected based on typical scanning conditions or user-selected scanning modes. In closed loop control, the system may dynamically adjust modulation parameters based on real-time feedback from sensors or image analysis. Factors that may influence the control strategy include the measured or estimated distance to the intraoral object 426, the velocity of scanner movement, the desired level of speckle reduction, and the characteristics of the dental object currently in the field of illumination of the structured light projector 420.

In some embodiments, the natural motion of the intraoral scanner during scanning operations may contribute to speckle reduction independently of wavelength modulation. When the scanner moves at a certain velocity (e.g., 20 mm/sec) during a camera exposure time (e.g., 2 milliseconds), the projected pattern features may traverse a distance on the target surface (e.g., 40 micrometers), causing the speckle patterns to be averaged over the exposure time. This motion-induced speckle averaging may be particularly effective when the scanner and cameras move together relative to a flat surface region where no significant height changes occur. The effectiveness of motion-based de-speckle may depend on factors including the scanning speed, the pulse duration, and the surface geometry of the intraoral object being scanned. In some scanning scenarios where the scanner is moving rapidly, the motion-induced speckle averaging may be sufficient to achieve acceptable speckle contrast levels without requiring additional wavelength modulation, allowing the system to use simpler driving schemes that maximize optical power output.

The system may also take into account the type of dental object being scanned, such as distinguishing between teeth and gingiva, as different tissue types may exhibit different speckle characteristics and may benefit from different modulation strategies. A determination of what dental object is currently being scanned may be made by processing recent 2D images and/or intraoral scans using a trained machine learning model that performs classification of dental structures. This classification information may then be used to optimize the wavelength modulation parameters for the specific type of dental tissue being imaged, potentially improving scanning accuracy and efficiency.

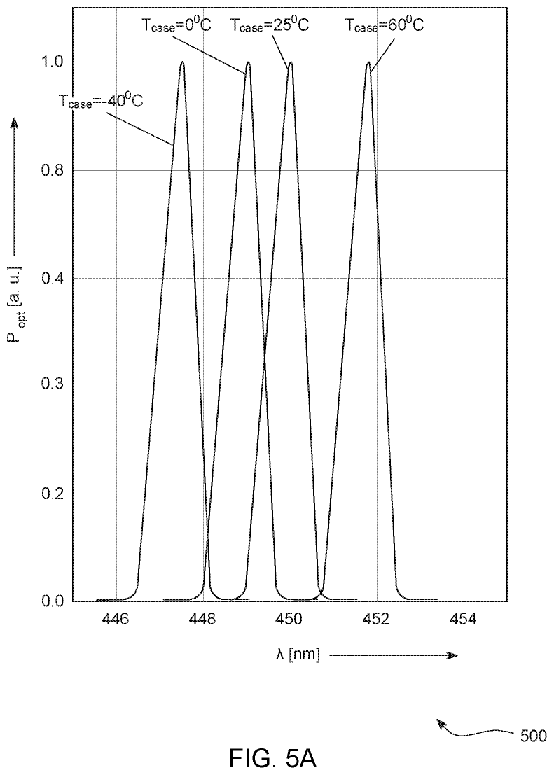

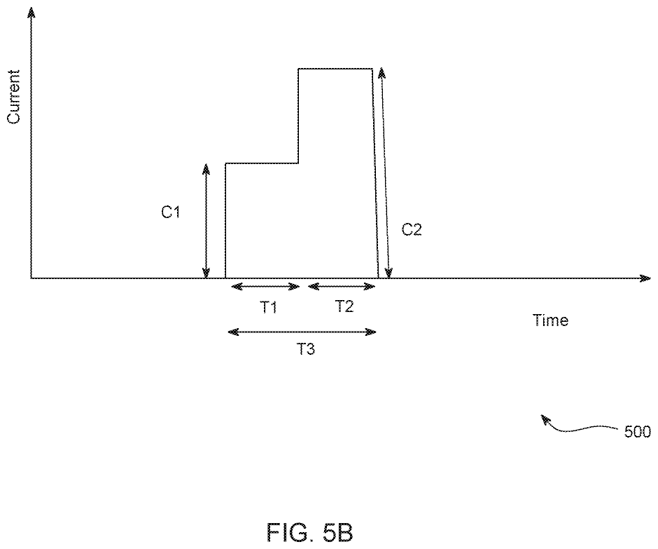

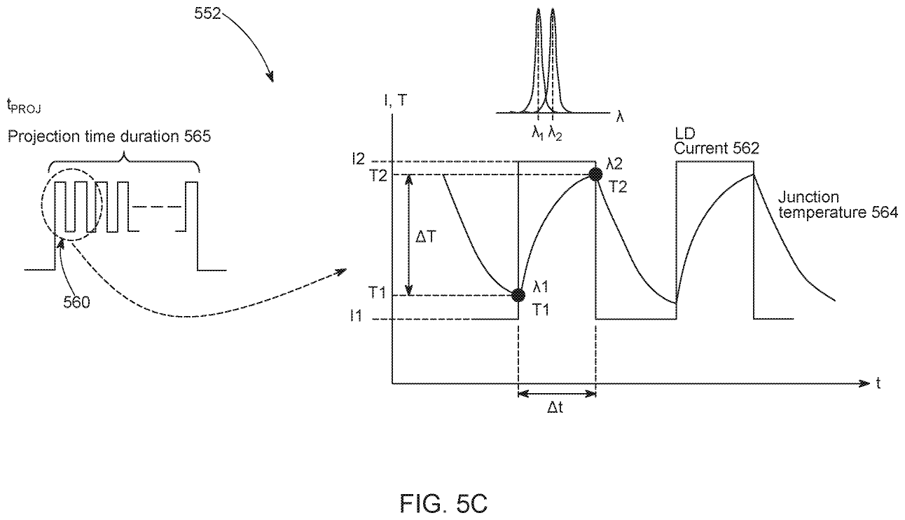

FIG. 5A is a chart showing wavelengths of light output by a laser at different power levels of the laser, in accordance with embodiments of the present disclosure. The chart shows wavelength of light output by a laser diode on the x axis (in units of nm) and power of light output at the different wavelengths (in arbitrary units) on the y axis. A first wavelength peak is shown at about 447 nm, which is achieved at a laser diode temperature of −40 °C. A second wavelength peak is shown at about 449 nm, which is achieved at a laser diode temperature of 0 °C. A third wavelength peak is shown at about 450 nm, which is achieved at a laser diode temperature of 25 °C. A fourth wavelength peak is shown at about 452 nm, which is achieved at a laser diode temperature of 60 °C. In one example embodiment, a current delivered to a laser diode (or other coherent light source) may be rapidly modulated between two values. The rapid modulation of the current may cause the laser diode to fluctuate between about 25 °C and about 60 °C (or between two or more other temperatures). If this rapid fluctuation of the temperature of the laser diode is performed faster than (e.g., at least 2× the speed of) the frame rate of a camera capturing images of dental objects illuminated by the light projector, then both wavelengths of light will be captured in a single image frame. Since each wavelength of light generates a unique speckle pattern when it interacts with a tooth, the number of speckle patterns that are captured in an image may be increased by at least 2×. If the light source can be modulated between three different temperatures within an exposure time used to generate an image frame of a camera, then the number of speckle patterns may be tripled.

In some embodiments, a controller acts as a speckle pattern generating element. The controller causes power and/or current to a light source to fluctuate during an exposure time of a camera, thus increasing a number of speckle patterns that are created to be increased. In some embodiments, the controller may cause multiple light sources (e.g., as shown in FIGS. 3A-B) to fluctuate in power/current, further increasing a number of speckle patterns and further decreasing a speckle contrast. In some embodiments, temperature fluctuation, elliptical/circular polarization and/or multiple light sources are used together to further increase a number of speckle patterns and reduce a speckle contrast.

FIG. 5B illustrates a light projection cycle 550 for a structured light projector (e.g., laser diode) that outputs light using multiple current levels, in accordance with embodiments of the present disclosure. As shown, time is reflected on the x axis, and current to the light source is reflected on the y axis. In embodiments, using less than the maximal allowed current for the laser diode will cause the laser diode to operate at a lower power (and thus a lower temperature), and thus produce a coherent light having a different wavelength than is generated when the structured light projector (e.g., laser diode of the structured light projector) is operated at maximal power (and thus a higher temperature).

As shown, a current delivered to a light source such as a laser diode may change over time. The exposure time of a camera may be T3. A first time T1 may be an amount of time at which a first current (C1) is delivered to the light source. A second time T2 may be an amount of time at which a second current (C2) is delivered to the light source. As shown, T3=T1+T2 in some embodiments. Since C2 is greater than C1, the intensity of light output during T2 is greater than the intensity of light output during T1. As a result, the speckle pattern associated with C2 may have a greater weight than a speckle pattern associated with C1. However, to reduce speckle contrast by as much as possible, the intensity of light output during T2 should be approximately equal to the intensity of light output during T1. In other words, to get a maximum speckle reduction, the two speckle patterns should have the same power. If the two speckle patterns have the same power, the speckle reduction will be √2. However, if one speckle pattern is stronger than the other, the reduction will be smaller.

Accordingly, in some embodiments the time T1 at which the lower current is used may be longer than the time T2 at which the higher current is used. If the time T1 is greater than the time T2, then the amount of time that a camera's image sensor is exposed to light at current C1 is greater than the amount of time that the camera's image sensor is exposed to light at current C2. Careful selection of T1, T2, C1 and C2 may cause the total light exposure of the image sensor during T1 to be equal to the total light exposure of the image sensor during T2. For the case of two current levels C1 and C2 with corresponding times of T1 and T2, and assuming optical power is linear with current, we would like T2*C2=T1*C1.

In embodiments, too small (sub-nano meter) wavelength changes may not generate independent speckle patterns. However, too large wavelength differences will also cause a widening of the pattern feature (e.g., spot) size (e.g., in the outer rings of a diffracted pattern generated by the feature pattern generating optical element). Accordingly, the different temperature levels that the light source is fluctuated between may be carefully chosen to produce wavelengths of light that are different enough to produce independent speckle patterns while not being so different that the feature pattern sizes vary dramatically. In embodiments, the optimal current driving shape will be an optimization of all above effects, and will take into account the speckle reduction level that is achieved, a pattern feature size change in high rings (e.g., at high diffraction angle), and amount of energy per pattern feature.

In one embodiment, the driving parameters may be optimized using a measure of spot detection error. Sets of different conditions may be run on different cases, and analysis may be performed to determine what current fluctuations result in the lowest pattern feature (e.g., spot) detection error. This process can be continued until only marginal differences remain between the different conditions (e.g., between the different current levels used for the light source).

In embodiments, feature pattern detection error may be estimated based on distance of a feature pattern from an epi-polar line, distance of a 3D triangulated feature pattern from a surface, and/or roughness of a resulting 3D surface generated by solving a correspondence problem using the projected feature patterns projected using the different current levels. In some embodiments, the speckle contrast and pattern feature size for one or more feature patterns (e.g., in a part of an array of feature patterns) can be performed in a lab without using a real feature pattern detector.

In embodiments, different optimal light source driving conditions (e.g., currents, times to deliver currents, etc.) may be used for different lasers (for example, green and blue lasers) in embodiments. For example, the driving times and/or currents used for a green laser may be different than those used for a blue laser. In other embodiments, the driving times and currents used for the same type of laser (e.g., two different blue lasers) may differ. Accordingly, a calibration may be performed for a given structured light projector to determine which times and currents to use to drive the light sources of the structured light projectors.

FIG. 5C illustrates a light projection cycle 552 for a structured light projector (e.g., laser diode) that outputs light using multiple current levels, in accordance with embodiments of the present disclosure. The left side of the figure shows a projection time duration 555 for the complete cycle, which represents the time that the structured light projector is turned on to capture an image, typically corresponding to the camera exposure time. The right side shows a zoomed in view of a portion 560 of the cycle. The right side presents a graph with time (t) on the x-axis and both temperature T and current I on the y-axis. The graph demonstrates modulation of a laser diode current 562 between a first current I1 and a second current I2, and corresponding modulation of a junction temperature 564 for the laser diode between a first temperature T1 and a second temperature T2, with an overall temperature delta (ΔT) between the minimum and maximum temperature. The current is modulated at a period of Δt. Above the graph, the figure shows two wavelength peaks λ1 and λ2, where each wavelength corresponds to one of the temperatures T1 and T2, respectively.

The modulation scheme illustrated in FIG. 5C demonstrates the relationship between current control and wavelength output in laser diodes used for structured light projection. When the current delivered to the laser diode alternates between the lower level I1 and the higher level I2, the junction temperature of the laser diode responds accordingly, fluctuating between T1 and T2. In some embodiments, the first current I1 may range from approximately 50 mA to 200 mA, while the second current I2 may range from approximately 100 mA to 400 mA. The corresponding first temperature T1 may range from approximately X to Y, while the second temperature T2 may range from approximately 20 °C to 80 °C. This temperature variation directly affects the wavelength of the coherent light output, with the lower temperature T1 producing wavelength lambda1 and the higher temperature T2 producing wavelength lambda2. The wavelength difference between lambda1 and lambda2 may typically range from approximately 0.5 nm to 5 nm, depending on the laser diode characteristics and the temperature delta applied.

The temperature response of the laser diode junction may be non-linear, as illustrated by the curved transitions in the junction temperature 564 profile. When the current increases from I1 to I2, the temperature initially rises quickly due to the immediate increase in power dissipation, but then the rate of temperature increase slows down as thermal equilibrium is approached. Similarly, when the current decreases from I2 to I1, the temperature initially drops rapidly, but the rate of temperature decrease slows down as the junction approaches the lower thermal equilibrium state. This non-linear thermal response is due to the thermal mass and heat capacity of the laser diode junction and its packaging, which creates thermal time constants that govern the heating and cooling behavior. The non-linear thermal response to current modulation may be taken into account when configuring a modulation scheme for modulating the current to the laser diode in embodiments.

The rapid modulation at period Δt may occur at a frequency that is significantly higher than the camera exposure time, ensuring that both wavelengths are captured within a single image frame. This dual-wavelength operation enables the generation of multiple independent speckle patterns, as each wavelength produces a distinct speckle pattern when the coherent light interacts with dental surfaces. The alternation between lambda1 and lambda2 during the camera exposure time effectively averages the speckle patterns, reducing the overall speckle contrast and improving the quality of pattern feature detection in the captured images. The temperature delta shown in the figure represents the total temperature swing of the laser diode junction, which may be optimized to achieve sufficient wavelength separation for independent speckle pattern generation while maintaining acceptable optical power levels and avoiding excessive thermal stress on the laser diode.

The thermal behavior of laser diodes under current modulation involves complex interactions between electrical power dissipation, heat generation, thermal conduction, and temperature-dependent optical properties. The junction temperature of a laser diode responds to current changes according to multiple thermal time constants that reflect the different thermal masses and heat conduction paths within the device structure. The fastest thermal response, typically occurring on microsecond timescales, corresponds to heating of the active region itself, while slower responses on millisecond to second timescales reflect heating of the laser chip, submount, and package. Understanding these thermal time constants is crucial for designing effective current modulation schemes that achieve the desired wavelength variations while maintaining stable optical output and avoiding thermal damage to the laser diode.

The relationship between junction temperature and optical wavelength in laser diodes is primarily determined by the temperature dependence of the semiconductor bandgap and the thermal expansion of the laser cavity. For typical near-infrared laser diodes, the wavelength temperature coefficient ranges from 0.2 to 0.4 nm per degree Celsius, meaning that temperature changes of 10-20 °C can produce wavelength shifts of 2-8 nm. The thermal modeling accounts for the nonlinear relationship between drive current and junction temperature in embodiments, as higher currents produce disproportionately more heat due to increased series resistance and reduced quantum efficiency at high injection levels.

Advanced thermal modeling may incorporate finite element analysis to predict temperature distributions within the laser diode structure and optimize the current modulation waveforms for specific thermal performance targets. The model may account for factors such as the thermal interface between the laser chip and its mount, the thermal conductivity of packaging materials, and the heat dissipation capacity of the scanner housing. This detailed thermal analysis enables the design of current modulation schemes that achieve maximum wavelength variation while maintaining junction temperatures within safe operating limits and minimizing thermal stress that could affect long-term reliability. The thermal model may also be used to predict the warm-up behavior of the laser diode and implement compensation algorithms that maintain consistent wavelength modulation performance as the device reaches thermal equilibrium.

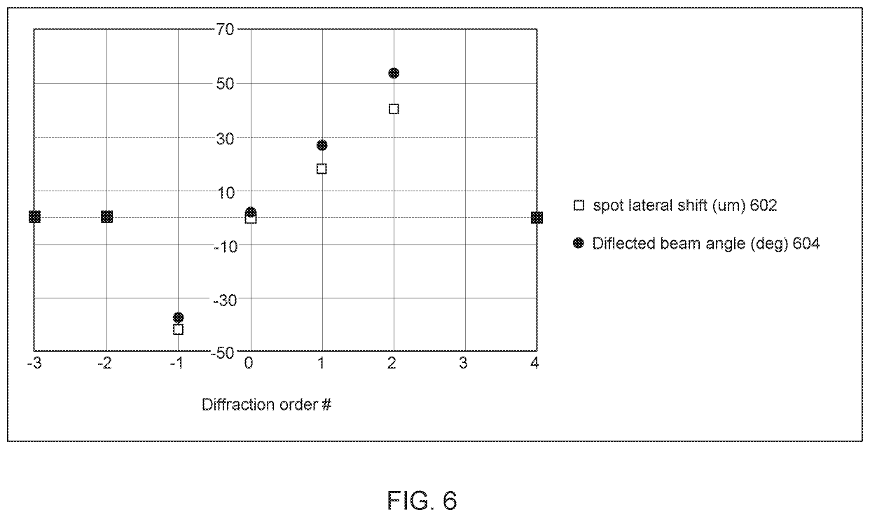

FIG. 6 is a chart showing lateral spot shift and deflected beam angle verses diffraction order, in accordance with embodiments of the present disclosure. The chart displays diffraction order number on the x-axis, with spot lateral shift 602 measured in microns and deflected beam angle 604 measured in degrees plotted for different diffraction orders. The chart demonstrates the relationship between diffraction order and both the lateral displacement of pattern features and the angular deflection of the diffracted beam produced by a diffractive optical element. As the diffraction order increases, both the lateral spot shift 602 and the deflected beam angle 604 increase correspondingly, illustrating how higher-order diffractions result in greater angular separation and larger lateral displacements of the projected pattern features. This relationship shows how different diffraction orders can be spatially separated and selectively utilized for structured light projection applications in embodiments. FIG. 6 shows the lateral spot shift as detected at a particular distance (e.g., 18 mm in one example), which may correspond to the focusing distance of the structured light projector where spot size is minimal. Since the deflection is angular, as the distance increases, lateral shift also increases.

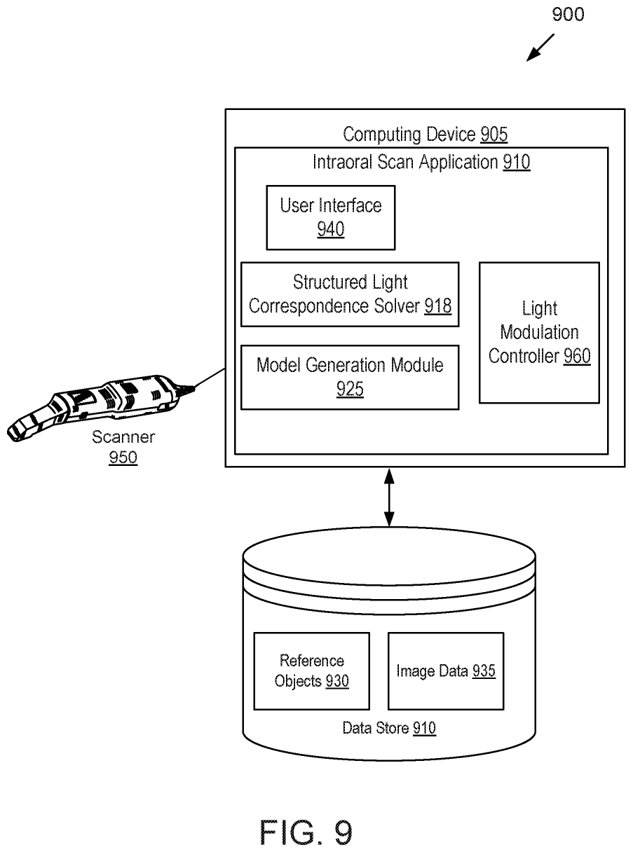

Ultimately, the structured light projectors described herein may be used in an intraoral scanner, such as the intraoral scanner of FIGS. 9-11. Such an intraoral scanner may be used under different scanning conditions in embodiments. In some scanning conditions, one type of driving of the structured light projectors (e.g., timing and/or currents used, referred to as a power fluctuation scheme) may be preferred over another type of driving of the structured light projectors (e.g., another power fluctuation scheme). For example, for orthodontic treatment, resolution may be less critical and movement of the intraoral scanner during scanning may be fast. This may cause de-speckle to be achieved by motion of the intraoral scanner. Accordingly, a smaller and/or shorter pulses without varying of currents delivered to the light source may be used for orthodontic scanning. In another example, for scanning for restorative treatment a high precision may be particularly important (e.g., when scanning a margin line), and thus a high de-speckle may be useful. The scanner may be moved slowly for restorative scanning, and thus motion blur may not be significant enough to help with de-speckle. Accordingly, multiple different currents may be used during a camera exposure for restorative scanning to increase de-speckle and reduce speckle contrast. In a third example, scanning of an edentulous gingiva may be performed at high speed and at a large distance between the intraoral scanner and the edentulous dental arch. Additionally, the gingiva may not produce a speckle pattern when illuminated by the coherent light. Accordingly, a maximum power/current output may be used when scanning an edentulous region and attempts may not be made to reduce speckle contrast.

In embodiments, by knowing the type of scan (or part of scan) being performed (e.g., a scanning regime), different driving methods (e.g., different power fluctuation schemes, some of which may include not fluctuating the power of the light source) can be dynamically selected for the intraoral scanner. In some embodiments, processing logic automatically determines a type of scan being performed (e.g., a scanning regime) based on processing of received image data (e.g., intraoral scans, 3D surfaces generated from intraoral scans, 2D images, etc.). For example, processing logic may determine whether an orthodontic scanning regime, a restorative scanning regime, or an edentulous scanning regime is appropriate.

Different scanning regimes in intraoral scanning applications may use tailored power fluctuation schemes to optimize the balance between speckle reduction and measurement accuracy in embodiments. For orthodontic scanning regimes, where the scanner typically moves rapidly across tooth surfaces to capture overall tooth positions and orientations, minimal wavelength modulation may be employed. In this regime, the natural motion blur created by the rapid scanner movement provides inherent speckle averaging, making additional wavelength-induced smearing unnecessary or potentially counterproductive. The power fluctuation scheme for orthodontic scanning may use constant current levels or very low-frequency modulation (e.g., 1-10 Hz) with small amplitude variations to maintain consistent optical power while minimizing pattern feature smearing that could degrade the detection of tooth boundaries and contact points.

Restorative scanning regimes, which focus on high-precision measurements of preparation margins, crown preparations, and other critical dental features, may Include use of aggressive power fluctuation schemes optimized for maximum speckle reduction. In these applications, the scanner typically moves slowly or remains stationary for extended periods to capture fine details, providing minimal natural motion blur. The power fluctuation scheme may employ high-frequency modulation (e.g., 10-100 kHz) with larger amplitude variations to maximize wavelength diversity and speckle pattern averaging. The current levels may alternate between 50-150 mA for the low state and 200-400 mA for the high state, with duty cycles optimized to maintain equal energy distribution between the different wavelengths while staying within eye safety limits and laser diode thermal constraints.

Edentulous scanning regimes, used for scanning gum tissue and edentulous ridges, may employ intermediate power fluctuation schemes that account for the different optical properties of soft tissue compared to hard tooth structure. Gingival tissue typically produces weaker speckle patterns due to its softer, more diffusely scattering surface, and may call for higher optical power levels to achieve adequate signal-to-noise ratios in some instances. The power fluctuation scheme for edentulous scanning may use moderate-frequency modulation (e.g., 1-10 kHz) with emphasis on maintaining high average optical power rather than maximizing wavelength diversity. The current modulation may be optimized to provide sufficient speckle reduction while preserving the higher power levels needed for effective imaging of the less reflective gingival surfaces.

In one embodiment, image data is processed using a trained artificial intelligence (AI) model such as a convolutional neural network (CNN), which may output a scanning mode prediction. For example, the AI model may output a edentulous mode prediction (e.g., if no teeth are detected in the image data), may output a restorative mode prediction (e.g., if a preparation tooth is detected in the image data), or may output an orthodontic mode prediction (e.g., if teeth are detected and no preparation teeth are detected). Based on the predicted mode, the intraoral scanner (or a computer connected to the intraoral scanner that together with the intraoral scanner forms an intraoral scanning system) may then automatically select a scanning mode most appropriate for a current situation. Alternatively, the intraoral scanner or intraoral scanning system may output a recommendation for a scanning mode, and may receive a selection of a scanning mode. Alternatively, the intraoral scanner or intraoral scanning system may receive a selection of a scanning mode without outputting a recommendation.

In some embodiments, a structured light projector may be coupled to or incorporate a vibrator configured to vibrate the structured light projector during light projection. By vibrating the structured light projector, the output light may move back and forth rapidly in embodiments, which may effectively smear a speckle pattern produced when coherent light of the structured light pattern interacts with a tooth. Accordingly, the vibrator may be a speckle pattern generating element that increases a number of speckle patterns by vibrating the structured light projector. In some embodiments, just one or more components of the structured light projector are vibrated by the vibrator, while other components may not vibrate. For example, the light source, lens, and/or pattern generating optical element may be vibrated by the vibrator.

In some embodiments, the vibrator may be configured to mechanically oscillate one or more optical components to create temporal variations in the speckle patterns. The vibrator may be implemented using various actuation technologies, including piezoelectric actuators, electromagnetic actuators, or micro-electromechanical systems (MEMS) devices. Piezoelectric actuators offer advantages in terms of precise displacement control, high frequency response, and low power consumption, making them suitable for creating small-amplitude, high-frequency vibrations of optical elements such as the light source, focusing lenses, or pattern generating optical elements. The vibration amplitude may be controlled to create lateral displacements on the order of micrometers to tens of micrometers, sufficient to decorrelate speckle patterns without significantly degrading the overall pattern quality.

The vibrator may operate at frequencies ranging from hundreds of hertz to several kilohertz, with the optimal frequency selected based on the camera exposure time and the desired level of speckle averaging. Higher vibration frequencies provide more thorough speckle averaging within a given exposure time but may require more sophisticated control systems and higher power consumption. The vibration pattern may be sinusoidal, triangular, or more complex waveforms designed to provide uniform coverage of the speckle decorrelation space. In some embodiments, multiple vibrators may be used to create multi-dimensional motion patterns, such as circular or elliptical trajectories, that provide more comprehensive speckle averaging than simple linear oscillations.

The vibrator system may be integrated with the wavelength modulation control to provide coordinated speckle reduction through both mechanical and optical means. For example, the vibration frequency and amplitude may be dynamically adjusted based on the effectiveness of wavelength modulation, with mechanical vibration providing additional speckle reduction when wavelength modulation alone is insufficient. The system may also implement feedback control based on real-time analysis of speckle contrast in captured images, automatically adjusting vibration parameters to maintain optimal speckle reduction performance under varying scanning conditions.

As discussed above, the quality of structured light patterns output by a structured light projector may be improved by increasing a number of speckle patterns produced by a coherent light source, and ultimately by reducing a speckle contrast. The quality of structured light patterns may also be improved by improving the uniformity of pattern features of the structured light pattern. Achieving high uniformity between the pattern features is difficult, and there are tradeoffs between cost of a feature pattern generating optical element (e.g., a DOE) and a quality of the feature pattern generating optical element, where higher quality feature pattern generating optical elements produce light patterns with increased uniformity. In some embodiments, the uniformity of the structured light pattern can be improved, even for cheap feature pattern generating optical elements, by carefully designed dielectric layer stacks (e.g., anti-reflective coatings). Embodiments describe a set of thin film dielectric layers, at one side of a feature pattern generating optical element such as a DOE, to remove any parasitic pattern features (e.g., spots) that are outside of a defined field of view (FOV) or field of illumination of a structured light projector.

FIG. 7 illustrates a structured light projector 700 that generates a structured light pattern having improved structured light projection (e.g., that generates a light pattern having pattern features with improved uniformity), in accordance with embodiments of the present disclosure. The structured light projector 700 includes a light source 736 that outputs coherent and non-structured light. A lens 730 focuses the coherent and non-structured light. A pattern generating optical element 738 (e.g., such as a DOE) receives the coherent non-structured light and outputs coherent structured light having a particular light pattern. Disposed on the pattern generating optical element 738 is a dielectric layer stack 770 that includes layers 772A, 772B, 774A, 774B of alternating materials and/or thicknesses. For example, layers 772A-B may be a first material and/or have a first thickness, and layers 774A-B may be a second material and/or have a second thickness. In embodiments, more then two types of layers may be included in the dielectric layer stack 770. Additionally, in embodiments more layers than those shown may be used.

The antireflective coating may correspond to the dielectric layer stack 770 of FIG. 7 in embodiments. The dielectric layer stack may be chosen such that it increases a transmittance of the coherent light of the structured light pattern output by the structured light projector at first angles of incidence below an angle threshold and increases a reflectance of the coherent light at second angles of incidence above the angle threshold. In some embodiments, the angle threshold is about 45 degrees. However, other angle thresholds may also be used. The angles of incidence may be angles between rays of light associated with pattern features and a plane defined by the antireflective coating in embodiments. Accordingly, pattern features that are associated with higher angles of incidence may be suppressed, and pattern features that are associated with lower angles of incidence may not be suppressed. This may have an effect of increasing an intensity uniformity of the pattern features that are passed through the dielectric layer stack (e.g., through the antireflective coating).

In an example, structured light projector may include a laser diode light source and a pattern generating optical element that includes a diffractive pattern and/or a micro lens array that outputs a rectangular grid or hexagonal grid of pattern features (e.g., spots). A pattern generating optical element such as a diffractive optical element (DOE) may be defined by a few quality measures, as follows:
i) Zero order is the beam of the structured light pattern in the zero direction. It will usually be stronger than the other beams. When the zero order beam is very strong (e.g., over ×2 or ×10) it may become saturated and/or reduce the detectability of the neighboring beams (e.g., and thus of neighboring feature patterns.
ii) Beam uniformity/non uniformity is the difference in intensity between different beams (and thus different pattern features). Beam uniformity could be measured as the maximum intensity minus the minimum intensity of any beams divided by an average intensity of the beams. Alternatively, beam uniformity could be measured as the difference between two percentiles (e.g., the maximum intensity percentile and the minimum intensity percentile). Alternatively, beam uniformity may be measured as the standard deviation or the Gino index of beam intensity. High non-uniformity will create week pattern features (e.g., spots) that are hard to detect as well as saturated pattern features (e.g., spots) that occlude their neighborhoods.
iii) Roll-off is a measure of the average intensity of a beam as function of its distance from center. Generally there will not be a clear fall to zero value, but instead a more gradual fall. The gradual roll-off (reduction in intensity with distance from center and with increased angle) is detrimental to uniformity. A hard stop (rapid reduction to zero after a certain distance or angle) reduces computation and confusion in pattern feature detection.

Measures i and ii are specific cases of non-uniformity, but roll-off (measure iii) can also make the uniformity computation not well defined.

When designing a DOE, different design requirements have a tradeoff between them. For a given minimal feature size, a ×1 zero order may affect other aspects of uniformity. A strong fall to zero of the roll-off will affect other non-uniformity. All parameters of quality can be improved if the minimal feature size is reduced, but that requires more manufacturing time in manufacture of the pattern generating optical element, and fine process control, raising the cost the product.

In embodiments, the effect of roll-off is resolved or ameliorated by adding a special design of dialectic layers on one side of the feature pattern generating optical element. In some embodiments, the dielectric layer stack is referred to herein as an antireflective coating. However, in embodiments the dielectric layer stack acts as an antireflective coating only for certain combinations of light wavelength and angle of incidence that is below an angle threshold, and acts as a reflective layer for combinations of light wavelength and angle of incidence that is at or above the angle threshold. For example, when moving from air to glass for light, some of the light will reflect back off of the glass and some of the light will penetrate the glass. The Fresnel coefficient shows how much light is reflected and how much light is transmitted per angle. Optical systems may be designed to reduce this effect. One method of reducing this effect is using layers of dialectic material with different indexes of reflection, such that negative and positive inference are designed to reduce and/or increase reflection at various angles of incidence.

For a single angle and wavelength, one can theoretically reach perfect zero back reflection. Generally, such a coating is designed to achieve a reduced reflection over a range of angles and wavelengths. This is difficult to achieve, and quality of results is limited by a cost of more and more layers and manufacturing tolerance. By using coherent light with a limited range of wavelengths, the design of the dielectric layer stack can be simplified in embodiments.

In embodiments, the stack of dielectric layers is designed to provide better transmittance up to a selected angle of incidence, and to provide increased reflection at angles above the selected angle of incidence. Since coherent light is used in embodiments, the range of light wavelengths may be only a few nm, making the design of the stack of dielectric layers that can achieve the above goals simpler. In some embodiments, different structured light projectors used in an intraoral scanner may output different wavelengths of light. For example, a first structured light projector may output green light and a second structured light projector may output blue light. Different dielectric layer stacks may be used for the different structured light projectors, where each dielectric layer stack may be optimized for a different wavelength or wavelength range.

FIG. 8 is a chart 800 showing transmittance through a dielectric layer stack (e.g., an antireflective coating) on a transparent surface of a structured light projector with different angles of incidence, in accordance with embodiments of the present disclosure. As shown, the light transmittance may be 100% up to an angle of incidence of 40 degrees, after which a rapid roll-off of intensity may be provided, reducing the transmittance to 0% after about 70 degrees in one embodiment, and reducing the transmittance to 0% after 40 degrees in another embodiment. It may be difficult to achieve a perfect cutoff of light at the target threshold angle, and optimization of the dielectric layer stack may be performed to get as close as possible to the ideal roll-off (e.g., perfect cutoff of light above the target threshold angle).

FIG. 9 illustrates one embodiment of a system 900 for performing intraoral scanning and/or generating a virtual three-dimensional (3D) model of a dental site (e.g., that may include a reflective object). System 900 includes a computing device 905 that may be coupled to an intraoral scanner (also referred to simply as a scanner) 950 and/or a data store 910. In embodiments, intraoral scanner 950 includes one or more speckle pattern generating elements as described above and/or a dielectric layer stack (e.g., an antireflective coating) as described above that improve a quality of a structured light pattern that is output by structured light projectors of the intraoral scanner 950.

Computing device 905 may include a processing device, memory, secondary storage, one or more input devices (e.g., such as a keyboard, mouse, tablet, and so on), one or more output devices (e.g., a display, a printer, etc.), and/or other hardware components. Computing device 905 may be connected to a data store 910 either directly or via a network. The network may be a local area network (LAN), a public wide area network (WAN) (e.g., the Internet), a private WAN (e.g., an intranet), or a combination thereof. The computing device 905 and/or the data store 910 may be integrated into the scanner 950 in some embodiments to improve performance and mobility.

Data store 910 may be an internal data store, or an external data store that is connected to computing device 905 directly or via a network. Examples of network data stores include a storage area network (SAN), a network attached storage (NAS), and a storage service provided by a cloud computing service provider. Data store 910 may include a file system, a database, or other data storage arrangement.

In some embodiments, a scanner 950 for obtaining three-dimensional (3D) data of a dental site in a patient's oral cavity (referred to as an intraoral scanner) is also operatively connected to the computing device 905. Scanner 950 may include a probe (e.g., a hand held probe) for optically capturing three dimensional structures (e.g., by confocal focusing of an array of light beams).

The scanner 950 may be used to perform an intraoral scan of a patient's oral cavity. A result of the intraoral scan may be a sequence of intraoral scans, each of which may include or be based on multiple images, each captured by a different camera of the intraoral scanner simultaneously or approximately simultaneously. An operator may start recording the video (e.g., sequence of intraoral scans) with the scanner 950 at a first position in the oral cavity, move the scanner 950 within the oral cavity to a second position while the video is being taken, and then stop recording the video. In some embodiments, recording may start automatically as the scanner identifies that it has been inserted into a patient oral cavity. The scanner 950 may transmit the intraoral images or intraoral scans (e.g., 3D point clouds generated from the intraoral images) to the computing device 905. Note that in some embodiments the computing device may be integrated into the scanner 950. Computing device 905 may store the image data 935 in data store 910. Alternatively, scanner 950 may be connected to another system that stores the image data in data store 910. In such an embodiment, scanner 950 may not be connected to computing device 905.

In some embodiments, the scanner 950 includes an elongate wand including a probe at a distal end of the wand; a rigid structure disposed within a distal end of the probe; one or more structured light projectors coupled to the rigid structure and one or more non-structured light projectors coupled to the rigid structure, such as non-coherent light projectors and/or near-infrared light projectors; and one or more cameras coupled to the rigid structure. In some applications, each light projector may have an angular field of view (AFOI) of 45-120 degrees. Optionally, the one or more light projectors may utilize a laser diode light source, a light emitting diode (LED) light source, and/or other light source. Further, the structured light projector(s) may include a beam shaping optical element. Further still, the structured light projector(s) may include a feature pattern generating optical element.

The feature pattern generating optical element may be configured to generate a light pattern (structured light) such as a distribution of discrete unconnected spots of light, a checkerboard pattern, a grid pattern, a line pattern, or other pattern. The light pattern may be generated at all planes located between specific distances (e.g., 0-30 mm, 0-20 mm etc.) from the feature pattern generating optical element when the light source (e.g., laser diode) is activated to transmit light through the pattern generating optical element. In some applications, the feature pattern generating optical element utilizes diffraction and/or refraction to generate the distribution. In some embodiments, the feature pattern generating optical element includes a transmission mask that generates the distribution. In some embodiments, the feature pattern generating optical element has a light throughput efficiency of at least 90%.

The structured light projectors of the intraoral scanner 950 may additionally include one or more speckle pattern generating elements, as described above. The speckle pattern generating elements may include one or more speckle pattern generating optical elements (e.g., such as an elliptical or circular polarizer), a controller configured to fluctuate a current/power delivered to light sources of the structured light projectors, a vibrator, a wavelength-dependent turning element, a combination of multiple light sources that output overlapping light of the same or similar wavelengths, and so on. In some embodiments, the structured light projectors may include a first diffractive optical element configured to adjust an angle of coherent light to an optical axis based on wavelength, wherein the first diffractive optical element causes coherent light at a first wavelength and a first order to have a first angle to the optical axis and causes coherent light at a second wavelength and/or a second order to have a second angle to the optical axis. The first diffractive optical element may be tilted relative to the optical axis so that the light at the first order is transmitted to a pattern generating optical element, while light of other orders may not be transmitted to the pattern generating optical element. In embodiments, the diffractive optical element is a linear grating. In some embodiments, the first diffractive optical element may be a ruled transmission grating or a volume phase holographic grating. The intraoral scanner 950 may additionally include one or more features that improve a uniformity of the structured light pattern, such as a dielectric layer stack on the feature pattern generating optical element that increases a transmittance of light coming out of the feature pattern generating optical element at first angles of incidence below an angle threshold and increases a reflectance of the light at second angles of incidence above the angle threshold.

In some embodiments, an intraoral scanner may include multiple structured light projectors that are configured with different diffractive optical element parameters optimized for their respective intended working distances. For example, a first structured light projector intended for restorative scanning applications may be optimized for a first working distance (e.g., approximately 12 millimeters), while a second structured light projector intended for orthodontic scanning applications may be optimized for a second working distance (e.g., approximately 7 millimeters). The first diffractive optical element of each projector may have a grating period and/or tilt angle selected such that the amount of pattern feature smearing at the respective optimal working distance achieves a target percentage of the pattern feature size (e.g., approximately one-half of the spot diameter). By tailoring the diffractive optical element configuration to the intended working distance of each projector, the system may achieve consistent speckle reduction performance across different scanning modes while maintaining acceptable pattern feature quality at the distances where each projector is expected to operate most frequently.

For some applications, the light projectors and/or the cameras are positioned such that one or more light projector and/or one or more cameras faces an object outside of the wand placed in its field of illumination. Optionally, each camera may face an object outside of the wand placed in its field of view. Additionally, or alternatively, one or more light projectors and/or cameras may face a mirror that reflects light to/from an object being scanned. Further, in some applications, at least 20% of the pattern features are in the field of view of at least one of the cameras.

Scanner 950 may drive each one of one or more structured light projectors to project a light pattern (e.g., a distribution of discrete unconnected spots of light, a checkerboard pattern, etc.) on an intraoral three-dimensional surface and/or may drive one or more non-structured light projectors to project non-structured light onto the intraoral 3D surface. Scanner 950 may further drive each one of one or more cameras to capture an image, the image including one or more image features corresponding to pattern features projected by one of the structured light projectors of the scanner 950 if structured light was projected. Each one of the one or more cameras may include a camera sensor including an array of pixels. The images captured together at a particular time may constitute an image set and may together form an intraoral scan. The intraoral scans may be transmitted to computing device 905 and/or stored in data store 910 as scan data 935.

Computing device 905 may include an intraoral scan application 910 for facilitating intraoral scanning and generating 3D models of dental arches and/or intraoral objects from intraoral scans. Intraoral scan application 910 may include a user interface 940, a structured light correspondence solver 918, and/or a model generation module 925. The modules 940, 918, 925 may be software modules that are components of a single software application (e.g., different libraries of a single application), may be distinct software applications, may be firmware, may be hardware modules, and/or a combination thereof. In some embodiments, one or more of the modules 940, 918, 925, or portions thereof, may execute on scanner 950 in addition to, or instead of, on computing device 905.

Structured light correspondence solver 918 may process image data 935 (e.g., images captured during structured light projection by scanner 950) and compare against known projected structured light patterns to determine which captured structured light features correspond to which projected structured light features. Structured light correspondence solver 918 may determine 3D points in space corresponding to the solutions to the correspondence problem, which may correspond to points on a surface of an imaged object. 3D point clouds may be generated from the determined 3D points in space. In embodiments, structured light correspondence solver 918 solves a correspondence problem for sets of images captured at a same time by different cameras of the scanner 950 to generate a 3D point cloud. The 3D point clouds may then be used by model generation module 925 to generate a 3D surface and/or a 3D model of a dental site (e.g., of a dental arch, a portion of a dental arch, etc.).

In embodiments, structured light correspondence solver 918 may execute a correspondence algorithm on intraoral scans to determine the depths of spots or points (e.g., points at which feature patterns illuminate a surface) in the intraoral scans. The structured light correspondence solver 918 may access stored calibration data indicating (a) a camera ray of image feature corresponding to each pixel on the camera sensor of each one of the one or more cameras, and (b) a projector ray corresponding to each of the projected pattern features from each one of the one or more projectors and/or one or more projector rays corresponding to each nonstructured light projector, where each projector ray corresponds to a respective path of pixels on at least one of the camera sensors. Using the calibration data and the correspondence algorithm, structured light correspondence solver 918 may determine which captured feature patterns correspond to which projected feature patterns, and determine 3D coordinates for points associated with the captured feature patterns based on the correspondence and triangulation.

Model generation module 925 may perform surface registration between intraoral scans (e.g., may stitch together the intraoral scans as discussed above). Model generation module 925 may then generate a virtual 3D model of a dental arch from the registered intraoral scans, as discussed above.

User interface 940 may function during an intraoral scan session. As scanner 950 generates intraoral images and those intraoral images are processed by structured light correspondence solver 918 and/or model generation module 925, a view screen showing a two-dimensional (2D) or 3D representation of a scanned dental site may be output to a display (e.g., of computing device 905). Images may be stitched together during the intraoral scan session to continuously update the representation of the dental site during the intraoral scan session. Image registration processes and model generation processes may be performed to continually update a 3D surface. The representation of the dental site may show a user of the scanner 950 what areas have been sufficiently imaged and which areas would benefit from further imaging.

In embodiments, computing device 905 may include a light modulation controller 960 as part of the intraoral scan application 910. The light modulation controller 960 may be configured to analyze multiple control inputs and feedback mechanisms to optimize wavelength modulation parameters for improved scanning accuracy. The light modulation controller 960 may operate using either open loop control strategies, where predetermined modulation parameters are selected based on typical scanning conditions or user-selected scanning modes, or closed loop control strategies, where the system dynamically adjusts modulation parameters based on real-time feedback from inputs such as sensors or image analysis.

The light modulation controller 960 may be configured to determine a velocity of the intraoral scanner 950 through various methods, including analyzing sequential image frames to detect motion blur patterns, receiving an input from an inertial measurement unit (IMU), processing data from integrated accelerometers or gyroscopes within the scanner (e.g., from the IMU), and/or calculating displacement between successive intraoral scans (e.g., 3D point clouds). For example, when the scanner velocity is high (e.g., greater than 10 mm/s), natural motion blur may already provide sufficient speckle averaging, allowing the controller to reduce or eliminate wavelength modulation to preserve pattern feature sharpness. Conversely, when the scanner is moving slowly (e.g., less than 2 mm/s) or is stationary during detailed scanning of critical areas such as preparation margins, the controller may increase the wavelength modulation frequency to compensate for the lack of motion-induced speckle averaging.

The light modulation controller 960 may determine a distance of an intraoral object from the intraoral scanner 950 using one or more techniques described herein such as triangulation calculations from the structured light correspondence solver 918, time-of-flight measurements, and/or focus distance analysis from the camera systems. Distance measurements may influence modulation decisions because greater working distances result in proportionally larger lateral displacements of pattern features for a given angular deflection from the diffractive optical element and/or in larger pattern feature sizes. For instance, at a working distance of 1 mm, a small angular change may produce minimal pattern feature movement, requiring higher modulation frequencies to achieve effective speckle averaging. At a working distance of 20 mm, the same angular change produces larger pattern feature displacements, potentially requiring lower modulation frequencies to prevent excessive smearing that could degrade pattern feature detection accuracy.

The light modulation controller 960 may estimate speckle contrast by analyzing the intensity variations within individual pattern features captured in the images. Speckle contrast may be calculated as the ratio of the standard deviation to the mean intensity within each pattern feature region. When speckle contrast exceeds a predetermined threshold (e.g., 0.3), the light modulation controller 960 may increase wavelength modulation frequency or amplitude to generate more independent speckle patterns and reduce the contrast. The light modulation controller 960 may also estimate spot smearing magnitude by analyzing the spatial extent and intensity distribution of pattern features compared to their expected theoretical profiles. Excessive smearing, indicated by pattern features that are significantly larger or more diffuse than expected, may prompt the light modulation controller 960 to reduce modulation frequency or amplitude.

In closed loop control implementations, the light modulation controller 960 may employ adaptive feedback mechanisms that make incremental adjustments to modulation parameters and evaluate the resulting changes in image quality metrics. For example, the light modulation controller 960 may slightly increase the wavelength modulation frequency and then analyze subsequent image frames to determine whether speckle contrast has decreased without causing excessive pattern feature smearing. If the adjustment produces favorable results, the light modulation controller 960 may continue in that direction or maintain the new settings. If the adjustment degrades image quality, the light modulation controller 960 may reverse the change and explore adjustments in the opposite direction. This iterative optimization process allows the system to continuously adapt to changing scanning conditions and maintain optimal balance between speckle reduction and pattern feature clarity.

The light modulation controller 960 may determine dental object classification by processing captured images using trained machine learning models that can distinguish between different tissue types such as teeth, gingiva, restorative materials, and preparation margins. Different dental objects may exhibit varying speckle characteristics and may benefit from different modulation strategies. For example, when scanning tooth enamel, which typically produces strong speckle patterns due to its crystalline structure, the light modulation controller 960 may employ aggressive wavelength modulation to reduce speckle contrast. When scanning gingival tissue, which may produce weaker speckle patterns, the controller may reduce or eliminate wavelength modulation to maximize optical power efficiency. When scanning metallic restorative objects that produce highly reflective surfaces with complex speckle patterns, the light modulation controller 960 may employ specialized modulation schemes optimized for high-contrast reflective surfaces.

In some embodiments, the system fundamentally operates by balancing the trade-off between two primary sources of measurement inaccuracy: pattern feature smearing and speckle contrast. Pattern feature smearing, caused by scanner movement and/or wavelength modulation and resulting lateral movement of projected spots, can reduce the precision with which pattern feature centers can be located in captured images. However, speckle contrast, caused by coherent light interference effects, creates random intensity variations within pattern features that can also degrade center location accuracy. In embodiments, the light modulation controller 960 continuously evaluates both error sources and adjusts modulation parameters to minimize the combined error. For example, in scenarios where natural scanner motion already provides some speckle averaging, the light modulation controller 960 may reduce or turn off wavelength modulation to minimize additional smearing. In stationary scanning scenarios where speckle contrast is the dominant error source, the light modulation controller 960 may increase or turn on wavelength modulation despite the associated smearing penalty. In embodiments, the optimal operating point represents the modulation level that minimizes the root-mean-square combination of smearing-induced errors and speckle-induced errors, which may vary dynamically based on scanning conditions, target surface properties, and measurement accuracy requirements.

In embodiments, light modulation controller 960 may be configured to adjust the wavelength of the structured light pattern over the exposure time of the camera. The camera exposure time represents the duration during which the camera sensor collects light to form a single image frame, typically ranging from microseconds to milliseconds depending on the scanning conditions and desired image quality. During this exposure time, the light modulation controller 960 may modulate the laser diode current to cause the junction temperature to fluctuate, which in turn causes the wavelength of the emitted coherent light to vary continuously or in discrete steps.

The timing coordination between camera exposure and wavelength changes may be precisely controlled to ensure that multiple wavelengths are captured within each image frame. For example, if the camera exposure time is 2 milliseconds, the controller may modulate the laser diode current at frequencies of 10 kHz or higher, causing the wavelength to alternate between two or more values hundreds of times during the single exposure. This rapid wavelength variation during the exposure time ensures that each captured image contains the averaged effect of multiple speckle patterns, effectively reducing the overall speckle contrast without requiring multiple separate image captures.

The light modulation controller 960 may also implement timing schemes where the wavelength modulation frequency and amplitude are dynamically adjusted based on the camera exposure settings. For longer exposure times, lower modulation frequencies may be sufficient to achieve adequate speckle averaging, while shorter exposure times may require higher modulation frequencies to ensure that sufficient wavelength variation occurs within the exposure window. The controller may also coordinate with the camera's electronic shutter timing to ensure that wavelength transitions occur smoothly during the exposure period, avoiding abrupt changes that could introduce artifacts in the captured images.

In embodiments, one or more AI models (e.g., machine learning models) are used by the intraoral scan application 910 (e.g., by structured light correspondence solver 918 and/or model generation module 925) to perform one or more operations, as described above. The AI models may be trained to perform, for example, detection and/or classification of pattern features, estimation of a 3D surface, dental object classification, and so on. One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

For model training, a training dataset containing hundreds, thousands, tens of thousands, hundreds of thousands or more intraoral scans, images and/or 3D models should be used to form a training dataset. In embodiments, up to millions of cases of patient dentition that may have underwent a prosthodontic procedure and/or an orthodontic procedure may be available for forming a training dataset, where each case may include various labels of one or more types of useful information. Each case may include, for example, data showing a 3D model, intraoral scans, height maps, color images, NIRI images, etc. of one or more dental sites, data showing pixel-level segmentation of the data (e.g., 3D model, intraoral scans, height maps, color images, NIRI images, etc.) into various dental classes (e.g., tooth, restorative object, gingiva, moving tissue, upper palate, virtual image, reflective object, healing abutment, etc.), data showing one or more assigned classifications for the data, and so on. This data may be processed to generate one or multiple training datasets for training of one or more machine learning models.

In one embodiment, generating one or more training datasets includes gathering one or more intraoral scans with labels. The labels may identify locations of virtual images of a light projector, a 3D shape of a reflective object, and so on. Processing logic may gather a training dataset comprising 2D or 3D images, intraoral scans, 3D surfaces, 3D models, height maps, etc. of dental sites (e.g., of teeth) having one or more associated labels (e.g., pixel-level labeled classes in the form of maps (e.g., probability maps) in embodiments. One or more images, scans, surfaces, and/or models and optionally associated probability maps in the training dataset may be resized in embodiments. For example, a machine learning model may be usable for images having certain pixel size ranges, and one or more image may be resized if they fall outside of those pixel size ranges. The images may be resized, for example, using methods such as nearest-neighbor interpolation or box sampling. The training dataset may additionally or alternatively be augmented. Training of large-scale neural networks generally uses tens of thousands of images, which are not easy to acquire in many real-world applications. Data augmentation can be used to artificially increase the effective sample size. Common techniques include random rotation, shifts, shear, flips and so on to existing images to increase the sample size.

To effectuate training, processing logic inputs the training dataset(s) into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the images and/scans into the machine learning model one at a time. Each input may include data from an image or intraoral scan in a training data item from the training dataset. The machine learning model processes the input to generate an output. An artificial neural network includes an input layer that consists of values in a data point (e.g., intensity values and/or height values of pixels in a height map). The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce. For pixel level segmentation, for each pixel in the image/scan/surface, the final layer applies a probability that the pixel of the image/scan/surface belongs to a first class, a probability that the pixel belongs to a second class, a probability that the pixel belongs to a third class, and/or one or more additional probabilities that the pixel belongs to other classes.

Accordingly, the output may include one or more prediction and/or one or more a probability map. For example, an output probability map may comprise, for each pixel in an input image/scan/surface, a first probability that the pixel represents a pattern feature and a second probability that the pixel does not represent a pattern feature, and so on.

Processing logic may then compare the generated probability map and/or other output to a known probability map and/or label that was included in the training data item. Processing logic determines an error (i.e., a classification error) based on the differences between the output probability map and/or label(s) and the provided probability map and/or label(s). Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

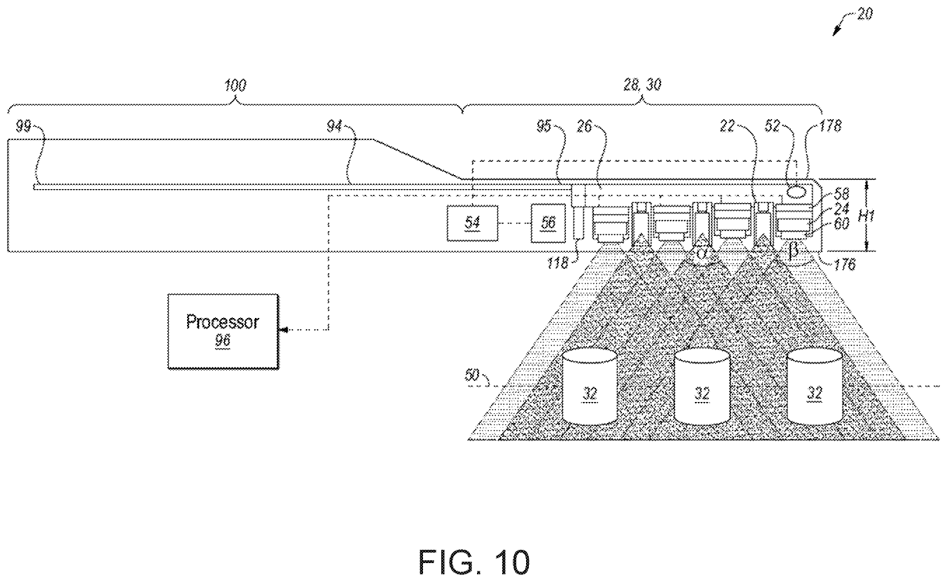

Reference is now made to FIG. 10, which is a schematic illustration of an elongate wand 20 for intraoral scanning, in accordance with some applications of the present disclosure. In embodiments, wand 20 is an intraoral scanner that includes a plurality of light projectors 22 (e.g., including structured light projectors that project visible light, structured light projectors that project infrared light, and/or non-structured light projectors) that incorporate one or more speckle pattern generating elements and/or one or more elements that improve a uniformity of a structured light pattern, as discussed above. Wand 20 may additionally include a plurality of cameras 24 that are coupled, along with the light projectors 22, to a rigid structure 26 disposed within a probe 28 at a distal end 30 of the wand. In some applications, during an intraoral scan, probe 28 enters the oral cavity of a subject.

In some particular applications of the present disclosure, an apparatus is provided for intraoral scanning (i.e., an intraoral scanner), the apparatus including an elongate wand with a probe at the distal end. During a scan, the probe may be configured to enter the intraoral cavity of a subject. Multiple light projectors (e.g., miniature structured light projectors and/or non-structured light projectors) as well multiple cameras (e.g., miniature cameras) may be coupled to a rigid structure disposed within a distal end of the probe. Each of the light projectors transmits light using alight source, such as a laser diode, light emitting diode (LED), etc. In embodiments, one or more of the light projectors corresponds to one of structured light projectors 300, 301, 420, 700 described earlier. Each of the structured light projectors may be configured to project a pattern of light defined by a plurality of projector rays when the light source is activated. Each camera may be configured to capture a plurality of images that depict at least a portion of a dental object illuminated by the non-structured light and/or the structured light (e.g., a projected pattern of light as projected by the multiple structured light projectors). For structured light projectors, each of the structured light projectors may further include a feature pattern generating optical element and optionally a speckle pattern generating optical element. The feature pattern generating optical element may utilize diffraction and/or refraction to generate a light pattern (e.g., where coherent light is used). Alternatively, the feature pattern generating optical element may be a mask that blocks a portion of the light and passes a remainder of the light. The mask can be a static mask or a changing mask such as a digital micro-mirror (DMD), a display, etc. In some applications, the light pattern may be a distribution of discrete unconnected spots of light. In some applications, the light pattern may be a checkerboard pattern. Other light patterns such as grids, lines, regular distributions of polygons, etc. may additionally or alternatively be used. Optionally, the light pattern maintains the distribution of discrete unconnected spots or other pattern features at all planes located up to a threshold distance (e.g., 30 mm, 40 mm, 60 mm, etc.) from the feature pattern generating optical element, when the light source (e.g., laser diode) is activated to transmit light through the feature pattern generating optical element. Each of the cameras includes a camera sensor and objective optics including one or more lenses.

A light pattern includes a plurality of pattern features. Typically, a dense light pattern will have dense pattern features and a sparse light pattern will have sparse pattern features. However, in some embodiments a sparse pattern may have dense pattern features. The pattern features of a light pattern may include, for example, the corners of a checkerboard (e.g., for a checkerboard light pattern). In another example, pattern features may be discrete spots of light. When projecting a pattern comprising pattern features onto a surface of a 3D object, acquired images of the object will comprise a plurality of captured image features corresponding to the pattern features. A pattern feature and an image feature may be an individual well-defined location in the image feature or pattern feature. Examples of image features and pattern features include corners, edges, vertices, points, transitions, dots, stripes, and so on.

For some applications, light projectors 22 are positioned within probe 28 such that one or more light projector 22 faces a 3D surface 32A and/or a 3D surface 32B outside of wand 20 that is placed in its field of illumination, as opposed to positioning the light projectors in a proximal end of the wand and illuminating the 3D surface by reflection of light off a mirror and subsequently onto the 3D surface. Similarly, for some applications, cameras 24 are positioned within probe 28 such that each camera 24 faces a 3D surface 32A, 32B outside of wand 20 that is placed in its field of view, as opposed to positioning the cameras in a proximal end of the wand and viewing the 3D surface by reflection of light off a mirror and into the camera. This positioning of the projectors and the cameras within probe 28 enables the scanner to have an overall large field of view while maintaining a low profile probe. In embodiments, light projectors 22 may correspond to the structured light projectors of any of FIGS. 2-8.

In some applications, a height H1 of probe 28 is less than 15 mm, height H1 of probe 28 being measured from a lower surface 176 (sensing surface), through which reflected light from 3D surface 32A, 32B being scanned enters probe 28, to an upper surface 178 opposite lower surface 176. In some applications, the height H1 is between 10-15 mm.

In embodiments, the light projectors and cameras disposed at a distal end of an intraoral scanner are non-telecentric. A camera may have a predefined field of view (FOV) and/or a predefined angular field of view (AFOV). Similarly, a light projector may have a predefined field of illumination (FOI) and/or a predefined angular field of illumination (AFOI). The field of view (FOV) of a camera in the intraoral scanner may be understood as the extent of the observable world that is seen at any given moment by the camera. The FOV may be reported as an area measure, e.g. an area at a given distance from the camera or at a given distance below the probe of the intraoral scanner. The angular field of view (AFOV) is correlated to the FOV, and the AFOI is correlated to the FOI. However, herein the AFOV and AFOI are expressed as angles and the FOV and FOI are expressed as an area. In embodiments, the light projectors have an AFOI that cause the FOI of the light projectors to become larger with increased distance from the intraoral scanner. Additionally or alternatively, the cameras have an AFOV that cause the FOV of the cameras to become larger with increased distance/depth from the intraoral scanner. The AFOI of the light projectors may cause light patterns projected by the respective light projectors to have different amounts of interference and/or overlap at different depths. Depth as used in this context may refer to a distance between intraoral scanner (e.g., the light projector and/or camera of the intraoral scanner) and an imaged surface along an imaging axis that is orthogonal to a longitudinal axis of the intraoral scanner (e.g., to a longitudinal axis of a probe of the intraoral scanner that contains the cameras and light projectors).

Each camera may be configured to capture a plurality of images that depict at least a portion of the projected pattern(s) of light as projected by the multiple light projectors on an intraoral object. In some applications, the light projectors may have an AFOI of at least 45 degrees. Optionally, the AFOI may be less than 120 degrees. For structured light projectors, each of the structured light projectors (e.g., visible and/or infrared structured light projectors) may further include a feature pattern generating optical element. The feature pattern generating optical element may utilize diffraction and/or refraction to generate a light pattern (e.g., where coherent light is used). Alternatively, the feature pattern generating optical element may be a mask that blocks a portion of the light and passes a remainder of the light. The mask can be a static mask or a changing mask such as a digital micro-mirror (DMD), a display, etc. In some applications, one or more of the light pattern(s) may be a distribution of discrete unconnected spots of light. In some applications, at least one light pattern may be a checkerboard pattern. Other light patterns such as grids, lines, regular distributions of polygons, etc. may additionally or alternatively be used. Optionally, the light pattern maintains the distribution of discrete unconnected spots or other pattern features at all planes located up to a threshold distance (e.g., 30 mm, 40 mm, 60 mm, etc.) from the pattern generating optical element, when the light source (e.g., laser diode) is activated to transmit light through the pattern generating optical element. Each of the cameras includes a camera sensor and objective optics including one or more lenses.

In some applications, the AFOV of each of the cameras may be at least 45 degrees, e.g., at least 80 degrees, e.g., 85 degrees. Optionally, the AFOV of each of the cameras may be less than 120 degrees, e.g., less than 90 degrees. The fields of view of the various cameras may together form a field of view of the intraoral scanner. In any case, the fields of view and/or angular fields of view of the various cameras may be identical or non-identical. Similarly, the focal length of the various cameras may be identical or non-identical. Further, each camera may be configured to focus at an object focal plane that is located up to a threshold distance from the respective camera sensor (e.g., up to a distance of 10 mm, 20 mm, 30 mm, 40 mm, 50 mm, 60 mm, 70 mm, 80 mm, etc. from the respective camera sensor). As distances increase, the accuracy of the position of the detected surfaces decreases. In one embodiment, beyond the threshold distance the accuracy is below an accuracy threshold. Similarly, in some applications, the AFOI of each of the light projectors (e.g., structured light projectors and/or non-structured light projectors) may be at least 45 degrees and optionally less than 120 degrees. A large field of view (FOV) of the intraoral scanner achieved by combining the respective fields of view of all the cameras may improve accuracy (as compared to traditional scanners that typically have a FOV of 10-20 mm in the x-axis and y-axis and a depth of capture of about 0-15 or 025 mm) due to reduced amount of image stitching errors, especially in edentulous regions, where the gum surface is smooth and there may be fewer clear high resolution 3D features. Having a larger FOV for the intraoral scanner enables large smooth features, such as the overall curve of the tooth, to appear in each image frame, which improves the accuracy of stitching respective surfaces obtained from multiple such image frames.

In some applications, the total combined FOV of the various cameras (e.g., of the intraoral scanner) is between about 20 mm and about 50 mm along the longitudinal axis of the elongate wand, and about 20-60 mm (or 20-40 mm) in the z-axis, where the z-axis may correspond to depth. In further applications, the field of view may be about 20 mm, about 25 mm, about 30 mm, about 35 mm, or about 40 mm along the longitudinal axis and/or at least 20 mm, at least 25 mm, at least 30 mm, at least 35 mm, at least 40 mm, at least 45 mm, at least 50 mm, at least 55 mm, at least 60 mm, at least 65 mm, at least 70 mm, at least 75 mm, or at least 80 mm in the z-axis. In some embodiments, the combined field of view may change with depth (e.g., with scanning distance). For example, at a scanning distance of about 4 mm the field of view may be about 20 mm along the longitudinal axis, and at a scanning distance of about 20-50 mm the field of view may be about 30 mm or less along the longitudinal axis. If most of the motion of the intraoral scanner is done relative to the long axis (e.g., longitudinal axis) of the scanner, then overlap between scans can be substantial. In some applications, the field of view of the combined cameras is not continuous. For example, the intraoral scanner may have a first field of view separated from a second field of view by a fixed separation. The fixed separation may be, for example, along the longitudinal axis of the elongate wand.

In some embodiments, the large FOV of the intraoral scanner increases an accuracy of the detected depth of 3D surfaces. For example, the accuracy of a depth measurement of a detected 3D surface may be based on the longitudinal distance between two cameras or between a light projector and a camera, which may represent a triangulation baseline distance. In embodiments, cameras and/or light projectors may be spaced apart in a configuration that provides for increased accuracy of depth measurements for 3D surfaces that, for example, have a depth of up to 30 mm, up to 40 mm, 15-25 mm, and so on.

In some applications, cameras 24 each have a large AFOV p (beta) of at least 45 degrees, e.g., at least 70 degrees, e.g., at least 80 degrees, e.g., 85 degrees. In some applications, the field of view may be less than 120 degrees, e.g., less than 100 degrees, e.g., less than 90 degrees. In experiments performed by the inventors, AFOV p (beta) for each camera being between 80 and 90 degrees was found to be particularly useful because it provided a good balance among pixel size, field of view and camera overlap, optical quality, and cost. Cameras 24 may include a camera sensor 58 and objective optics 60 including one or more lenses. To enable close focus imaging cameras 24 may focus at an object focal plane 50 that is located between 1 mm and 30 mm, e.g., between 4 mm and 24 mm, e.g., between 5 mm and 11 mm, e.g., 9 mm-10 mm, from the lens that is farthest from the camera sensor. Cameras 24 may also detect 3D surfaces located at greater distances from the camera sensor, such as 3D surfaces at 40 mm, 50 mm, 60 mm, 70 mm, 80 mm, 90 mm, and so on from the camera sensor.

As described hereinabove, a large field of view achieved by combining the respective fields of view of all the cameras may improve accuracy due to reduced amount of image stitching errors, especially in edentulous regions, where the gum surface is smooth and there may be fewer clear high resolution 3-D features. Having a larger field of view enables large smooth features, such as the overall curve of the tooth, to appear in each image frame, which improves the accuracy of stitching respective surfaces obtained from multiple such image frames.

Similarly, light projectors 22 may each have a large AFOI a (alpha) of at least 45 degrees, e.g., at least 70 degrees. In some applications, AFOI a (alpha) may be less than 120 degrees, e.g., than 100 degrees.

For some applications, in order to improve image capture, each camera 24 has a plurality of discrete preset focus positions, in each focus position the camera focusing at a respective object focal plane 50. Each of cameras 24 may include an autofocus actuator that selects a focus position from the discrete preset focus positions in order to improve a given image capture. Additionally or alternatively, each camera 24 includes an optical aperture phase mask that extends a depth of focus of the camera, such that images formed by each camera are maintained focused over all 3D surface distances located between 1 mm and 30 mm, e.g., between 4 mm and 24 mm, e.g., between 5 mm and 11 mm, e.g., 9 mm-10 mm, from the lens that is farthest from the camera sensor. In further embodiments, images formed by one or more cameras may additionally be maintained focused over greater 3D surface distances, such as distances up to 40 mm, up to 50 mm, up to 60 mm, up to 70 mm, up to 80 mm, or up to 90 mm.

In some applications, light projectors 22 and cameras 24 are coupled to rigid structure 26 in a closely packed and/or alternating fashion, such that (a) a substantial part of each camera's field of view overlaps the field of view of neighboring cameras, and (b) a substantial part of each camera's field of view overlaps the field of illumination of neighboring projectors. Optionally, at least 20%, e.g., at least 50%, e.g., at least 75% of the projected pattern of light are in the field of view of at least one of the cameras at an object focal plane 50 that is located at least 4 mm from the lens that is farthest from the camera sensor. Due to different possible configurations of the projectors and cameras, some of the projected pattern may never be seen in the field of view of any of the cameras, and some of the projected pattern may be blocked from view by 3D surface 32A, 32B as the scanner is moved around during a scan.

Rigid structure 26 may be a non-flexible structure to which light projectors 22 and cameras 24 are coupled so as to provide structural stability to the optics within probe 28. Coupling all the projectors and all the cameras to a common rigid structure helps maintain geometric integrity of the optics of each light projector 22 and each camera 24 under varying ambient conditions, e.g., under mechanical stress as may be induced by the subject's mouth. Additionally, rigid structure 26 helps maintain stable structural integrity and positioning of light projectors 22 and cameras 24 with respect to each other. As further described hereinbelow, controlling the temperature of rigid structure 26 may help enable maintaining geometrical integrity of the optics through a large range of ambient temperatures as probe 28 enters and exits a subject's oral cavity or as the subject breathes during a scan.

As shown, 3D surface 32A and 3D surface 32B are in a FOV of the probe 28, with 3D surface 32A being relatively close to the probe 28 and 3D surface 32B being relatively far from the probe 28.

Whether a pair of cameras or a pair of a camera and alight projector are used, the accuracy of the triangulation used to determine the depth of 3D surfaces may be roughly estimated by the following equation:

$${z}_{err} = \frac{{p}_{err} \cdot {z}^{2}}{f \cdot b}$$

Where zₑᵣᵣ is the error in the depth, pₑᵣᵣ is the basic image processing error (generally a sub-pixel error), z is the depth, f is the focal length of the lens, and b is the base line (the distance between two cameras when using stereo imaging or the distance between the camera and the light projector when using structured light). In embodiments, the probe of the intraoral scanner is configured such that the maximum baseline between two cameras or between a camera and a light projector is large and provides a high level of accuracy for triangulation.

In some embodiments, wand 20 corresponds to the intraoral scanner of U.S. Pat. No. 11,896,461, issued Feb. 13, 2024, which is incorporated by reference herein. In some embodiments, wand 20 corresponds to the intraoral scanner of U.S. Pat. No. 11,563,929, issued Jan. 24, 2023, which is incorporated by reference herein.

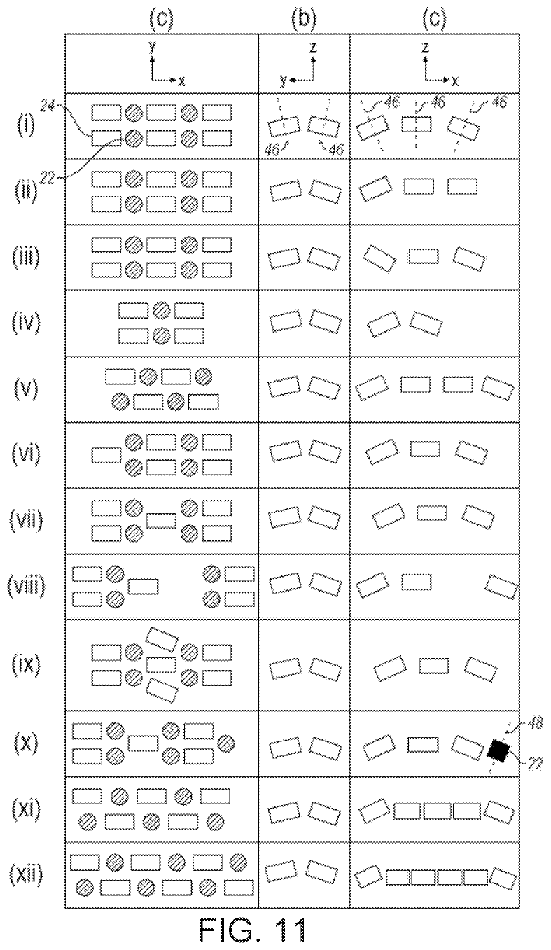

Reference is now made to FIG. 11, which is a chart depicting a plurality of different configurations for the position of light projectors 22 and cameras 24 in probe 28, in accordance with some applications of the present disclosure. Light projectors 22 are represented in FIG. 11 by circles and cameras 24 are represented in FIG. 11 by rectangles. Light projectors may be infrared light projectors, visible light projectors, or a combination thereof. It is noted that rectangles are used to represent the cameras, since typically, each camera sensor 58 and the AFOV p (beta) of each camera 24 have aspect ratios of 1:2. Column (a) of FIG. 11 shows a bird's eye view of the various configurations of light projectors 22 and cameras 24. The x-axis as labeled in the first row of column (a) corresponds to a central longitudinal axis of probe 28. Column (b) shows a side view of cameras 24 from the various configurations as viewed from a line of sight that is coaxial with the central longitudinal axis of probe 28. Column (b) of FIG. 11 shows cameras 24 positioned so as to have optical axes 46 at an angle of 90 degrees or less, e.g., 35 degrees or less, with respect to each other. Column (c) shows a side view of cameras 24 of the various configurations as viewed from a line of sight that is perpendicular to the central longitudinal axis of probe 28.

In one embodiment, the distal-most (toward the positive x-direction in FIG. 11) and proximal-most (toward the negative x-direction in FIG. 11) cameras 24 are positioned such that their optical axes 46 are slightly turned inwards, e.g., at an angle of 90 degrees or less, e.g., 35 degrees or less, with respect to the next closest camera 24. The camera(s) 24 that are more centrally positioned, i.e., not the distal-most camera 24 nor proximal-most camera 24, are positioned so as to face directly out of the probe, their optical axes 46 being substantially perpendicular to the central longitudinal axis of probe 28. It is noted that in row (xi) a projector 22 is positioned in the distal-most position of probe 28, and as such the optical axis 48 of that projector 22 points inwards, allowing a larger number of spots 33 projected from that particular projector 22 to be seen by more cameras 24.

In one embodiment, the number of light projectors 22 in probe 28 may range from two, e.g., as shown in row (iv) of FIG. 11, to six, e.g., as shown in row (xii). In one embodiment, the number of cameras 24 in probe 28 may range from four, e.g., as shown in rows (iv) and (v), to seven, e.g., as shown in row (ix) or eight. It is noted that the various configurations shown in FIG. 11 are by way of example and not limitation, and that the scope of the present disclosure includes additional configurations not shown. For example, the scope of the present disclosure includes more than five projectors 22 positioned in probe 28 and more than seven cameras positioned in probe 28.

In an example application, an apparatus for intraoral scanning (e.g., an intraoral scanner) includes an elongate wand comprising a probe at a distal end of the elongate wand, at least two light projectors disposed within the probe, and at least four cameras disposed within the probe. Each light projector may include at least one light source configured to generate light when activated, and a pattern generating optical element that is configured to generate a pattern of light when the light is transmitted through the pattern generating optical element. Each of the at least four cameras may include a camera sensor and one or more lenses, wherein each of the at least four cameras is configured to capture a plurality of images that depict at least a portion of the projected pattern of light on an intraoral surface. In one embodiment, a majority of the at least two light projectors and the at least four cameras may be arranged in at least two rows that are each approximately parallel to a longitudinal axis of the probe, the at least two rows comprising at least a first row and a second row.

In a further application, a distal-most camera along the longitudinal axis and a proximal-most camera along the longitudinal axis of the at least four cameras are positioned such that their optical axes are at an angle of 90 degrees or less with respect to each other from a line of sight that is perpendicular to the longitudinal axis. Cameras in the first row and cameras in the second row may be positioned such that optical axes of the cameras in the first row are at an angle of 90 degrees or less with respect to optical axes of the cameras in the second row from a line of sight that is coaxial with the longitudinal axis of the probe. A remainder of the at least four cameras other than the distal-most camera and the proximal-most camera have optical axes that are substantially parallel to the longitudinal axis of the probe. Each of the at least two rows may include an alternating sequence of light projectors and cameras.

In a further application, the at least four cameras comprise at least five cameras, the at least two light projectors comprise at least five light projectors, a proximal-most component in the first row is a light projector, and a proximal-most component in the second row is a camera.

In a further application, the distal-most camera along the longitudinal axis and the proximal-most camera along the longitudinal axis are positioned such that their optical axes are at an angle of 35 degrees or less with respect to each other from the line of sight that is perpendicular to the longitudinal axis. The cameras in the first row and the cameras in the second row may be positioned such that the optical axes of the cameras in the first row are at an angle of 35 degrees or less with respect to the optical axes of the cameras in the second row from the line of sight that is coaxial with the longitudinal axis of the probe.

In a further application, the at least four cameras may have a combined field of view of about 25-45 mm or about 20-50 mm along the longitudinal axis and a field of view of about 20-40 mm or about 15-80 mm along a z-axis corresponding to distance from the probe. Other FOVs discussed herein may also be provided.

In the examples FIGS. 10-11, cameras and structured light projectors directly face an object that is scanned. However, in other embodiments one or more structured light projectors and/or cameras may face a mirror, which may redirect light rays and returning light rays towards and/or from an object being scanned. In some embodiments, structured light projectors and cameras are arranged into one or more scan units, which may be arranged along the longitudinal axis of the probe. A scan unit may be understood herein as a unit comprising at least light projector and one or more cameras. In some embodiments, each scan unit comprises at least two cameras having at least partly overlapping fields of view along different camera optical axes. In one embodiment, each scan unit comprises at least four cameras having at least partly overlapping fields of view along different camera optical axes. An advantage of having overlapping fields of view of the cameras is an improved accuracy due to a reduced amount of image stitching errors. A further advantage of utilizing multiple cameras, such as two or more cameras, is that the reliability of the determination of 3D points is improved, whereby the accuracy of the generated digital 3D representation is improved. A scan unit may further comprise one or more lenses such as collimation lenses or projection lenses.

In some embodiments, one or more scan units may face an object being scanned and/or one or more scan units may face a mirror. Scan units that face an object being scanned may be referred to as downward looking scan units, and may have an imaging axis that is at an angle (e.g., perpendicular) to a longitudinal axis of a probe. Scan units that face a mirror may be referred to as forward looking scan units, and may have an imaging axis that is approximately parallel to a longitudinal axis of a probe. In some embodiments, all scan units are downward looking. In some embodiments, all scan units are forward looking. In some embodiments, some scan units are downward looking and some scan units are forward looking. In some embodiments, scan units are used as set forth in U.S. Patent Application No. 63/656,524, filed Jun. 5, 2024, which is incorporated by reference herein in its entirety.

In some embodiments, the intraoral scanner comprises a plurality of scan units positioned along the longitudinal axis of the intraoral scanner. For example, two scan units may be positioned in series along the longitudinal axis of the intraoral scanner. A scan unit may have a predefined field of view (FOV) and/or a predefined angular field of view (AFOV). In some embodiments, the FOV of each scan unit is at least 300 mm², preferably at least 400 mm², preferably at least 500 mm², preferably at least 550 mm², wherein the area is measured for a given predefined focus distance or working distance. As an example, the field of view of the intraoral scanner may be at least 20×20 mm², such as at least 23×23 mm², at a working distance of between 18 mm to 36 mm, such as approximately 20 mm to 24 mm. For some applications, e.g. for dental scanning applications, the intraoral scanner has a working distance of between 10 mm and 100 mm. In some embodiments, a working distance of the projector unit of between 10 mm and 70 mm, such as between 15 mm and 50 mm, is used. Since the scan unit(s) then take up less space inside the intraoral scanner, it also allows for multiple scan units to be placed in succession inside the intraoral scanner. In some embodiments, the intraoral scanner is able to project a pattern in focus at the exit of the tip of the intraoral scanner, e.g. at the optical window of the s intraoral scanner or at an opening in the surface of the intraoral scanner. The working distance may be understood as the object to lens distance where the image is at its sharpest focus. The working distance may also, or alternatively, be understood as the distance from the object to a front lens, e.g. a front lens of the projector unit. The front lens may be the one or more focus lenses of the projector unit.

In some embodiments the elongated probe comprises one or more openings and/or one or more optical windows at a distal end of the elongated probe. In some embodiments, there is an opening and/or an optical window in the elongated probe, wherein the opening/window is associated with each scan unit, such that each scan unit is configured to project the light pattern through said opening or optical window. Accordingly, the elongated probe may comprise an opening and/or an optical window for each scan unit of the intraoral scanner. The optical window may be made in a polymer material such as poly(methyl methacrylate) (PM MA) or in a ceramic or glass material such as Sapphire glass. The optical window may be made in a transparent, crystalline, ceramic material, such as aluminum oxide (Al₂O₃). Alternatively, the optical window may be made of a mineral glass. In some embodiments, the predefined distance mentioned in relation to the FOV of a given scan unit is measured below said opening/window. In some embodiments, the FOV of at least one scan unit is at least 500 mm², such as approximately 23×23 mm², in a distance approximately 0-15 mm, such as 4-7 mm below said opening/window. This may correspond to a working distance of between 15 mm and 50 mm, such as between 15 mm and 36 mm.

The angular field of view (AFOV) of a scan unit may be correlated to the FOV. In accordance with some embodiments, each scan unit defines an angular field of view (AFOV) of between 50° to 80°, such as between 60° to 75°. In accordance with some embodiments, the projector optical axis and the camera optical axis of at least one camera define a camera-projector angle of approximately 5 to 25 degrees, or 5 to 15 degrees, or 5 to 10 degrees, or 8 to 10 degrees. In some embodiments, the scan unit(s) are rotationally symmetric, such that each camera optical axis defines an approximately similar camera-projector angle with the projector unit of the scan unit.

In embodiments, wherein the intraoral scanner comprises at least two scan units, the intraoral scanner has a FOV, which is larger than the FOV of each scan unit. As an example, if the intraoral scanner comprises two scan units, each scan unit having a predefined FOV, then the intraoral scanner will have twice as large a FOV as each scan unit, provided there is no overlap in FOV between the scan units. In some cases, there may be a small overlap in FOV, but in general the intraoral scanner will have a larger field of view, or in other words an extended field of view, compared to one scan unit in isolation. Accordingly, the FOV of the intraoral scanner can be increased/scaled by the number of scan units in the intraoral scanner. In some embodiments, the intraoral scanner comprises at least three scan units. Accordingly, the intraoral scanner may further comprise a third scan unit comprising a third projector unit, said projector unit preferably configured to project the light pattern at a predefined third focus distance. A scan unit may further comprise at least one reflecting element, such as a mirror or a prism, wherein said reflecting element is configured to alter the direction of the light projected by the projector unit of the scan unit. In general, a scan unit can be oriented in many different ways, wherein the orientation is defined according to the projector optical axis of the scan unit. As an example, a scan unit may be oriented such that the projector optical axis of the scan unit is substantially parallel with the longitudinal axis of the intraoral scanner. Additionally, a scan unit may be oriented such that the light from the projector unit is projected in a forward direction, i.e. towards the distal end of the intraoral scanner. In case, a scan unit is oriented in this way, the scan unit is also referred to as being in a forward-looking configuration. In some embodiments, each scan unit comprises a reflecting element. In other embodiments, at least one scan unit comprises a reflecting element.

As another example, a scan unit may be oriented such that the projector optical axis of the scan unit is angled with respect to the longitudinal axis of the intraoral scanner or with respect to a projector optical axis of another scan unit. In some embodiments, at least one of the projector optical axes is substantially orthogonal to the longitudinal axis of the intraoral scanner. Additionally, such a scan unit may be oriented such that the light from the projector unit is projected in a downward direction, i.e. directly towards the dental object to be scanned. In case a scan unit is oriented in this way, the scan unit is also referred to as being in a downward-looking configuration. If the intraoral scanner comprises a plurality of scan units, such as at least two scan units, the scan units may be in different configurations, e.g. a first scan unit in the forward-looking configuration and a second scan unit in the downward-looking configuration. In this embodiment, the first projector optical axis is substantially parallel to the longitudinal axis of the intraoral scanner, and the second projector optical axis is substantially orthogonal to the longitudinal axis of the intraoral scanner. In other words, a first projector optical axis of a first projector unit of the first scan unit is angled with respect to a second projector optical axis of a second projector unit of the second scan unit. This angle may be at least 45°, such as at least 75°, or at least 85°, or approximately 90°.

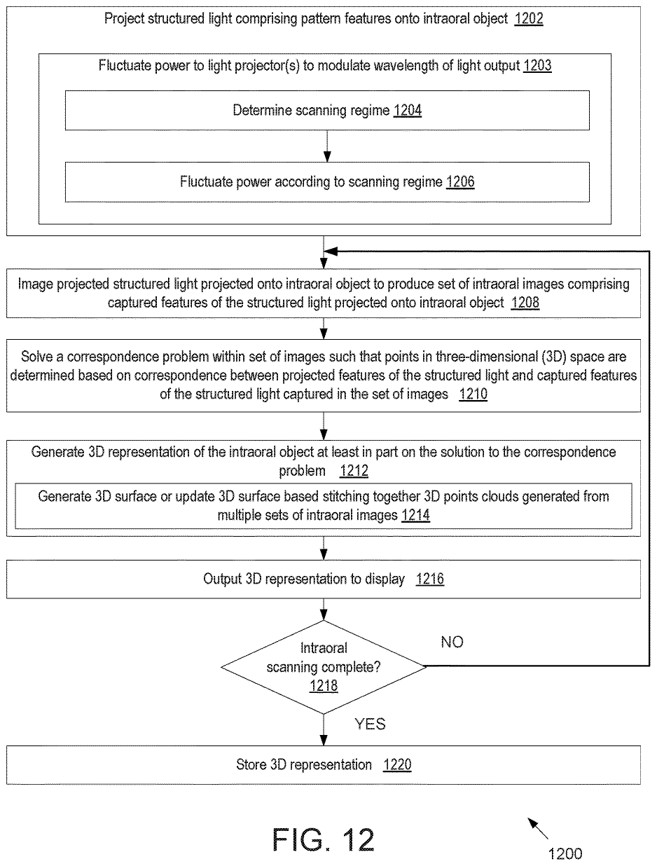

FIG. 12 is a flow chart for a method 1200 of generating a 3D representation of an intraoral object using an intraoral scanner configured to improve image quality using one or more speckle pattern generating elements and/or a stack of dielectric layers (e.g., a coating that acts as an antireflective coating for some angles and as a reflective coating for other angles, referred to simply as an antireflective coating for convenience), in accordance with embodiments of the present disclosure. At block 1202 of method 1200, processing logic causes a structured light projector of an intraoral scanner to project structured light onto an intraoral object (also referred to as a dental object or a dental site, which includes a surface in an oral cavity).

At block 1203, processing logic (e.g., a controller of the intraoral scanner, functioning as a speckle pattern generating element) causes power delivered to one or more light sources of the structured light projector to fluctuate. In embodiments, a current of the light source(s) is fluctuated, which causes the power to the light source(s) to fluctuate. In embodiments, the fluctuating power of the light sources causes the wavelength of coherent light output by the light source(s) to also fluctuate. The fluctuating wavelength may be an alternation between two or more wavelengths in embodiments. In some embodiments, the structured light projector includes a first diffractive optical element configured to adjust an angle of the coherent light to an optical axis based on wavelength, wherein the first diffractive optical element causes the coherent light at a first wavelength to have a first angle to the optical axis and causes the coherent light at a second wavelength to have a second angle to the optical axis. The alternation between wavelengths causes pattern features of the structured light pattern to alternate between first positions associated with the first angle and second positions associated with the second angle, thereby reducing speckle contrast in the pattern features through controlled lateral movement and smearing during camera exposure times.

In one embodiment, processing logic determines a scanning regime at block 1204. The scanning regime may be input by a user or may be automatically determined based on processing image data (e.g., 2D images, intraoral scans, a 3D model generated from intraoral scans, etc.) generated by cameras of the intraoral scanner in embodiments. For example, the image data may be processed using a trained AI model that has been trained to determine a scanning regime. The AI model may output a determination of a scanning regime based on the processed image data. At block 1206, processing logic may select the determined scanning regime, which may include setting one or more scanning parameters associated with the selected scanning regime. The scanning parameters may include, for example, whether to fluctuate the power of the light source(s), a rate at which to fluctuate the power to the light source(s), power settings to the light source(s), and so on. At block 1206, processing logic may fluctuate the power to the light source(s) according to the selected scanning regime.

In some embodiments, processing logic may determine various control parameters to optimize wavelength modulation. Processing logic may determine a velocity of the intraoral scanner through analysis of sequential image frames, inertial measurement unit data, or displacement calculations between successive 3D point clouds. Processing logic may also determine a distance of the intraoral object from the intraoral scanner using triangulation calculations, time-of-flight measurements, or focus distance analysis. Based on these parameters, processing logic may determine whether to modulate the coherent light between the first wavelength and the second wavelength and/or a frequency at which to modulate the coherent light. For example, when scanner velocity is high, natural motion blur may provide sufficient speckle averaging, allowing reduced wavelength modulation. When the scanner is stationary or moving slowly, increased wavelength modulation frequency may compensate for lack of motion-induced speckle averaging.

Processing logic may estimate speckle contrast by analyzing intensity variations within individual pattern features and may estimate spot smearing magnitude by analyzing spatial extent and intensity distribution of pattern features compared to expected theoretical profiles. In closed loop control implementations, processing logic may make incremental adjustments to modulation parameters and evaluate resulting changes in image quality metrics, iteratively optimizing the balance between speckle reduction and pattern feature clarity. Processing logic may also determine dental object classification using trained machine learning models to distinguish between tissue types such as teeth, gingiva, and restorative materials, with different modulation strategies applied based on the classification results.

At block 1208, processing logic causes one or more cameras of the intraoral scanner to image the intraoral object (e.g., to capture one or more images of the intraoral object) illuminated by the projected structured light. In some embodiments, one or more cameras of the intraoral scanner capture multiple frames of images at block 1208, each at a different time. For example, a camera may have a frame rate (e.g., of 120-120 frames per second), and may capture a set number of frames in a given time period according to the frame rate. In some embodiments, multiple cameras capture images simultaneously or in parallel. Each of the cameras may capture images at a same frame rate in some embodiments. Accordingly, a sequence of frames of images may be captured by each of a plurality of cameras of the intraoral scanner.

In embodiments, cameras capture intraoral scan data (also referred to as an intraoral scan) that includes a set of images generated at a same time or approximately the same time, each image having been generated by a different camera. Other intraoral scans may also be generated, each including a set of images. Each intraoral scan may include image data generated by multiple cameras of the intraoral scanner. In an example, two or more cameras of the intraoral scanner may each generate an intraoral image, and the multiple intraoral images may be combined based on the known positions and orientations of the respective two or more cameras to form an intraoral scan. In one embodiment, each intraoral scan may include captured image features that correspond to pattern features that were projected onto a region of the dental site/object by the one or more structured light projectors. Image features as used herein are features of a light pattern that are captured in an image (as opposed to pattern features, which are features of a projected light pattern as projected). Image features correspond to camera rays, while pattern features correspond to projector rays. For example, one or more structured light projectors may be driven to project a distribution of discrete unconnected spots of light or a checkerboard pattern on an intraoral surface, and the cameras may be driven to capture images of the projection. The image captured by each camera may include image features corresponding to at least one of the pattern features (e.g., projected spots, features of a checkerboard pattern, etc.). Together the images generated by the various cameras at a particular time may form an intraoral scan (e.g., first intraoral scan data). In some embodiments, non-structured light (e.g., non-coherent or white light and/or near-infrared light) is used to illuminate the dental arch/object for some frames, and structured light is used to illuminate the dental arch/object for other frames. For example, the intraoral scanner may alternate between projection of structured light and one or more types of non-structured light.

Each camera may include a camera sensor that has an array of pixels, for each of which there exists a corresponding ray in 3D space originating from the pixel whose direction is towards an object being imaged. Each point may lie along a particular one of these camera rays that, when imaged on the sensor, will fall on its corresponding respective pixel on the sensor. As used throughout this application, the term used for this is a “camera ray.” Similarly, for each projected spot or other feature from each structured light projector there exists a corresponding projector ray. Each projector ray corresponds to a respective path of pixels on at least one of the camera sensors. For example, if a camera sees a spot or other pattern feature projected by a specific projector ray, that spot or pattern feature will necessarily be detected by a pixel on the specific path of pixels that corresponds to that specific projector ray. Values for (a) the camera ray corresponding to each pixel on the camera sensor of each of the cameras, and (b) the projector ray corresponding to each of the projected pattern features from each of the projectors, may be stored as calibration data, as described herein.

A dental practitioner may perform intraoral scanning of the dental arch to generate a plurality of intraoral scans of the dental arch. This may include performing intraoral scanning of a partial or full mandibular or maxillary arch, or a partial or full scan of both arches. Performing the intraoral scanning may include alternately projecting structured light having a light pattern (e.g., a non-coded structured light pattern) onto an intraoral surface of a patient using a first light projector and projecting non-structured light lacking a light pattern onto the intraoral surface of the patient using a second light projector and/or a third light projector. Performing the intraoral scanning may further include capturing a plurality of scans or images of the projected structured light and non-structured light using one or more cameras disposed in the probe.

At block 1210, processing logic (e.g., processing logic of a computing device connected to the intraoral scanner via a wired or wireless connection) solves a correspondence algorithm to determine 3D coordinates for points in a captured set of images. Solving the correspondence algorithm may include, for each set of images, determining a correspondence between pattern features in the projected pattern of light and image features in the set of images by determining intersections of projector rays corresponding to one or more of the pattern features with camera rays corresponding to the one or more image features (e.g., of the projected pattern) in three-dimensional (3D) space based on calibration data that associates the camera rays corresponding to pixels on the camera sensor of each of the two or more cameras to the projector rays. Solving the correspondence algorithm may include first determining the correspondence between the pattern features and the image features in the 3D space for a first subset of the pattern features that are associated with a highest number of image features. Once correspondences have been found for the first subset of the pattern features that are associated with a highest number of image features, processing logic may subsequently determine the correspondence between the pattern features and the image features in the 3D space for a second subset of the pattern features that are associated with a next highest number of image features. This process may be repeated, each time for pattern features associated with a next highest number of image features.

Processing logic may determine depths associated with pattern features based on correspondence to image features in one or more images. The depths may be combined with x,y information also determined from the images to determine 3D coordinates of the pattern features, and thus 3D coordinates of points on a scanned intraoral surface. The depths may be determined using a correspondence algorithm and stored calibration values. The stored calibration values may associate camera rays corresponding to pixels on a camera sensor of each of a plurality of cameras to a plurality of projector rays.

Processing logic may run the correspondence algorithm using the stored calibration values in order to identify a three-dimensional location for each projected point or feature (referred to as a pattern feature) on a surface of a scanned 3D surface (e.g., the first intraoral 3D surface). In one embodiment, for a given projector ray, the processor “looks” at the corresponding camera sensor path on one of the cameras. Each detected image feature along that camera sensor path will have a camera ray that intersects the given projector ray (and thus the pattern feature). That intersection defines a three-dimensional point in space. The processor may search among the camera sensor paths that correspond to that given projector ray on the other cameras and may identify how many other cameras, on their respective camera sensor paths corresponding to the given projector ray, also detected an image feature whose camera ray intersects with that three-dimensional point in space. As used herein throughout the present application, if two or more cameras detect image features whose respective camera rays intersect a given projector ray at the same three-dimensional point in space, the cameras are considered to “agree” on the image feature being located at that three-dimensional point. Accordingly, the processor may identify three-dimensional locations of the projected pattern of light based on agreements of the two or more cameras on there being the projected pattern of light by projector rays at certain intersections. The process is repeated for the additional image features along a camera sensor path, and the image feature for which the highest number of cameras “agree” is identified as the image feature that is being projected onto the surface from the given projector ray (and thus that corresponds to a particular pattern feature). A three-dimensional position on the surface is thus computed for that image feature, including the depth for that image feature. Accordingly, a depth of a first intraoral 3D surface may be determined (which may include depths of multiple different points on the surface of the first intraoral 3D surface).

Once a position on the surface is determined for a specific image feature, the projector ray that projected that image feature, as well as all camera rays corresponding to that image feature, may be removed from consideration and the correspondence algorithm may be run again for a next projector ray. This may be repeated until depths are determined for many or all image features (or there are no remaining image features for which a solution can be found with a threshold level of confidence).

At block 1212, processing logic generates a 3D representation of the intraoral object based at least in part on the solution to the correspondence problem. For example, processing logic may generate a digital 3D representation of the dental object based on the determined correspondence between the pattern features and the image features in the one or more sets of images. The correspondence algorithm for solving for correspondence between pattern features (e.g., corresponding to projector rays from one or more light projectors) and image features (e.g., corresponding to camera rays from one or more cameras) is described in U.S. application Ser. No. 16/446,181, filed Jun. 19, 2019, which is incorporated by reference herein in its entirety.

In one embodiment, at block 1214 processing logic stitches together the plurality of intraoral scans (e.g., 3D point clouds generated from multiple sets of intraoral images) to generate a 3D surface or model. This may include registering the first intraoral scan to one or more additional intraoral scans using overlapping data between the various intraoral scans. In one embodiment, performing scan registration includes capturing 3D data of various points of a surface in multiple intraoral scans, and registering the intraoral scans by computing transformations between the intraoral scans. The intraoral scans may then be integrated into a common reference frame by applying appropriate transformations to points of each registered intraoral scan.

In one embodiment, surface registration is performed for adjacent or overlapping intraoral scans (e.g., successive frames of an intraoral video). Surface registration algorithms are carried out to register two or more intraoral scans that have overlapping scan data, which essentially involves determination of the transformations which align one scan with the other. Surface registration may be performed using, for example, an iterative closest point (ICP) algorithm, and may involve identifying multiple points in multiple scans (e.g., point clouds), surface fitting to the points of each scan, and using local searches around points to match points of the overlapping scans. Some examples of ICP algorithms that may be used are described in Francois Pomerleau, et al., “Comparing ICP Variants on Real-World Data Sets”, 2013, which is incorporated by reference herein. Other techniques that may be used for registration include those based on determining point-to-point correspondences using other features and minimization of point-to-surface distances, for example. In one embodiment, scan registration (and stitching) is performed as described in U.S. Pat. No. 6,542,249, issued Apr. 1, 2003, entitled “Three-dimensional Measurement Method and Apparatus,” which is incorporated by reference herein. Other scan registration techniques may also be used.

Surface registration may include both stitching pairs of intraoral scans sequentially, as well as performing a global optimization that minimizes all pairs of positions together and/or or minimizes all points from all scans one to another. Accordingly, if a scan to scan registration (e.g., using ICP) searches in 6 degrees of freedom (3 translation and 3 rotation) that optimizes the distance of all points from one scan to another, then a global optimization of 11 scans will search in (11−1)×6=60 degrees of freedom for all scans relative to all other scans, while minimizing some distance between all scans. In some cases, this global optimization should give weights to different errors (e.g., edges of scans and/or far points may be given lower weight for better robustness).

Processing logic may generate a virtual 3D model of a dental object (e.g., a patient's dental arch) from the intraoral scans by integrating data from all intraoral scans into a single 3D model by applying the appropriate determined transformations to each of the scans. Each transformation may include rotations about one to three axes and translations within one to three planes, for example.

Processing logic may register 2D color images captured while projecting non-structured white light onto the dental arch/object with the 3D model. Based on this registration, color information may be added to the 3D model as a texture.

For some applications, there is at least one near-infrared light projector that projects near-infrared and/or infrared light onto an object while the object is being scanned. At least one camera captures images of the object using illumination from a near-infrared light projector. Processing logic may run a surface reconstruction algorithm that combines at least one image captured using illumination from structured light projectors with one or more images captured using illumination from a near-infrared light projector in order to generate a digital three-dimensional image of the intraoral three-dimensional surface. Using a combination of structured light and near-infrared illumination enhances the overall capture of the intraoral scanner and may help reduce the number of options that processing logic needs to consider when running the correspondence algorithm. In one embodiment, stereo vision techniques, deep learning techniques (e.g., using convolutional neural networks) and/or simultaneous localization and mapping (SLAM) techniques may be used with the scan data from the structured light and the scan data from the near-infrared light to improve an accuracy of a determined 3D surface and/or to reduce a number of options that processing logic needs to consider when running the correspondence algorithm.

At block 1216, processing logic outputs the generated 3D representation to a display.

At block 1218, processing logic determines whether intraoral scanning is complete (e.g., whether a user has pressed a button to stop generating intraoral scans, the intraoral scanner has been removed from a patient's mouth, a full 3D model of the patient's dental arch(es) has been generated, etc.). If the intraoral scanning is complete, the method may continue to block 1220, and the 3D representation of the dental object (e.g., dental arch(es)) may be stored. If at block 1218 a determination is made that intraoral scanning is not complete, the method may return to block 1208.

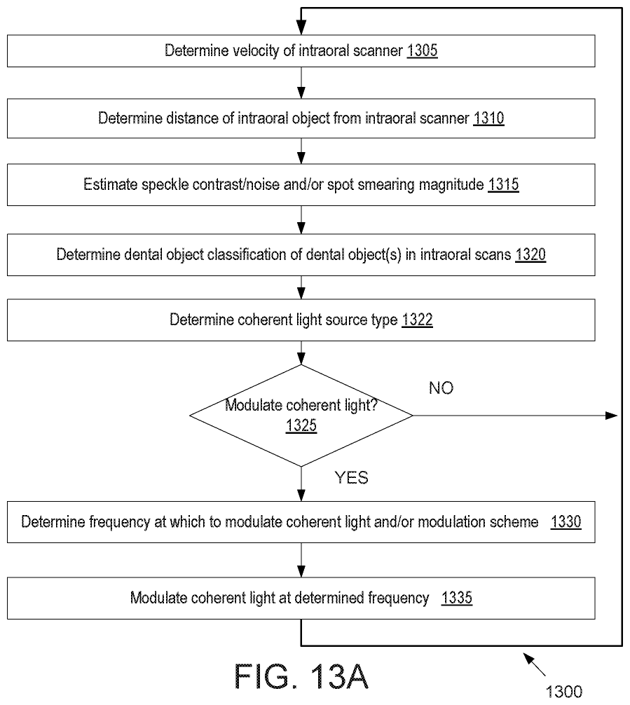

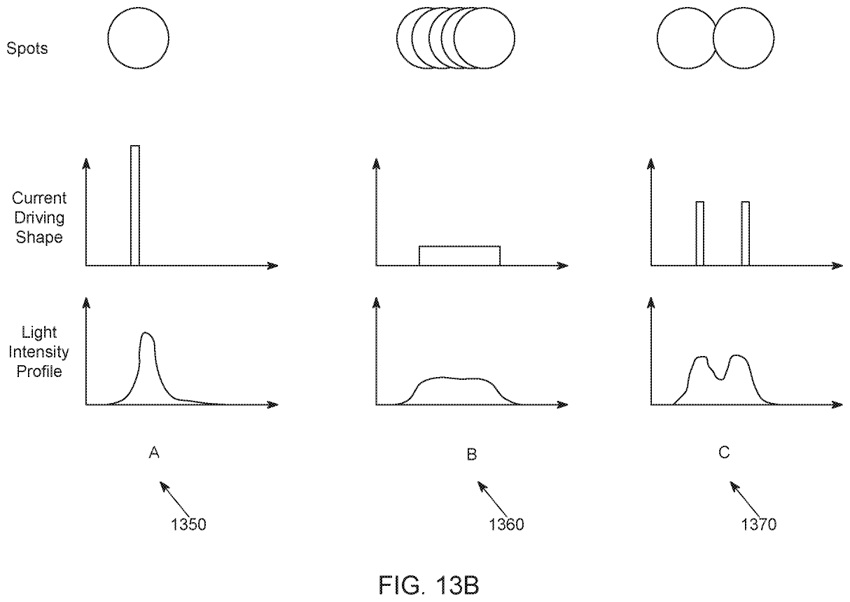

FIG. 13A is a flow chart for a method 1300 of modulating a wavelength of light produced by a structured light projector and/or controlling a pulse scheme for projecting light, in accordance with embodiments of the present disclosure. The method 1300 may be performed as part of operations at block 1202 of method 1200 in some embodiments, where processing logic causes a structured light projector of an intraoral scanner to project structured light onto an intraoral object.

The method 1300 provides detailed control mechanisms for optimizing wavelength modulation parameters and/or light projection parameters (e.g., for light pulses) to achieve optimal balance between speckle contrast reduction and pattern feature clarity preservation. The method may be implemented using either open loop control strategies or closed loop control strategies in embodiments, each offering distinct advantages depending on the specific scanning scenario and performance requirements.

In open loop control implementations, processing logic may begin by determining predetermined modulation parameters and/or pulse parameters based on typical scanning conditions, current conditions, user-selected scanning modes, and/or pre-calibrated settings optimized for specific dental procedures. For example, an orthodontic scanning mode may employ minimal wavelength modulation since the scanner typically moves rapidly across tooth surfaces, providing natural motion blur that contributes to speckle averaging. The rapid scanner movement in orthodontic applications may render additional wavelength-induced pattern feature movement unnecessary or even counterproductive, as excessive smearing could degrade the detection accuracy of pattern features needed for precise tooth positioning measurements. In contrast, a restorative scanning mode may employ aggressive wavelength modulation parameters optimized for high-precision measurements of preparation margins, where the scanner moves slowly or remains stationary for extended periods. The slower scanning speeds in restorative applications provide minimal natural motion blur, making wavelength modulation essential for achieving adequate speckle contrast reduction.

Open loop control may incorporate environmental factors and scanner specifications into the parameter selection process. For instance, the working distance capabilities of the specific scanner model may influence modulation frequency selection, as scanners designed for close-proximity scanning (e.g., 5-15 mm working distance) may require higher modulation frequencies to achieve the same lateral pattern feature displacement as scanners optimized for longer working distances (e.g., 20-40 mm). Similarly, the wavelength characteristics of the laser diodes used in the structured light projectors may determine the optimal current modulation ranges, as different laser diode models exhibit varying wavelength sensitivity to temperature changes.

Closed loop control implementations of method 1300 provide dynamic adaptation capabilities that continuously optimize modulation parameters and/or light pulse parameters based on real-time feedback from multiple sensor inputs and image analysis algorithms. The closed loop approach may begin by establishing baseline measurements of current scanning conditions, including scanner velocity, working distance to the target surface, speckle contrast levels in captured pattern features, and/or the degree of pattern feature smearing observed in recent image frames.

At block 1305 of method 1300, processing logic may determine a velocity of an intraoral scanner. Scanner velocity determination in closed loop control may utilize multiple complementary measurement techniques to ensure robust and accurate motion detection. Inertial measurement units (IMUs) integrated within the scanner housing may provide direct acceleration and angular velocity measurements, which can be integrated over time to estimate linear and rotational displacement. However, IMU-based velocity estimation may suffer from drift errors that accumulate over extended scanning sessions, necessitating periodic recalibration or fusion with alternative measurement methods. Optical flow analysis of sequential image frames may provide an independent velocity estimation method by tracking the apparent motion of surface features between consecutive captures. This approach may be particularly effective when scanning textured surfaces such as tooth enamel, where natural surface variations provide distinctive tracking features. For smooth surfaces such as gingival tissue, optical flow analysis may be less reliable due to the lack of distinctive features, requiring the system to rely more heavily on IMU data or structured light pattern tracking.

At block 1310, processing logic may determine a distance of an intraoral object from the intraoral scanner. Working distance estimation may employ triangulation calculations derived from the structured light correspondence solver, providing highly accurate distance measurements to individual points on the scanned surface. However, triangulation-based distance estimation relies upon successful pattern feature detection and correspondence matching, which may be compromised in regions with high speckle contrast or excessive pattern feature smearing. Time-of-flight measurements may provide an alternative distance estimation method that operates independently of pattern feature detection, using the round-trip travel time of light pulses to calculate distances. Focus distance analysis from the camera systems may offer a third distance estimation approach, analyzing the sharpness of captured images at different focus settings to determine the optimal focus distance, which corresponds to the working distance.

At block 1315, processing logic may estimate speckle contrast/noise and/or spot smearing magnitude. Speckle contrast estimation may include analyzing the statistical properties of intensity variations within individual pattern features captured in recent image frames. Processing logic may calculate speckle contrast as the ratio of the standard deviation to the mean intensity within each pattern feature region, providing a quantitative measure of the random intensity fluctuations caused by coherent light interference effects. Pattern features exhibiting speckle contrast values above a predetermined threshold (e.g., 0.3 or 0.4) may indicate insufficient speckle averaging, prompting the system to increase wavelength modulation frequency or amplitude. Conversely, pattern features with very low speckle contrast values (e.g., below 0.1) may indicate that adequate speckle averaging has been achieved, allowing the system to reduce modulation parameters to minimize unnecessary pattern feature smearing.

Pattern feature smearing estimation may include comparing the observed spatial extent and intensity distribution of captured pattern features against theoretical predictions based on the known characteristics of the structured light projector and the current modulation parameters. Pattern features that appear significantly larger, more diffuse, or less circular than expected may indicate excessive smearing caused by overly aggressive wavelength modulation and/or by scanner motion. Processing logic may quantify smearing magnitude by measuring parameters such as pattern feature diameter, edge sharpness, peak intensity, and/or centroid stability across multiple image frames.

At block 1320, processing logic may determine dental object classification of dental object(s) in intraoral scans. Dental object classification may be performed using one or more trained machine learning models to analyze captured images and identify the type of tissue or material currently being scanned. Convolutional neural networks (CNNs) trained on large datasets of intraoral images may distinguish between tooth enamel, dentin, gingival tissue, restorative materials such as ceramics or metals, and/or other intraoral structures, for example. Each tissue type may exhibit characteristic optical properties that influence optimal modulation strategies. Tooth enamel, with its crystalline structure and high refractive index, typically produces strong speckle patterns that benefit from aggressive wavelength modulation. Gingival tissue, being softer and more diffusely scattering, may produce weaker speckle patterns and may require different modulation approaches optimized for low-contrast surfaces.

The classification system may also identify specific scanning scenarios that benefit from specialized modulation strategies. Detection of preparation margins, which represent critical boundaries between prepared tooth structure and surrounding enamel, may trigger high-precision modulation modes that prioritize measurement accuracy over scanning speed. Identification of metallic restorations may activate modulation schemes optimized for highly reflective surfaces that produce complex speckle patterns with different spatial and temporal characteristics compared to natural tooth structure.

At block 1322, processing logic may determine coherent light source type. This may involve identifying the specific characteristics of the laser diodes or other coherent light sources used in the structured light projectors, including their wavelength characteristics, temperature sensitivity, and modulation capabilities. Different laser diode models may exhibit varying wavelength sensitivity to temperature changes, which influences the optimal current modulation ranges and frequencies. The wavelength characteristics of the laser diodes used in the structured light projectors may determine the optimal current modulation ranges, as different laser diode models exhibit varying wavelength sensitivity to temperature changes. In some embodiments, the coherent light source type is preconfigured and fixed.

The coherent light source type determination may also consider the distinction between central wavelength and bandwidth characteristics of laser diodes. The central wavelength refers to the primary wavelength at which the laser diode emits light under specific operating conditions, typically measured at a particular temperature and current level. This central wavelength may shift predictably with changes in temperature and drive current, making it useful for controlled wavelength modulation applications. The bandwidth, also referred to as spectral width or linewidth, describes the range of wavelengths over which the laser diode emits light around the central wavelength. Narrow bandwidth laser diodes may produce more coherent light with stronger speckle patterns, potentially benefiting from more aggressive modulation strategies to achieve adequate speckle reduction. Broader bandwidth laser diodes may inherently produce multiple wavelengths simultaneously, which can naturally reduce speckle contrast but may also reduce the effectiveness of wavelength-based modulation techniques. The selection between narrow and broad bandwidth laser diodes may influence the optimal modulation approach, with narrow bandwidth sources benefiting more from temperature-induced wavelength modulation and broad bandwidth sources potentially requiring alternative speckle reduction strategies.

At block 1325, processing logic evaluates whether to modulate the wavelength of coherent light being produced or to be produced and/or whether to update a pulse scheme. This decision may be based on the analysis of all previously determined parameters, including scanner velocity, working distance, speckle contrast levels, dental object classification, and/or light source characteristics. For example, when scanning tooth enamel with high speckle characteristics at close working distances with slow scanner movement, processing logic may determine that wavelength modulation is beneficial. Conversely, when scanning gingival tissue at high scanner velocities where natural motion blur provides adequate speckle averaging, processing logic may determine that modulation is unnecessary. If the decision at block 1325 is No, the method returns to block 1305 to continue monitoring scanning conditions. If the decision at block 1325 is Yes, the method proceeds to block 1330.

At block 1330, processing logic may determine a frequency at which to modulate coherent light. Additionally, or alternatively, processing logic may determine a pulse scheme for the light. The pulse scheme may include a shape of a pulse (e.g., a current pulse or power pulse) over time. Different shaped pulses may cause different speckle contrast and/or pattern feature (e.g., spot) blurring. Alternatively, processing logic may simply begin modulating the wavelength of the coherent light based on one or more predetermined settings. The frequency determination and/or pulse scheme may be determined based on factors such as the camera exposure time, the magnitude of wavelength change achievable with the specific light source, the working distance to the target surface, movement speed of the intraoral scanner, a type of dental object and/or material in a field of view of the intraoral scanner, and/or a target balance between speckle reduction and pattern feature smearing. Higher modulation frequencies and/or first pulse schemes may be selected for close working distances or when aggressive speckle reduction is required, while lower frequencies and/or second pulse schemes may be chosen to minimize smearing when pattern feature precision is critical. In some embodiments, pulse schemes are selected and/or adjusted via closed loop control. In some embodiments, pulse schemes are selected and/or adjusted based on application of machine learning. For example, current data such as captured 2D images, captured intraoral scans, camera exposure time, magnitude of wavelength change achievable with the specific light source, working distance to the target surface, movement speed of the intraoral scanner, type of dental object and/or material in a field of view of the intraoral scanner, and/or target balance between speckle reduction and pattern feature smearing may be input into a trained machine learning model, which may output a modulation frequency and/or a pulse scheme. A few example modulation schemes are discussed with reference to FIG. 13B.

FIG. 13B illustrates three example pulse schemes for controlling a light beam during intraoral scanning, in accordance with embodiments of the present disclosure. FIG. 13B shows spot shape positions/movement, a current driving shape, and a light intensity profile for each of the pulse schemes. The pulse schemes include a first pulse scheme A 1350, which is a short single pulse in which the current is turned on to a high level to generate a high intensity pattern feature (e.g., spot) for a short period of time and without movement. This pulse scheme results in a brief spike in the current driving shape and a tall gaussian light intensity profile. The pulse schemes include a second pulse scheme B 1360, which is a long low current pulse in which the current is turned on for a longer period of time while the pattern feature is moved (e.g., linearly swept along a line). This pulse scheme results in a long low current driving shape and a short and wide gaussian light intensity profile. The pulse schemes include a third pulse scheme C 1370, which includes two brief medium current pulses separated by a short time interval. The third pulse driving shape may result in a current driving shape with two brief mid-level current peaks and a light intensity profile with two distinct peaks.

Each of the illustrated pulse schemes will create a different level of smearing and speckle contrast/noise. The first pulse scheme A 1350 will have the least smear and maximal speckle contrast/noise. The second pulse scheme B 1360 will have more smear and less speckle contrast/noise. The third pulse scheme C 1370 will have maximal smear and minimal speckle contrast/noise.

Assuming a laser diode in which the power integration is the same, when the power limit is mirroring damage and instant power is limited, the first modulation scheme A 1350 is more limited in maximal power than the second modulation scheme B 1360, and the third modulation scheme C 1370 has more limited power than the second modulation scheme B 1360. Accordingly, when considering motion de-speckle, the shape of the pulse can have a significant effect. When optimizing the shape of the pulse, there are many degrees of freedom, and the level of noise is dependent on many factors.

FIG. 13B shows speckle reduction resulting only from motion of the pattern feature (e.g., spot) on an object. It can be assumed that objective surface speckles are not correlated when a spot is moved by a full spot size. If we look at a smeared spot on an illuminated object, when the position of the spot on a sensor is not moving, this will result in spot with less speckle noise.

The selection of an optimal pulse scheme may depend on multiple factors that vary during scanning operations. In some embodiments, the pulse scheme may be selected or adjusted based on the pattern feature distance from the projector, as greater distances result in larger lateral displacements for a given angular deflection. The material type being scanned may also influence pulse scheme selection, as different materials (e.g., tooth enamel versus gingiva versus metallic restorations) may exhibit different speckle characteristics and may benefit from different balances between speckle reduction and pattern feature preservation. The characteristics of the light source (e.g., laser diode), including its central wavelength and spectral bandwidth, may affect the wavelength variation achievable for a given current modulation, influencing the optimal pulse parameters. Additionally, the speed of scanner motion may be considered, as faster scanning speeds provide natural motion-based speckle averaging that may reduce the need for aggressive current modulation. In some embodiments, the system may dynamically select between pulse schemes based on real-time assessment of these factors, transitioning between schemes optimized for different scanning conditions as the scanner moves through different regions of the oral cavity.

Returning to FIG. 13A, the closed loop control system may implement adaptive feedback mechanisms that make incremental adjustments to modulation parameters and evaluate the resulting changes in image quality metrics. For example, processing logic may slightly increase the wavelength modulation frequency by 5-10% and then capture several image frames to assess the impact on both speckle contrast and pattern feature smearing. If the adjustment results in measurable speckle contrast reduction without causing excessive smearing, processing logic may continue increasing the modulation frequency in small increments until an optimal balance is achieved. If the adjustment causes unacceptable smearing or fails to provide meaningful speckle reduction, processing logic may reverse the change and explore adjustments in the opposite direction.

The iterative optimization process in closed loop control may employ various mathematical optimization algorithms to efficiently converge on optimal modulation parameters. Gradient descent algorithms may be used to minimize a cost function that combines speckle contrast and smearing penalties, with the relative weighting of these factors adjusted based on specific scanning requirements. For applications requiring maximum measurement precision, such as crown preparation scanning, the cost function may heavily penalize pattern feature smearing while accepting moderate speckle contrast levels. For applications where speed is prioritized over ultimate precision, such as initial arch scanning for orthodontic treatment planning, the cost function may accept higher smearing levels in exchange for more aggressive speckle reduction that enables faster scanning speeds.

Processing logic then continues to block 1335, where it modulates the coherent light at the determined frequency. In embodiments, processing logic controls the current or power delivered to the light sources to achieve the desired wavelength modulation, which in turn causes the pattern features to move laterally due to the wavelength-dependent deflection characteristics of diffractive optical elements in the structured light projector.

In some embodiments, the method 1300 may incorporate predictive algorithms that anticipate optimal modulation parameters based on the scanning trajectory and planned scanning sequence. For example, when transitioning from scanning smooth gingival surfaces to textured tooth surfaces, processing logic may preemptively adjust modulation parameters to optimize performance for the upcoming surface type. Similarly, when approaching areas known to require high precision measurements, such as preparation margins or contact points between adjacent teeth, processing logic may gradually transition to high-precision modulation modes to ensure optimal measurement accuracy when reaching these critical regions.

Quality assurance mechanisms in method 1300 may continuously monitor the effectiveness of the chosen modulation parameters by analyzing the success rate of pattern feature detection, the accuracy of 3D point cloud generation, and the consistency of measurements across multiple image frames. If processing logic detects degraded performance metrics, such as increased pattern feature detection failures or higher measurement noise levels, it may trigger recalibration procedures or switch to alternative modulation strategies. Processing logic may also maintain historical performance data to identify long-term trends or degradation in scanner performance that may require maintenance or component replacement.

In some embodiments, processing logic fundamentally operates by balancing the trade-off between two primary sources of measurement inaccuracy: pattern feature smearing and speckle contrast. This balance represents a fundamental optimization problem in coherent light-based structured light systems, where reducing one error source typically increases the other. Pattern feature smearing, caused by wavelength modulation and the resulting lateral movement of projected spots due to the wavelength-dependent deflection characteristics of diffractive optical elements, can reduce the precision with which pattern feature centers can be located in captured images. The magnitude of this smearing effect depends on multiple factors, including the modulation frequency, the wavelength change amplitude, the working distance to the target surface, and the angular sensitivity of the diffractive optical elements used in the structured light projector.

Speckle contrast, caused by coherent light interference effects when laser light interacts with optically rough surfaces such as tooth enamel, creates random intensity variations within pattern features that can significantly degrade center location accuracy. The speckle pattern characteristics depend on factors such as the surface roughness of the scanned object, the coherence length of the laser light, the numerical aperture of the imaging system, and the relative motion between the scanner and the target surface.

In some embodiments, the optimal operating point in method 1300 represents the modulation level that minimizes the root-mean-square combination of smearing-induced errors and speckle-induced errors. This optimal point may vary dynamically based on scanning conditions, target surface properties, measurement accuracy requirements, and the specific characteristics of the structured light projector and imaging system. For surfaces with strong speckle characteristics, such as highly polished dental restorations, the optimal operating point may favor aggressive wavelength modulation despite the associated smearing penalty. For surfaces with weak speckle characteristics, such as soft gingival tissue, the optimal operating point may minimize modulation to preserve pattern feature sharpness while accepting moderate speckle contrast levels.

The method 1300 may also incorporate machine learning algorithms that continuously improve the optimization process based on accumulated experience from previous scanning sessions. Reinforcement learning algorithms may be trained to recognize patterns in scanning conditions and automatically select modulation parameters that have historically produced optimal results under similar circumstances. This learning capability may enable the system to adapt to individual user scanning techniques, specific patient populations, or particular clinical applications, continuously improving performance over time.

In embodiments, the real-time feedback control system for wavelength modulation employs sophisticated algorithms to continuously monitor image quality metrics and adjust modulation parameters to maintain optimal speckle reduction performance. The feedback control loop operates by analyzing each captured image frame to extract quantitative measures of speckle contrast and pattern feature quality, comparing these metrics against target values, and computing appropriate adjustments to the current modulation parameters. The speckle contrast estimation algorithm may analyze the intensity distribution within each detected pattern feature, calculating statistical measures such as the coefficient of variation (standard deviation divided by mean) and comparing these values against theoretical predictions for different numbers of independent speckle patterns.

The control algorithm may implement a multi-objective optimization approach that balances speckle reduction against pattern feature preservation. The system may maintain running estimates of both speckle contrast and pattern feature smearing magnitude, using these estimates to compute a composite quality metric that guides the parameter adjustment process. When speckle contrast exceeds a predetermined threshold (e.g., 0.3), the controller may increase the modulation frequency or amplitude to generate more independent speckle patterns. Conversely, when pattern feature smearing becomes excessive, as indicated by features that are significantly larger or less circular than expected, the controller may reduce the modulation intensity to preserve pattern feature quality. In some embodiments, the adjustment process uses proportional-integral-derivative (PID) control principles to provide stable, responsive parameter updates while avoiding oscillatory behavior.

In some embodiments, the feedback control system incorporates adaptive learning mechanisms that improve performance over time by analyzing the effectiveness of different parameter combinations under various scanning conditions. The system may maintain a database of scanning scenarios characterized by factors such as target surface type, working distance, scanner velocity, and ambient lighting conditions, along with the optimal modulation parameters determined for each scenario. Machine learning algorithms, such as neural networks or support vector machines, may be trained on this historical data to predict optimal modulation parameters for new scanning conditions, reducing the time that it takes for the feedback control system to converge on optimal settings. The adaptive learning system may also identify long-term trends in system performance that could indicate component aging or degradation, triggering maintenance alerts or automatic recalibration procedures.

A specialized calibration jig may be employed to characterize and optimize the speckle reduction performance of the wavelength modulation system under controlled conditions. The calibration jig typically may Include a flat, optically diffuse target surface mounted on a precision linear translation stage that can move a target through known distances with micrometer-level accuracy. This configuration allows for systematic evaluation of speckle patterns by capturing multiple images of the same target region at slightly different positions, effectively creating a reference dataset of independent speckle realizations that can be averaged to produce a speckle-free reference image. The translation stage may be computer-controlled to enable automated data collection across multiple target positions and scanning conditions.

The testing methodology using the calibration jig may involve capturing sequences of images under various current modulation conditions while maintaining fixed geometric relationships between the scanner, target, and translation stage. For each modulation condition, the system captures images both with and without target translation to separate the effects of wavelength-induced speckle reduction from motion-induced speckle averaging. The speckle contrast may be quantified by analyzing the intensity statistics within individual pattern features, calculating metrics such as the standard deviation to mean ratio, and comparing these values across different modulation parameters. This systematic approach enables optimization of current levels, modulation frequencies, and duty cycles to achieve maximum speckle reduction while minimizing pattern feature degradation.

The calibration jig methodology also enables characterization of the spatial variation in speckle reduction effectiveness across the field of view of the structured light projectors. Different regions of the projected pattern may experience varying levels of speckle reduction due to factors such as non-uniform illumination, optical aberrations, or variations in the local angle of incidence on the target surface. By systematically scanning the target across the entire field of view and analyzing speckle statistics as a function of position, the system can identify regions that may require additional optimization or compensation. The calibration data collected using this methodology may be used to generate lookup tables or correction algorithms that adjust modulation parameters based on the specific pattern features being projected and their locations within the field of view.

In some embodiments, a calibration jig may be used to characterize the relationship between current modulation parameters, speckle contrast, and pattern feature smearing for different rays of the structured light projector. The calibration jig may include a flat, optically diffuse target surface mounted on a precision linear translation stage (e.g., an X motor) that can move the target through known distances. By capturing multiple images at different target positions along the translation axis, each image captures a different speckle realization for the same pattern features. Accumulating and averaging these multiple images creates a substantially speckle-free reference image that serves as ground truth for measuring both the smearing level and the amount of speckle noise in individual speckled images. The calibration process may be repeated at different levels of current modulation to characterize how the de-speckle mechanism interacts with pattern feature smearing across the range of modulation parameters. Since different rays of the structured light projector exit at different angles from the pattern generating optical element, the speckle reduction and smearing effects may vary across the field of illumination. The calibration jig methodology enables characterization of these spatial variations, allowing the system to generate correction factors or lookup tables that account for position-dependent effects when optimizing modulation parameters during scanning operations.

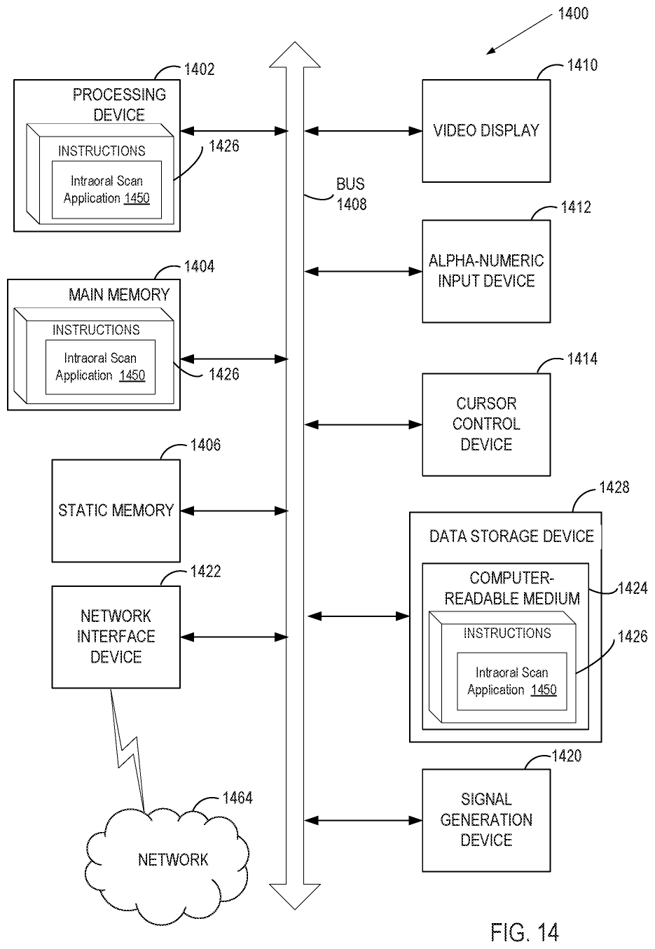

FIG. 14 illustrates a diagrammatic representation of a machine in the example form of a computing device 1400 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 1400 includes a processing device 1402, a main memory 1404 (e.g., read-only memory (ROM), flash memory, dynamic random access memory (DRAM) such as synchronous DRAM (SDRAM), etc.), a static memory 1406 (e.g., flash memory, static random access memory (SRAM), etc.), and a secondary memory (e.g., a data storage device 1428), which communicate with each other via a bus 1408.

Processing device 1402 represents one or more general-purpose processors such as a microprocessor, central processing unit, or the like. More particularly, the processing device 1402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1402 may also be one or more special-purpose processing devices such as an application specific integrated circuit (ASIC), a field programmable gate array (FPGA), a digital signal processor (DSP), network processor, or the like. Processing device 1402 is configured to execute the processing logic (instructions 1426) for performing operations and steps discussed herein.

The computing device 1400 may further include a network interface device 1422 for communicating with a network 1464. The computing device 1400 also may include a video display unit 1410 (e.g., a liquid crystal display (LCD) or a cathode ray tube (CRT)), an alphanumeric input device 1412 (e.g., a keyboard), a cursor control device 1414 (e.g., a mouse), and a signal generation device 1420 (e.g., a speaker).

The data storage device 1428 may include a machine-readable storage medium (or more specifically a non-transitory computer-readable storage medium) 1424 on which is stored one or more sets of instructions 1426 embodying any one or more of the methodologies or functions described herein. Wherein a non-transitory storage medium refers to a storage medium other than a carrier wave. The instructions 1426 may also reside, completely or at least partially, within the main memory 1404 and/or within the processing device 1402 during execution thereof by the computer device 1400, the main memory 1404 and the processing device 1402 also constituting computer-readable storage media.

The computer-readable storage medium 1424 may also be used to store an intraoral scan application 1450, which may correspond to the intraoral scan application of FIG. 9. While the computer-readable storage medium 1424 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

As used herein, the term “means for generating coherent light” may correspond to a laser diode or other coherent light source such as those described with reference to light sources 236, 336A, 336B, and 402. The term “means for producing a structured light pattern from the coherent light” may correspond to a feature pattern generating optical element such as a diffractive optical element (DOE), a micro-lens array (MLA), a transmission mask, or other pattern generating optical elements as described with reference to elements 238, 338, and 422. The term “means for causing at least one of the coherent light or the structured light pattern to have a plurality of speckle patterns” may correspond to one or more of: a speckle pattern generating optical element such as an elliptical or circular polarizer (e.g., a quarter waveplate) as described with reference to element 250; a controller configured to fluctuate power or current delivered to the light source to cause wavelength variations; multiple light sources configured to produce light at different wavelengths; a vibrator configured to vibrate the structured light projector; or a wavelength-dependent turning element such as a diffractive optical element configured to convert wavelength variations into angular variations as described with reference to element 410.

Some non-limiting example implementations are set forth below.

A first example implementation is an intraoral scanning system, comprising: an intraoral scanner comprising: a structured light projector configured to project structured light onto an intraoral object, the structured light projector comprising: at least one light source configured to generate coherent light; and a feature pattern generating optical element configured to output the structured light when the coherent light is transmitted through the feature pattern generating optical element; a plurality of cameras configured to capture one or more sets of images of the structured light projected onto the intraoral object; and one or more speckle pattern generating elements configured to cause the projected structured light to have a plurality of speckle patterns; and a computing device configured to: solve a correspondence problem within each set of images such that points in three-dimensional (3D) space are determined based on correspondence between projected features of the structured light and captured features of the structured light captured in the set of images; and generate a 3D representation of the intraoral object based at least in part on a solution to the correspondence problem.

A second example implementation may extend the first example implementation. In the second example implementation, the one or more speckle pattern generating elements comprise a speckle pattern generating optical element.

A third example implementation may extend the second example implementation. In the third example implementation, the coherent light is linearly polarized, and the speckle pattern generating optical element comprises an elliptical polarizer configured to receive the linearly polarized light and to output elliptically polarized light.

A fourth example implementation may extend the third example implementation. In the fourth example implementation, the elliptical polarizer is a circular polarizer, and the elliptically polarized light is circularly polarized light.

A fifth example implementation may extend any of the second through fourth example implementations. In the fifth example implementation, the speckle pattern generating optical element comprises a quarter waveplate.

A sixth example implementation may extend any of the second through fifth example implementations. In the sixth example implementation, the at least one light source comprises a laser diode, and the feature pattern generating optical element comprises a diffractive optical element.

A seventh example implementation may extend any of the second through sixth example implementations. In the seventh example implementation, the structured light projector further comprises: a lens configured to focus the coherent light; wherein one of: a) the speckle pattern generating optical element is disposed between the lens and the feature pattern generating optical element; b) the feature pattern generating optical element is disposed between the lens and the speckle pattern generating optical element; or c) the feature pattern generating optical element and the speckle pattern generating optical element are integrated into a same optical element.

An eighth example implementation may extend the seventh example implementation. In the eighth example implementation, the same optical element comprises the speckle pattern generating optical element at a first side and the feature pattern generating optical element at a second side opposite the first side.

A ninth example implementation may extend any of the first through eighth example implementations. In the ninth example implementation, the one or more speckle pattern generating elements comprise a controller configured to dynamically fluctuate a power of the at least one light source, wherein fluctuations in the power of the at least one light source cause fluctuations in a temperature of the at least one light source, resulting in fluctuations in a wavelength of the coherent light output by the at least one light source, and wherein the fluctuations in the wavelength of the coherent light cause speckle pattern fluctuations.

A tenth example implementation may extend the ninth example implementation. In the tenth example implementation, the speckle pattern fluctuations occur within an exposure time of the plurality of cameras such that the plurality of speckle patterns caused by the fluctuations in the wavelength of the coherent light are captured in each image of the one or more sets of images.

An eleventh example implementation may extend any of the ninth through tenth example implementations. In the eleventh example implementation, the controller is configured to adjust a current of the at least one light source, causing the power of the at least one light source to fluctuate.

A twelfth example implementation may extend any of the ninth through eleventh example implementations. In the twelfth example implementation, the at least one light source comprises a laser diode.

A thirteenth example implementation may extend any of the ninth through twelfth example implementations. In the thirteenth example implementation, two powers are used for the at least one light source over an exposure time of the plurality of cameras.

A fourteenth example implementation may extend the thirteenth example implementation. In the fourteenth example implementation, the two powers comprise a first power and a second power that is greater than the first power, and a first duration of the first power is greater than a second duration of the second power to cause a total intensity of captured light to be approximately equivalent for the first duration and the second duration.

A fifteenth example implementation may extend any of the ninth through fourteenth example implementations. In the fifteenth example implementation, the controller is further configured to: determine a scanning regime; and select a power fluctuation scheme for the at least one light source based on the scanning regime.

A sixteenth example implementation may extend the fifteenth example implementation. In the sixteenth example implementation, the scanning regime is selected from a group consisting of: an orthodontic scanning regime, a restorative scanning regime, and an edentulous scanning regime.

A seventeenth example implementation may extend any of the first through sixteenth example implementations. In the seventeenth example implementation, the at least one light source comprises a first light source configured to produce a first coherent light having a first wavelength and a second light source configured to produce a second coherent light having a second wavelength that is offset from the first wavelength, wherein the first wavelength produces a first speckle pattern and the second wavelength produces a second speckle pattern.

An eighteenth example implementation may extend the seventeenth example implementation. In the eighteenth example implementation, the first light source and the second light source are configured to produce the first coherent light and the second coherent light simultaneously or alternately at a rate that enables the plurality of cameras to capture the first speckle pattern and the second speckle pattern in a single exposure.

A nineteenth example implementation may extend the eighteenth example implementation. In the nineteenth example implementation, the rate of alternating between activation of the first light source and the second light source is one or more gigahertz.

A twentieth example implementation may extend any of the first through nineteenth example implementations. In the twentieth example implementation, the one or more speckle pattern generating elements comprise a vibrator configured to vibrate the structured light projector and fluctuate positions of the structured light, resulting in the plurality of speckle patterns.

A twenty-first example implementation may extend any of the first through twentieth example implementations. In the twenty-first example implementation, the intraoral scanning system further comprises: a stack of dielectric layers on the feature pattern generating optical element, wherein the stack of dielectric layers is configured to increase a transmittance of the coherent light at first angles of incidence below an angle threshold and to increase a reflectance of the coherent light at second angles of incidence above the angle threshold.

A twenty-second example implementation may extend the twenty-first example implementation. In the twenty-second example implementation, the feature pattern generating optical element comprises a diffractive optical element (DOE) with a rectangular or hexagonal arrangement.

A twenty-third example implementation may extend any of the twenty-first through twenty-second example implementations. In the twenty-third example implementation, the stack of dielectric layers is an alternating stack of a first layer having a first index of refraction and a first thickness and a second layer having a second index of refraction and a second thickness.

A twenty-fourth example implementation may extend any of the twenty-first through twenty-third example implementations. In the twenty-fourth example implementation, the stack of dielectric layers is tuned to a wavelength of the coherent light.

A twenty-fifth example implementation may extend any of the twenty-first through twenty-fourth example implementations. In the twenty-fifth example implementation, the angle threshold is 45 degrees.

A twenty-sixth example implementation may extend any of the first through twenty-fifth example implementations. In the twenty-sixth example implementation, the projected features and the captured features comprise spots.

A twenty-seventh example implementation is an intraoral scanning system, comprising: an intraoral scanner comprising: a structured light projector configured to project structured light onto an intraoral object, the structured light projector comprising: at least one light source configured to generate coherent light; a feature pattern generating optical element configured to output the structured light when the coherent light is transmitted through the feature pattern generating optical element; and a stack of dielectric layers on the feature pattern generating optical element, wherein the stack of dielectric layers is configured to increase a transmittance of the coherent light at first angles below an angle threshold and to increase a reflectance of the coherent light at second angles above the angle threshold; and a plurality of cameras configured to capture one or more sets of images of the structured light projected onto the intraoral object; and a computing device configured to: solve a correspondence problem within each set of images such that points in three-dimensional (3D) space are determined based on correspondence between projected features of the structured light and captured features of the structured light captured in the set of images; and generate a 3D representation of the intraoral object based at least in part on a solution to the correspondence problem.

A twenty-eighth example implementation may extend any of the twenty-seventh example implementation. In the twenty-eighth example implementation, the feature pattern generating optical element comprises a diffractive optical element (DOE) with a rectangular or hexagonal arrangement.

A twenty-ninth example implementation may extend any of the twenty-seventh through twenty-eighth example implementations. In the twenty-ninth example implementation, the stack of dielectric layers is an alternating stack of a first layer having a first index of refraction and a first thickness and a second layer having a second index of refraction and a second thickness.

A thirtieth example implementation may extend any of the twenty-seventh through twenty-ninth example implementations. In the thirtieth example implementation, the stack of dielectric layers is tuned to a wavelength of the coherent light.

A thirty-first example implementation may extend any of the twenty-seventh through thirtieth example implementations. In the thirty-first example implementation, the angle threshold is 45 degrees.

A thirty-second example implementation is an intraoral scanner, comprising: a structured light projector configured to project structured light onto an intraoral object, the structured light projector comprising: at least one light source configured to generate coherent light; and a feature pattern generating optical element configured to output the structured light when the coherent light is transmitted through the feature pattern generating optical element; one or more speckle pattern generating elements configured to cause the projected structured light to have a plurality of speckle patterns; a plurality of cameras configured to capture one or more sets of images of the structured light projected onto the intraoral object; and a communication module to transmit the one or more sets of images to a computing device.

A thirty-third example implementation may extend the thirty-second example implementation. In the thirty-third example implementation, the one or more speckle pattern generating elements comprise a speckle pattern generating optical element.

A thirty-fourth example implementation may extend the thirty-third example implementation. In the thirty-fourth example implementation, the coherent light is linearly polarized, and the speckle pattern generating optical element comprises an elliptical polarizer configured to receive the linearly polarized light and to output elliptically polarized light.

A thirty-fifth example implementation may extend any of the thirty-third through thirty-fourth example implementations. In the thirty-fifth example implementation, the structured light projector further comprises: a lens configured to focus the coherent light; wherein one of: a) the speckle pattern generating optical element is disposed between the lens and the feature pattern generating optical element; b) the feature pattern generating optical element is disposed between the lens and the speckle pattern generating optical element; or c) the feature pattern generating optical element and the speckle pattern generating optical element are integrated into a same optical element.

A thirty-sixth example implementation may extend the thirty-fifth example implementation. In the thirty-sixth example implementation, the optical element comprises the speckle pattern generating optical element at a first side and the feature pattern generating optical element at a second side opposite the first side.

A thirty-seventh example implementation may extend any of the thirty-second through thirty-sixth example implementations. In the thirty-seventh example implementation, the one or more speckle pattern generating elements comprise a controller configured to dynamically fluctuate a power of the at least one light source, wherein fluctuations in the power of the at least one light source cause fluctuations in a temperature of the at least one light source, resulting in fluctuations in a wavelength of the coherent light output by the at least one light source, and wherein the fluctuations in the wavelength of the coherent light cause speckle pattern fluctuations.

A thirty-eighth example implementation may extend the thirty-seventh example implementation. In the thirty-eighth example implementation, the speckle pattern fluctuations occur within an exposure time of the plurality of cameras such that the plurality of speckle patterns caused by the fluctuations in the wavelength of the coherent light are captured in each image of the one or more sets of images.

A thirty-ninth example implementation may extend any of the thirty-seventh through thirty-eighth example implementations. In the thirty-ninth example implementation, two powers are used for the at least one light source over an exposure time of the plurality of cameras.

A fortieth example implementation may extend the thirty-ninth example implementation. In the fortieth example implementation, the two powers comprise a first power and a second power that is greater than the first power, and a first duration of the first power is greater than a second duration of the second power to cause a total intensity of captured light to be approximately equivalent for the first duration and the second duration.

A forty-first example implementation may extend any of the thirty-seventh through fortieth example implementations. In the forty-first example implementation, the controller is further configured to: determine a scanning regime; and select a power fluctuation scheme for the at least one light source based on the scanning regime.

A forty-second example implementation may extend any of the thirty-second through forty-first example implementations. In the forty-second example implementation, the at least one light source comprises a first light source configured to produce a first coherent light having a first wavelength and a second light source configured to produce a second coherent light having a second wavelength that is offset from the first wavelength, wherein the first wavelength produces a first speckle pattern and the second wavelength produces a second speckle pattern.

A forty-third example implementation may extend any of the thirty-second through forty-second example implementations. In the forty-third example implementation, the first light source and the second light source are configured to produce the first coherent light and the second coherent light simultaneously or alternately at a rate that enables the plurality of cameras to capture the first speckle pattern and the second speckle pattern in a single exposure.

A forty-fourth example implementation may extend the forty-third example implementation. In the forty-fourth example implementation, the rate of alternating between activation of the first light source and the second light source is one or more gigahertz.

A forty-fifth example implementation may extend any of the thirty-second through forty-fourth example implementations. In the forty-fifth example implementation, the one or more speckle pattern generating elements comprise a vibrator configured to vibrate the structured light projector and fluctuate positions of the structured light, resulting in the plurality of speckle patterns.

A forty-sixth example implementation may extend any of the thirty-second through forty-fifth example implementations. In the forty-sixth example implementation, the intraoral scanner further comprises: a stack of dielectric layers on the feature pattern generating optical element, wherein the stack of dielectric layers is configured to increase a transmittance of the coherent light at first angles of incidence below an angle threshold and to increase a reflectance of the coherent light at second angles of incidence above the angle threshold.

A forty-seventh example implementation may extend the forty-sixth example implementation. In the forty-seventh example implementation, the feature pattern generating optical element comprises a diffractive optical element (DOE) with a rectangular or hexagonal arrangement.

A forty-eighth example implementation may extend any of the forty-sixth through forty-seventh example implementations. In the forty-eighth example implementation, the stack of dielectric layers is an alternating stack of a first layer having a first index of refraction and a first thickness and a second layer having a second index of refraction and a second thickness.

A forty-ninth example implementation may extend any of the forty-sixth through forty-eighth example implementations. In the forty-ninth example implementation, the stack of dielectric layers is tuned to a wavelength of the coherent light.

A fiftieth example implementation may extend any of the forty-sixth through forty-ninth example implementations. In the fiftieth example implementation, the angle threshold is 45 degrees.

A fifty-first example implementation is an intraoral scanner, comprising: a structured light projector configured to project structured light onto an intraoral object, the structured light projector comprising: at least one light source configured to generate coherent light; a feature pattern generating optical element configured to output the structured light when the coherent light is transmitted through the feature pattern generating optical element; and a stack of dielectric layers on the feature pattern generating optical element, wherein the stack of dielectric layers is configured to increase a transmittance of the coherent light at first angles below an angle threshold and to increase a reflectance of the coherent light at second angles above the angle threshold; a plurality of cameras configured to capture one or more sets of images of the structured light projected onto the intraoral object; and a communication module configured to transmit the one or more sets of images to a computing device.

A fifty-second example implementation may extend the fifty-first example implementation. In the fifty-second example implementation, the feature pattern generating optical element comprises a diffractive optical element (DOE) with a rectangular or hexagonal arrangement.

A fifty-third example implementation may extend any of the fifty-first through fifty-second example implementations. In the fifty-third example implementation, the stack of dielectric layers is an alternating stack of a first layer having a first index of refraction and a first thickness and a second layer having a second index of refraction and a second thickness.

A fifty-fourth example implementation may extend any of the fifty-first through fifty-third example implementations. In the fifty-fourth example implementation, the stack of dielectric layers is tuned to a wavelength of the coherent light.

A fifty-fifth example implementation may extend any of the fifty-first through fifty-fourth example implementations. In the fifty-fifth example implementation, the angle threshold is 45 degrees.

A fifty-sixth example implementation is an intraoral scanning system, comprising: an intraoral scanner comprising: a structured light projector configured to project structured light onto an intraoral object, the structured light projector comprising: at least one light source configured to generate coherent light; a feature pattern generating optical element configured to output the structured light when the coherent light is transmitted through the feature pattern generating optical element; and a polarizer configured to cause at least one of the coherent light or the structured light to have a combination of x-polarization and y-polarization; and a plurality of cameras configured to capture one or more sets of images of the structured light projected onto the intraoral object; and a computing device configured to: solve a correspondence problem within each set of images such that points in three-dimensional (3D) space are determined based on correspondence between projected features of the structured light and captured features of the structured light captured in the set of images; and generate a 3D representation of the intraoral object based at least in part on a solution to the correspondence problem.

A fifty-seventh example implementation is an intraoral scanner, comprising: a structured light projector configured to project structured light onto an intraoral object, the structured light projector comprising: at least one light source configured to generate coherent light; a feature pattern generating optical element configured to output the structured light when the coherent light is transmitted through the feature pattern generating optical element; and a polarizer configured to cause at least one of the coherent light or the structured light to have a combination of x-polarization and y-polarization; and a plurality of cameras configured to capture one or more sets of images of the structured light projected onto the intraoral object.

A fifty-eighth example implementation is an intraoral scanner comprising: a structured light projector comprising: a laser diode configured to generate coherent light; an aperture configured to shape the coherent light; a lens configured to focus the coherent light; a polarization element configured to polarize the coherent light, and a pattern generating optical element configured to output structured light when the coherent light is transmitted through the pattern generating optical element; one or more cameras configured to capture a plurality of images of the structured light projected onto an intraoral object; and a processor configured to process the plurality of images.

A fifty-ninth example implementation may extend the fifty-eighth example implementation. In the fifty-ninth example implementation, the coherent light output by the laser diode is linearly polarized.

A sixtieth example implementation may extend the fifty-ninth example implementation. In the sixtieth example implementation, the polarization element comprises a quarter wave plate.

A sixty-first example implementation may extend any of the fifty-ninth through sixtieth example implementations. In the sixty-first example implementation, the polarization element is configured to cause at least one of the coherent light or the structured light to have both x-polarization and y-polarization simultaneously.

A sixty-second example implementation may extend any of the fifty-eighth through sixty-first example implementations. In the sixty-second example implementation, the polarization element is disposed between the lens and the pattern generating optical element.

A sixty-third example implementation is an intraoral scanner comprising: a laser-based pattern projector for projecting a structured light pattern, wherein the structured light pattern has both x-polarization and y-polarization simultaneously; one or more cameras configured to capture a plurality of images of the structured light projected onto an intraoral object; and a processor configured to process the plurality of images.

A sixty-fourth example implementation is an intraoral scanner comprising: a laser-based pattern projector for projecting a structured light pattern; a camera having an exposure time, wherein the camera is configured to capture a plurality of images of the structured light projected onto an intraoral object; and a controller configured to adjust a wavelength of the structured light pattern over the exposure time of the camera.

A sixty-fifth example implementation may extend the sixty-fourth example implementation. In the sixty-fifth example implementation, the structured light pattern has both x-polarization and y-polarization simultaneously.

A sixty-sixth example implementation may extend any of the sixty-fourth through sixty-fifth example implementations. In the sixty-sixth example implementation, the controller is configured to adjust the wavelength by adjusting a temperature of a laser diode of the laser-based pattern projector.

A sixty-seventh example implementation may extend the sixty-sixth example implementation. In the sixty-seventh example implementation, the temperature of the laser diode is adjusted by adjusting a current delivered to the laser diode.

A sixty-eighth example implementation may extend the sixty-seventh example implementation. In the sixty-eighth example implementation, the controller is configured to cause two currents to be alternately delivered to the laser diode.

A sixty-ninth example implementation is an intraoral scanner, comprising: a structured light projector configured to project structured light onto an intraoral object, the structured light projector comprising: a means for generating coherent light; and a means for producing a structured light pattern from the coherent light; means for causing at least one of the coherent light or the structured light pattern to have a plurality of speckle patterns; a plurality of cameras configured to capture one or more sets of images of the structured light pattern projected onto an intraoral object; and a processor configured to process the one or more sets of images.

A seventieth example implementation is an intraoral scanning system, comprising: an intraoral scanner comprising: a structured light projector configured to project a structured light pattern onto an intraoral object, the structured light projector comprising: at least one light source configured to generate coherent light that modulates between at least a first wavelength and a second wavelength; a first diffractive optical element configured to adjust an angle of the coherent light to an optical axis based on wavelength, wherein the first diffractive optical element causes the coherent light at the first wavelength to have a first angle to the optical axis and causes the coherent light at the second wavelength to have a second angle to the optical axis; and a feature pattern generating optical element configured to output the structured light when the coherent light is transmitted through the feature pattern generating optical element, wherein positions of pattern features of the structured light pattern are to alternate between first positions associated with the first angle and second positions associated with the second angle; and a plurality of cameras configured to capture one or more sets of images of the structured light pattern projected onto the intraoral object, wherein alternation of the pattern features of the structured light pattern between the first positions and the second positions reduces speckle contrast in the pattern features.

A seventy-first example implementation may extend the seventieth example implementation. In the seventy-first example implementation, the structured light projector further comprises focusing optics after the at least one light source and before the first diffractive optical element, the focusing optics configured to focus the coherent light.

A seventy-second example implementation may extend the seventy-first example implementation. In the seventy-second example implementation, the focusing optics comprise an additional diffractive optical element.

A seventy-third example implementation may extend any of the seventieth through seventy-second example implementations. In the seventy-third example implementation, the intraoral scanning system further comprises: a computing device configured to: solve a correspondence problem within each set of images such that points in three-dimensional (3D) space are determined based on correspondence between projected pattern features of the structured light pattern and captured pattern features of the structured light pattern captured in the set of images; and generate a 3D representation of the intraoral object based at least in part on a solution to the correspondence problem.

A seventy-fourth example implementation may extend the seventy-third example implementation. In the seventy-fourth example implementation, the computing device is further configured to: determine a velocity of the intraoral scanner; determine a distance of the intraoral object from the intraoral scanner; and determine, based on at least one of the velocity of the intraoral scanner or the distance of the intraoral object from the intraoral scanner, at least one of a) whether to stop modulating the coherent light between the first wavelength and the second wavelength or b) a frequency at which to modulate the coherent light between the first wavelength and the second wavelength.

A seventy-fifth example implementation may extend any of the seventy-third through seventy-fourth example implementations. In the seventy-fifth example implementation, the computing device is further configured to: estimate at least one of a speckle contrast or a spot smearing magnitude for the pattern features; and adjust a frequency at which to modulate the coherent light between the first wavelength and the second wavelength based on at least one of the speckle contrast or the spot smearing magnitude.

A seventy-sixth example implementation may extend any of the seventy-third through seventy-fifth example implementations. In the seventy-sixth example implementation, the computing device is further configured to: determine a dental object classification of the intraoral object; and determine whether or not to modulate the coherent light between the first wavelength and the second wavelength based on the dental object classification of the intraoral object.

A seventy-seventh example implementation may extend the seventy-sixth example implementation. In the seventy-seventh example implementation, the dental object classification comprises a gingiva classification or a tooth classification.

A seventy-eighth example implementation may extend any of the seventy-sixth through seventy-seventh example implementations. In the seventy-eighth example implementation, the dental object classification is determined by processing one or more images of the one or more sets of images using a trained machine learning model that outputs the dental object classification.

A seventy-ninth example implementation may extend any of the seventieth through seventy-eighth example implementations. In the seventy-ninth example implementation, the at least one light source comprises a laser diode.

An eightieth example implementation may extend any of the seventieth through seventy-ninth example implementations. In the eightieth example implementation, the intraoral scanner is configured to pulse the coherent light at a first frequency, the plurality of cameras are configured to capture the one or more sets of images at an exposure time, and the at least one light source is configured to modulate between at least the first wavelength and the second wavelength at a second frequency that is greater than the first frequency and the exposure time.

An eighty-first example implementation may extend any of the seventieth through eightieth example implementations. In the eighty-first example implementation, the first diffractive optical element is tilted relative to the optical axis.

An eighty-second example implementation may extend the eighty-first example implementation. In the eighty-second example implementation, the first wavelength is about 400 nm, and a tilt of the first diffractive optical element relative to the optical axis is about 32 degrees.

An eighty-third example implementation may extend any of the seventieth through eighty-second example implementations. In the eighty-third example implementation, the first diffractive optical element is configured such that light other than first order light entering the pattern generating optical element is minimized.

An eighty-fourth example implementation may extend any of the seventieth through eighty-third example implementations. In the eighty-fourth example implementation, the first diffractive optical element comprises a linear grating that suppresses zero order light.

An eighty-fifth example implementation may extend any of the seventieth through eighty-fourth example implementations. In the eighty-fifth example implementation, the intraoral scanning system further comprises: a filter configured to filter out higher ordered light.

An eighty-sixth example implementation may extend the eighty-fifth example implementation. In the eighty-sixth example implementation, the filter comprises at least one of an electric filter, a band pass filter, or an aperture.

An eighty-seventh example implementation may extend any of the eighty-fifth through eighty-sixth example implementations. In the eighty-seventh example implementation, the higher ordered light has angles greater than a threshold angle, and the filter filters out light at the angles greater than the threshold angle.

An eighty-eighth example implementation may extend any of the eightieth through eighty-seventh example implementations. In the eighty-eighth example implementation, the intraoral scanner further comprises: a second structured light projector configured to project the structured light pattern or a second structured light pattern onto the intraoral object, the second structured light projector comprising: a second light source configured to generate second coherent light that modulates between at least a third wavelength and a fourth wavelength; a second diffractive optical element configured to adjust an angle of the second coherent light to an optical axis based on wavelength, wherein the second diffractive optical element causes the second coherent light at the third wavelength to have a third angle to the optical axis and causes the second coherent light at the fourth wavelength to have a fourth angle to the optical axis; and a second feature pattern generating optical element configured to output the structured light pattern or the second structured light pattern when the second coherent light is transmitted through the second feature pattern generating optical element, wherein positions of additional pattern features of the structured light pattern or the second structured light pattern are to alternate between third positions associated with the third angle and fourth positions associated with the fourth angle; wherein the first diffractive optical element has a first configuration optimized for the first wavelength and the second wavelength, and wherein the second diffractive optical element has a second configuration optimized for the third wavelength and the fourth wavelength.

An eighty-ninth example implementation may extend any of the seventieth through eighty-eighth example implementations. In the eighty-ninth example implementation, the first diffractive optical element is a ruled transmission grating or a volume phase holographic grating.

A ninetieth example implementation may extend any of the seventieth through eighty-ninth example implementations. In the ninetieth example implementation, the feature pattern generating optical element comprises a second diffractive optical element, a microelectromechanical systems (MEMS) device, or a mirror goniometer.

A ninety-first example implementation may extend any of the seventieth through ninetieth example implementations. In the ninety-first example implementation, alternation of the pattern features of the structured light pattern between the first positions and the second positions occurs along a single axis and causes smearing that is averaged over an exposure time of the plurality of cameras.

A ninety-second example implementation may extend any of the seventieth through ninety-first example implementations. In the ninety-second example implementation, the coherent light is linearly polarized, and the structured light projector further comprises an elliptical polarizer configured to receive the linearly polarized light and to output elliptically polarized light.

A ninety-third example implementation may extend the ninety-second example implementation. In the ninety-third example implementation, the elliptical polarizer is a circular polarizer, and the elliptically polarized light is circularly polarized light.

A ninety-fourth example implementation may extend any of the ninety-second through ninety-third example implementations. In the ninety-fourth example implementation, the elliptical polarizer comprises a quarter waveplate.

A ninety-fifth example implementation may extend any of the first through ninety-fourth example implementations. In the ninety-fifth example implementation, the intraoral scanning system further comprises: a controller configured to dynamically fluctuate a power of the at least one light source, wherein fluctuations in the power of the at least one light source cause fluctuations in a temperature of the at least one light source, resulting in fluctuations in a wavelength of the coherent light output by the at least one light source, and wherein the fluctuations in the wavelength of the coherent light cause speckle pattern fluctuations.

A ninety-sixth example implementation may extend the ninety-fifth example implementation. In the ninety-sixth example implementation, the controller is configured to adjust a current of the at least one light source, causing the power of the at least one light source to fluctuate.

A ninety-seventh example implementation may extend any of the ninety-fifth through ninety-sixth example implementations. In the ninety-seventh example implementation, two powers are used for the at least one light source over an exposure time of the plurality of cameras.

A ninety-eighth example implementation may extend the ninety-seventh example implementation. In the ninety-eighth example implementation, the two powers comprise a first power and a second power that is greater than the first power, and a first duration of the first power is greater than a second duration of the second power to cause a total intensity of captured light to be approximately equivalent for the first duration and the second duration.

A ninety-ninth example implementation may extend any of the ninety-fifth through ninety-eighth example implementations. In the ninety-ninth example implementation, the controller is further configured to: determine a scanning regime; and select a power fluctuation scheme for the at least one light source based on the scanning regime.

A one hundredth example implementation may extend the ninety-ninth example implementation. In the one hundredth example implementation, the scanning regime is selected from a group consisting of: an orthodontic scanning regime, a restorative scanning regime, and an edentulous scanning regime.

A one hundred first example implementation may extend any of the seventieth through one hundredth example implementations. In the one hundred first example implementation, the at least one light source comprises a first light source configured to produce a first coherent light having the first wavelength and a second light source configured to produce a second coherent light having the second wavelength that is offset from the first wavelength, wherein the first wavelength produces a first speckle pattern and the second wavelength produces a second speckle pattern.

A one hundred second example implementation may extend the one hundred first example implementation. In the one hundred second example implementation, the first light source and the second light source are configured to produce the first coherent light and the second coherent light simultaneously or alternately at a rate that enables the plurality of cameras to capture the first speckle pattern and the second speckle pattern in a single exposure.

A one hundred third example implementation may extend any of the seventieth through one hundred second example implementations. In the one hundred third example implementation, the intraoral scanning system further comprises: a stack of dielectric layers on the feature pattern generating optical element, wherein the stack of dielectric layers is configured to increase a transmittance of the coherent light at first angles of incidence below an angle threshold and to increase a reflectance of the coherent light at second angles of incidence above the angle threshold.

A one hundred fourth example implementation may extend any of the seventieth through one hundred third example implementations. In the one hundred fourth example implementation, the feature pattern generating optical element comprises a second diffractive optical element (DOE) with a rectangular or hexagonal arrangement.

A one hundred fifth example implementation may extend any of the seventieth through one hundred fourth example implementations. In the one hundred fifth example implementation, the intraoral scanning system further comprises: a computing device configured to: determine a pulse scheme for modulating a pulse to the at least one light source; and apply the pulse scheme to the at least one light source to control at least one of a speckle contrast or a light smear for one or more pattern features of the structured light pattern.

It is to be understood that the above description is intended to be illustrative, and not restrictive. Many other embodiments will be apparent upon reading and understanding the above description. Although embodiments of the present disclosure have been described with reference to specific example embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. An intraoral scanning system, comprising:
an intraoral scanner comprising:
a structured light projector configured to project structured light onto an intraoral object, the structured light projector comprising:
at least one light source configured to generate coherent light; and
a feature pattern generating optical element configured to output the structured light when the coherent light is transmitted through the feature pattern generating optical element;
a plurality of cameras configured to capture one or more sets of images of the structured light projected onto the intraoral object; and
one or more speckle pattern generating elements configured to cause the projected structured light to have a plurality of speckle patterns; and
a computing device configured to:
solve a correspondence problem within each set of images such that points in three-dimensional (3D) space are determined based on correspondence between projected features of the structured light and captured features of the structured light captured in the set of images; and
generate a 3D representation of the intraoral object based at least in part on a solution to the correspondence problem.

2. The intraoral scanning system of claim 1, wherein the one or more speckle pattern generating elements comprise a speckle pattern generating optical element.

3. The intraoral scanning system of claim 2, wherein the coherent light is linearly polarized, and wherein the speckle pattern generating optical element comprises an elliptical polarizer configured to receive the linearly polarized light and to output elliptically polarized light.

4. The intraoral scanning system of claim 3, wherein the elliptical polarizer is a circular polarizer, and wherein the elliptically polarized light is circularly polarized light.

5. The intraoral scanning system of claim 2, wherein the speckle pattern generating optical element comprises a quarter waveplate.

6. The intraoral scanning system of claim 2, wherein the at least one light source comprises a laser diode, and wherein the feature pattern generating optical element comprises a diffractive optical element.

7. The intraoral scanning system of claim 2, wherein the structured light projector further comprises:
a lens configured to focus the coherent light;
wherein one of:
a) the speckle pattern generating optical element is disposed between the lens and the feature pattern generating optical element;
b) the feature pattern generating optical element is disposed between the lens and the speckle pattern generating optical element; or
c) the feature pattern generating optical element and the speckle pattern generating optical element are integrated into a same optical element.

8. The intraoral scanning system of claim 7, wherein the same optical element comprises the speckle pattern generating optical element at a first side and the feature pattern generating optical element at a second side opposite the first side.

9. The intraoral scanning system of claim 1, wherein the one or more speckle pattern generating elements comprise a controller configured to dynamically fluctuate a power of the at least one light source, wherein fluctuations in the power of the at least one light source cause fluctuations in a temperature of the at least one light source, resulting in fluctuations in a wavelength of the coherent light output by the at least one light source, and wherein the fluctuations in the wavelength of the coherent light cause speckle pattern fluctuations.

10. The intraoral scanning system of claim 9, wherein the speckle pattern fluctuations occur within an exposure time of the plurality of cameras such that the plurality of speckle patterns caused by the fluctuations in the wavelength of the coherent light are captured in each image of the one or more sets of images.

11. The intraoral scanning system of claim 9, wherein the controller is configured to adjust a current of the at least one light source, causing the power of the at least one light source to fluctuate.

12. The intraoral scanning system of claim 9, wherein the at least one light source comprises a laser diode.

13. The intraoral scanning system of claim 9, wherein two powers are used for the at least one light source over an exposure time of the plurality of cameras.

14. The intraoral scanning system of claim 13, wherein the two powers comprise a first power and a second power that is greater than the first power, and wherein a first duration of the first power is greater than a second duration of the second power to cause a total intensity of captured light to be approximately equivalent for the first duration and the second duration.

15. The intraoral scanning system of claim 9, wherein the controller is further configured to:
determine a scanning regime; and
select a power fluctuation scheme for the at least one light source based on the scanning regime.

16. The intraoral scanning system of claim 15, wherein the scanning regime is selected from a group consisting of: an orthodontic scanning regime, a restorative scanning regime, and an edentulous scanning regime.

17. The intraoral scanning system of claim 1, wherein the at least one light source comprises a first light source configured to produce a first coherent light having a first wavelength and a second light source configured to produce a second coherent light having a second wavelength that is offset from the first wavelength, wherein the first wavelength produces a first speckle pattern and the second wavelength produces a second speckle pattern.

18. The intraoral scanning system of claim 17, wherein the first light source and the second light source are configured to produce the first coherent light and the second coherent light simultaneously or alternately at a rate that enables the plurality of cameras to capture the first speckle pattern and the second speckle pattern in a single exposure.

19. The intraoral scanning system of claim 18, wherein the rate of alternating between activation of the first light source and the second light source is one or more gigahertz.

20. The intraoral scanning system of claim 1, wherein the one or more speckle pattern generating elements comprise a vibrator configured to vibrate the structured light projector and fluctuate positions of the structured light, resulting in the plurality of speckle patterns.

21. The intraoral scanning system of claim 1, further comprising:
a stack of dielectric layers on the feature pattern generating optical element, wherein the stack of dielectric layers is configured to increase a transmittance of the coherent light at first angles of incidence below an angle threshold and to increase a reflectance of the coherent light at second angles of incidence above the angle threshold.

22. The intraoral scanning system of claim 21, wherein the feature pattern generating optical element comprises a diffractive optical element (DOE) with a rectangular or hexagonal arrangement.

23. The intraoral scanning system of claim 21, wherein the stack of dielectric layers is an alternating stack of a first layer having a first index of refraction and a first thickness and a second layer having a second index of refraction and a second thickness.

24. The intraoral scanning system of claim 21, wherein the stack of dielectric layers is tuned to a wavelength of the coherent light.

25. The intraoral scanning system of claim 21, wherein the angle threshold is 45 degrees.

26. The intraoral scanning system of claim 1, wherein the projected features and the captured features comprise spots.
